(19) United States
(12) Patent Application Publication
(10) Pub. No.: US 2007/0083452 A1
(43) Pub. Date: Apr. 12, 2007

(54) Securities trade monitoring and evaluation system

(76) Inventors: Jan Mayle, Bernardsville, NJ (US); Stephanie Jacoby, New York, NY (US); Ronald Crampton, Hillsborough, CA (US); Mark Martin, Lake Orion, MI (US); Dave Waluk, Mill Valley, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/351,633

(22) Filed: Feb. 9, 2006

Related U.S. Application Data
(60) Provisional application No. 60/724,620, filed on Oct. 7, 2005.

(51) Int. Cl. G06Q 40/00

(52) U.S. Cl. 705/36 R

(57) ABSTRACT

A security price evaluation and exception reporting system and method evaluate an offer price or executed price for a security, such as a bond. Current offerings, past trades, or other market information related to the bond are selected based on first user selectable criteria. Current offerings, past trades, or other market information related to other bonds are selected based on second user selectable criteria. The second security has similar characteristics, which are user selectable, to the bond. An indication of a price of the bond is generated based on the selected current offerings or past trades and the third and fourth user selectable criteria.

### CROSS REFERENCE TO RELATED APPLICATIONS

This application claims a benefit of, and priority 35 USC § 119(e) to, U.S. Provisional Patent Application No. 60/724,620, filed Oct. 7, 2005, and titled “Securities Trade Monitoring And Evaluation System”, the contents of which are herein incorporated by reference.

### FIELD OF THE INVENTION

The present invention relates to a system and method for processing data related to security price evaluation and exception reporting, and more particularly to processing data related to the price evaluation and exception reporting of fixed income securities.

### BACKGROUND

Over the past few years, the financial services industry has seen an escalation in regulatory activity designed to protect the retail customer. Specifically, broker-dealers who buy or sell bonds have witnessed two key trends over the past 12 months: an unprecedented increase in fixed-income market transparency, and an increased focus on dealer pricing responsibilities. The new regulatory environment has created the need for a new product that helps to both protect and empower broker-dealers, and ultimately promote better pricing for their customers.

### Increase in Market Transparency

As an over-the-counter market without a centralized exchange, the bond market has historically been opaque. Only the most sophisticated market participants had tools to determine whether the bond they were buying was fairly priced. The regulatory agencies have changed that, by mandating that prices on executed trades be reported and publicly disseminated. Beginning in January 2005, the Municipal Securities Rulemaking Board (MSRB) began disseminating transaction information on all municipal security trades in real time.

In February 2005, NASD's Trade Reporting and Compliance Engine (TRACE) began disseminating transaction and price data for 99 percent of corporate bond trades on a real-time basis. A new proposal released Sep. 26, 2005 would provide for the public dissemination of the remaining one percent of trades, “which include large transactions of infrequently traded, high-yield bonds that almost exclusively involve dealers and institutional investors rather than retail investors”, according to the NASD press release “NASD to Expand Public Dissemination of Corporate Bond Transaction Data Seeks Rule”.

This real-time transaction information is now available to retail investors free of charge online at sites such as investinginbonds.com and nasdbondinfo.com. For the first time, any retail investor can easily find out where the bond they are about to buy has traded recently.

### Increase in Dealer Pricing Responsibilities

The NASD and MSRB also enforce rules, which prohibit firms from charging their customers prices for securities that are not reasonably related to prevailing market conditions. Prevailing market conditions are determined using a broad range of data including TRACE, MSRB, other sources of transaction data, benchmark scales, current live pricing for comparable bond offerings, ratings history, and comparable bond trades.

Both the MSRB and the NASD have stated that a key factor that dealers must consider is the yield on comparable securities. The MSRB stated in their Review of Dealer Pricing Responsibilities Notice 2004-3 (Jan. 26, 2004) “The most important factor in determining whether the aggregate price to the customer is fair and reasonable is that the yield should be comparable to the yield on other securities of comparable quality, maturity, coupon rate, and block size then available in the market.”

### Problem

There is now an unprecedented volume of information that the broker-dealer must synthesize at various points in the transaction process to ensure that his customers are receiving fair pricing. Retail investors now have more information about the market for a bond than ever before. Regulators are using reported trade information and automated detection patterns to create “audit trails” of mis-pricing. Regulators are also clarifying their rules to reinforce a broker-dealer's responsibility to fairly price a bond for his customer. There is a strong and growing need for a product to review vast stores of market information in order to automatically alert the user if their bond is fairly priced.

As Doug Shulman states:
Testimony of Doug Shulman, Jun. 17, 2004.
President, NASD Markets, Services and Information
United States Senate Committee on Banking, Housing, and Urban Affairs
“An Overview of the Regulation of the Bond Markets”
“TRACE and the MSRB's transaction information enable NASD to create an audit trail of the activity in these markets and undertake comprehensive automated surveillance. NASD market surveillance systems utilize the TRACE and MSRB data to check for compliance with applicable rules and to detect potential violations.
Automated detection patterns are used to address customer protection concerns such as the levels of commissions and markups or markdowns charged to investors. NASD and MSRB rules prohibit firms from charging customers prices that are not reasonably related to the current market price of a security. With the increasing level of retail participation in the fixed income market, this is clearly a high-priority concern.”

The problem is that broker-dealers do not have an effective way of monitoring this themselves, in order to catch “outlier” trades, offerings or bids in time to take the necessary corrective actions. In addition, regulators are looking to see that broker-dealers have a review process in place to ensure that their customers are receiving proper pricing.
Doug Shulman
BMA Legal and Compliance Conference
Feb. 2, 2005
“The message here is that we're not just interested in improper sales practices; we're also interested in whether a firm has the processes in place to prevent those practices.”
   If a broker-dealer has executed trades that the regulators find questionable, the regulators will perform an audit. NASD audits are extremely costly, including both the potential fine, and the man-hours required to collect all the requested information. As reported in a recent press article:

http://www.financial-planning.com/pubs/fp/20050601021. html
In September 2004, Capital Analysts, a small Northeastern broker-dealer with 600 reps, was audited by the National Association of Securities Dealers on its disclosure of mutual fund breakpoints at the point of sale. The regulators came to Capital's office and rifled through its papers and file cabinets, not once, but twice. “The auditing process is difficult because even if you are compliant and following the rules, you still have to take it to the next level and prove that you are complying,” says Jack Crosby, vice president of technology at Capital Analysts. “It's getting so complicated that you can break the rules by mistake.”
After a two-month ordeal, the Radnor, Pa.-based broker-dealer passed the test. “We had no violation, but the time and labor costs of providing what they were looking for were enormous,” Crosby says. The firm is now spending an estimated $100,000 a year out of its operating budget on a suitability and surveillance system to meet regulators' expectations . . .
ProEquities spends about 20% of its operating budget on compliance and on creating systems to support new rules. Timmons, who manages a staff of 17, reports that $1.4 million went to direct expenses associated with compliance last year, plus an additional $200,000 to $300,000 for technology.
Jefferson Pilot's bottom line is stressed by staffing issues and technology demands. “We are constantly being hit with waves of compliance requests,” says David Booth, president of the midsize broker-dealer in Concord, N.H. “As far as profitability, we've had dramatic increases in expenses in the areas of compliance efforts, initiatives, and solutions as well as consultants and technology salaries across the board. More than 90% of our overall expenses are focusing on compliance issues.”

In the event of an NASD audit, broker-dealers need a cost-effective way to easily retrieve important documentation that the regulators request.

### SUMMARY

A security price evaluation system provides or evaluates multiple sources of market information to determine whether a bond offering or bid, or potential trades are fairly priced or whether a recently traded bond or bonds or portfolio holdings were fairly priced. For offerings, the price evaluation system first enables a pre-trade analysis of whether a bond offering is fairly priced, and then automatically alerts a firm if its customer's trades were not in-line with relevant market information, including TRACE and MSRB data. The bond price evaluation system archives a detailed snapshot of the market at the time of trade—including TRACE, MSRB, pricing on comparable offerings which were available in the market, pricing on comparable trades, dealers' bids and offers on the same CUSIP, ratings history, and benchmark yields. The price evaluation system allows a user to customize exception tests and tolerance levels to select trades for further evaluation. Supervisors and traders responsible for the trade may then be automatically alerted for further review of the trade, and the evaluation system archives their documentation and notes.

A security price evaluation and exception reporting system and method evaluate a given price for a unit of a first security. Current offerings or past trades of other units of the first security are selected based on first user selectable criteria. Current offerings or past trades of units of a second security are selected based on second user selectable criteria. The second security has similar characteristics to said unit of the first security. The characteristics are third user selectable criteria. User defined exception test rules, based on the first, second, third, and fourth user selectable criteria, are applied to the given price for a unit of the first security. In one aspect, the given first security is labeled with either a “pass” or “flag”, based on whether it passes or fails the user defined exception test rules.

In another aspect, an automatic alert to the user is generated if the price for the first security is off the market, given the results of a user-selected tolerance test. The alert may indicate that an offering price of the first security falls within the user defined exception test rules, based on multiple points of market data.

In various aspects, the third user selectable criteria may be set by regulatory standards, industry standards, the user, or a private software provider.

In other aspects, an exception notice is generated in the event that the bid, offer, trade, or portfolio holding of the unit of the first security does not conform to the indicia of the price of the first security.

### BRIEF DESCRIPTION OF THE DRAWINGS

FIG. 1 is a block diagram illustrating a security price evaluation and exception reporting system.

FIGS. 2, 3, 4, 5, and 6 are exemplary screenshots illustrating various user screens shown to users of the security and evaluation and exception reporting system of FIG. 1.

FIGS. 7-8 are exemplary screenshots illustrating data for a bond under evaluation.

FIG. 9 is an exemplary screenshot illustrating data for a bond under evaluation with an overlay drop down window for call schedule for the bond under evaluation.

FIG. 10 is an exemplary screenshot illustrating comparable offerings in response to selecting all comparable offerings button in the screenshot of FIG. 7.

FIG. 11 is an exemplary screenshot illustrating trades of the security over the last thirty days.

FIG. 12 is an exemplary screenshot illustrating a “show all history” selection from a screenshot for a corporate security.

FIG. 13 is an exemplary screenshot illustrating a “show all history” selection for municipal bonds.

FIG. 14 is an exemplary screenshot illustrating trades of a security over the last two days.

FIG. 15 is an exemplary screenshot illustrating a list of comparable offerings and related information.

FIG. 16 is an exemplary screenshot illustrating data for evaluating a bond after the trade has occurred.

FIG. 17 is an exemplary screenshot illustrating a home page for the trade monitoring system of FIG. 1.

FIG. 18 is an exemplary screenshot illustrating results of a single price exception test.

FIG. 19 is an exemplary partial screenshot illustrating a drop down menu for user selection.

FIG. 20 is an exemplary screenshot illustrating a resultant comparison of selected securities from the screenshot of FIG. 10.

FIGS. 21A, 21B, 21C, and 21D are tables illustrating user selectable criteria for evaluating prices of securities.

FIG. 22 is an exemplary screenshot illustrating an expanded view of a summary of trades for a two day period as shown in FIG. 14.

FIGS. 23a-23k are exemplary screenshots illustrating test approval screens, and drop down menus which users can select to search for specific exceptions or trades.

FIG. 24 is an exemplary screenshot illustrating a test summary.

FIG. 25 is an exemplary screenshot illustrating a data input screen for test administration. FIGS. 25a-h are exemplary screenshots which illustrate drop down menus on screens which can be used to define rules and tolerance levels within the exception test.

FIG. 26 is an exemplary screenshot illustrating an ad hoc test query.

FIG. 27 is an exemplary screenshot illustrating a test execution summary.

FIG. 28 is an exemplary screenshot illustrating an email of exception tests.

FIG. 29 is a flow diagram illustrating the methodology for approval of exception reports.

FIG. 30 is an exemplary screenshot illustrating a multiple test screen view.

FIG. 31 is an exemplary screenshot illustrating a pre-trade test with trade monitoring system evaluation.

FIG. 32 is an exemplary screenshot illustrating the screenshot of FIG. 31 and a pop-up window for reported trades.

FIG. 33 is an exemplary screenshot illustrating a post-trade trade monitoring system display with pre-trade evaluation data.

FIGS. 34-37 are exemplary screenshots illustrating a summary of the user operation of the price evaluation system of the system of FIG. 1.

FIG. 38 lists a glossary of NASD TRACE special notes which are displayed in the “special notes” column on FIG. 2, and on FIG. 12.

FIG. 39 is a flow diagram illustrating the methodology for approval of exception reports.

### DETAILED DESCRIPTION

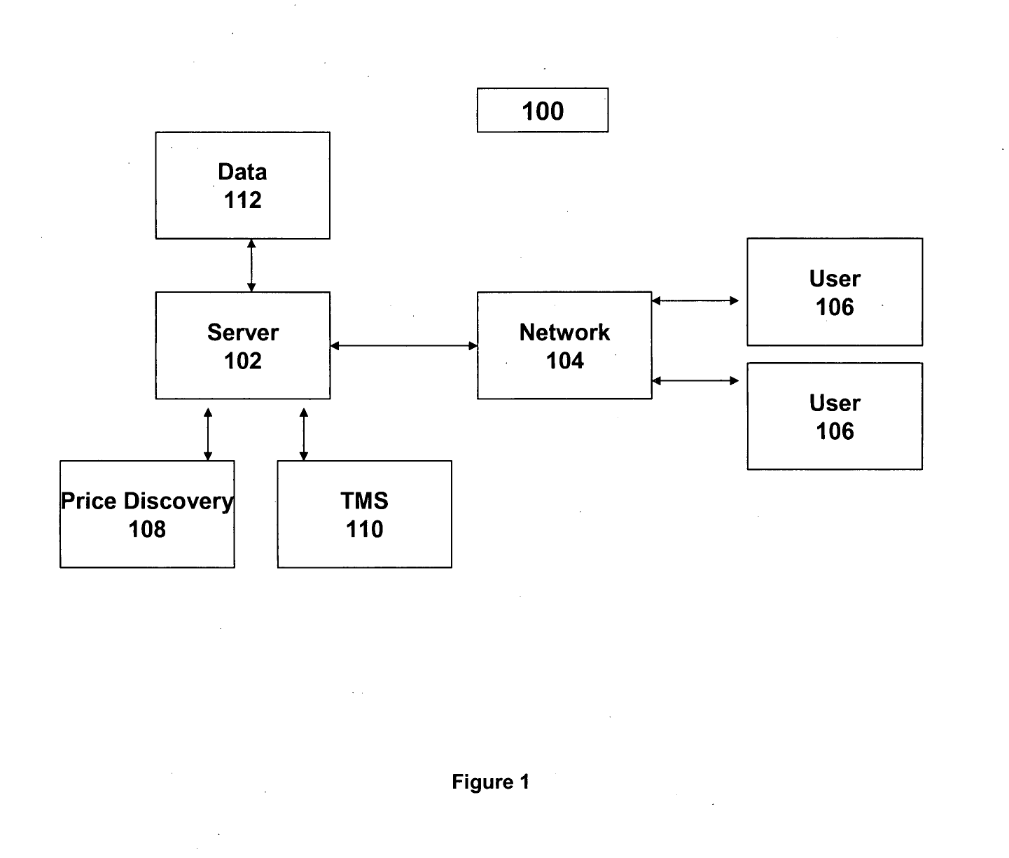

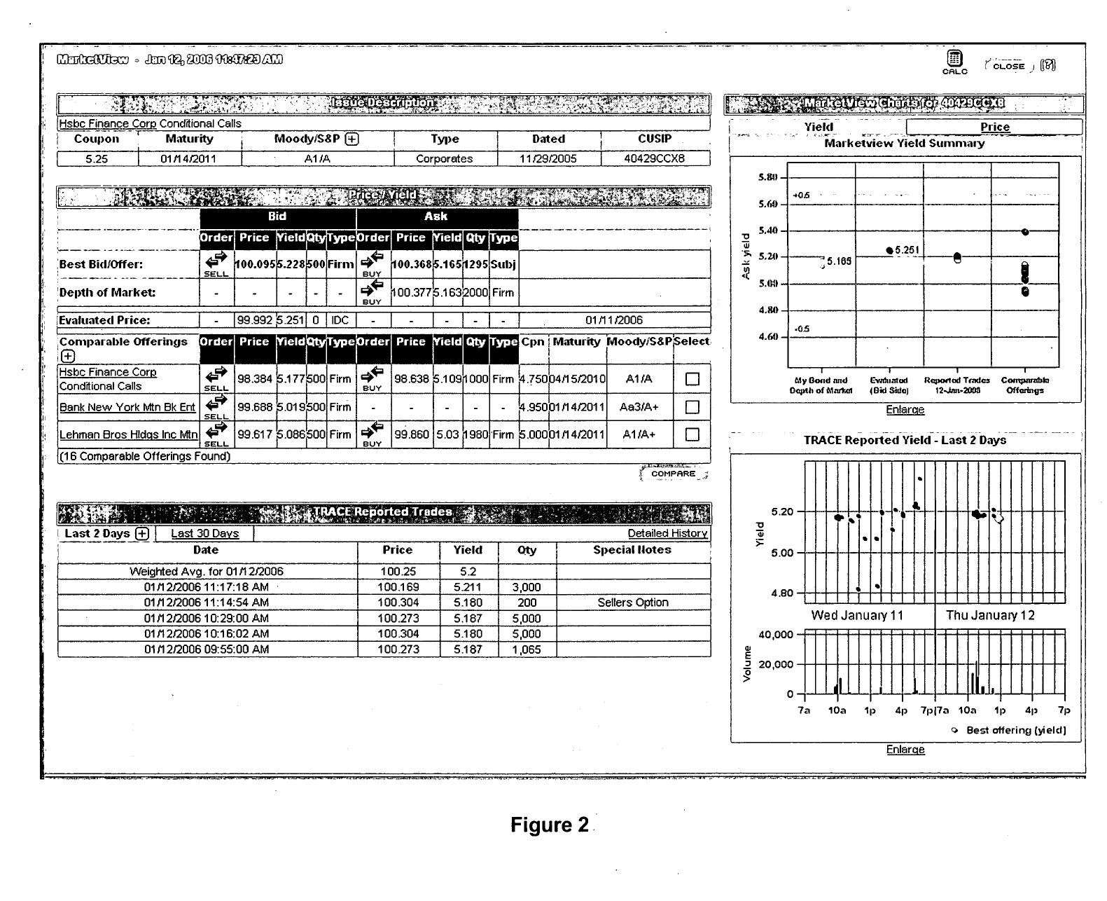

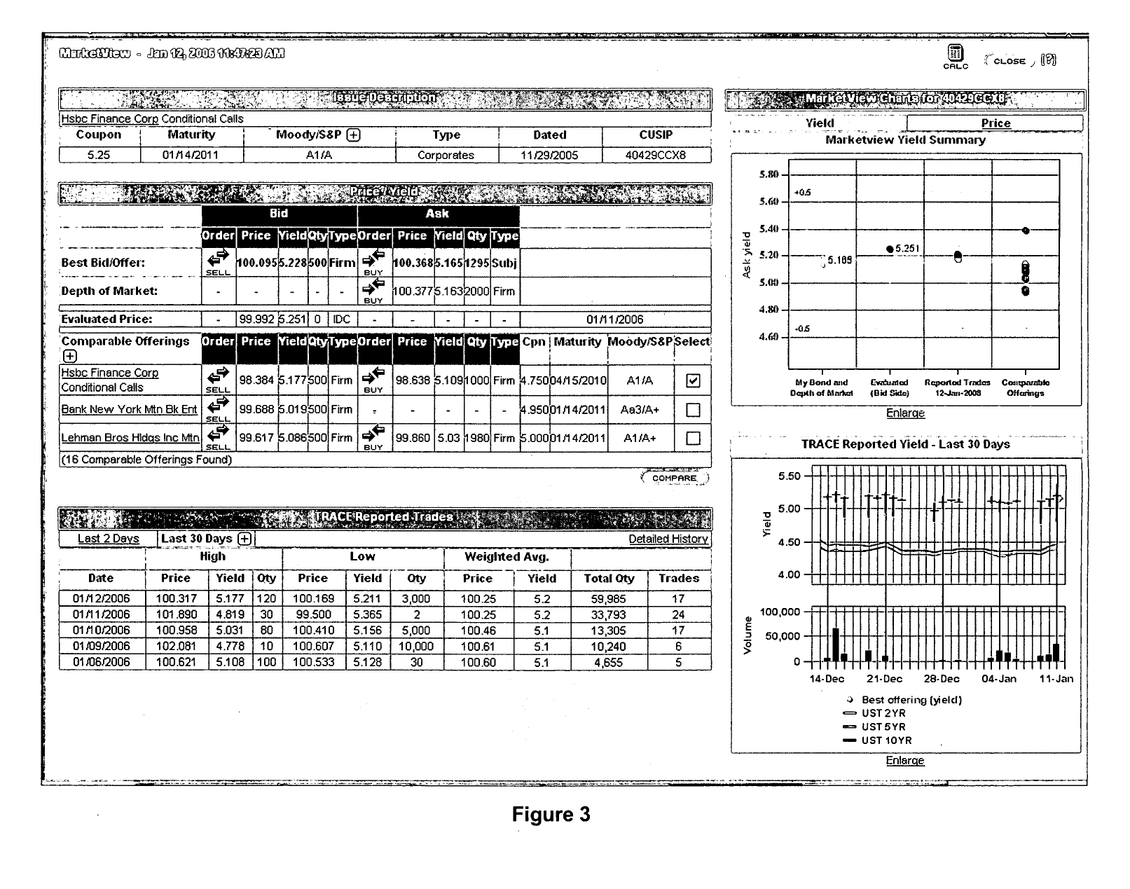

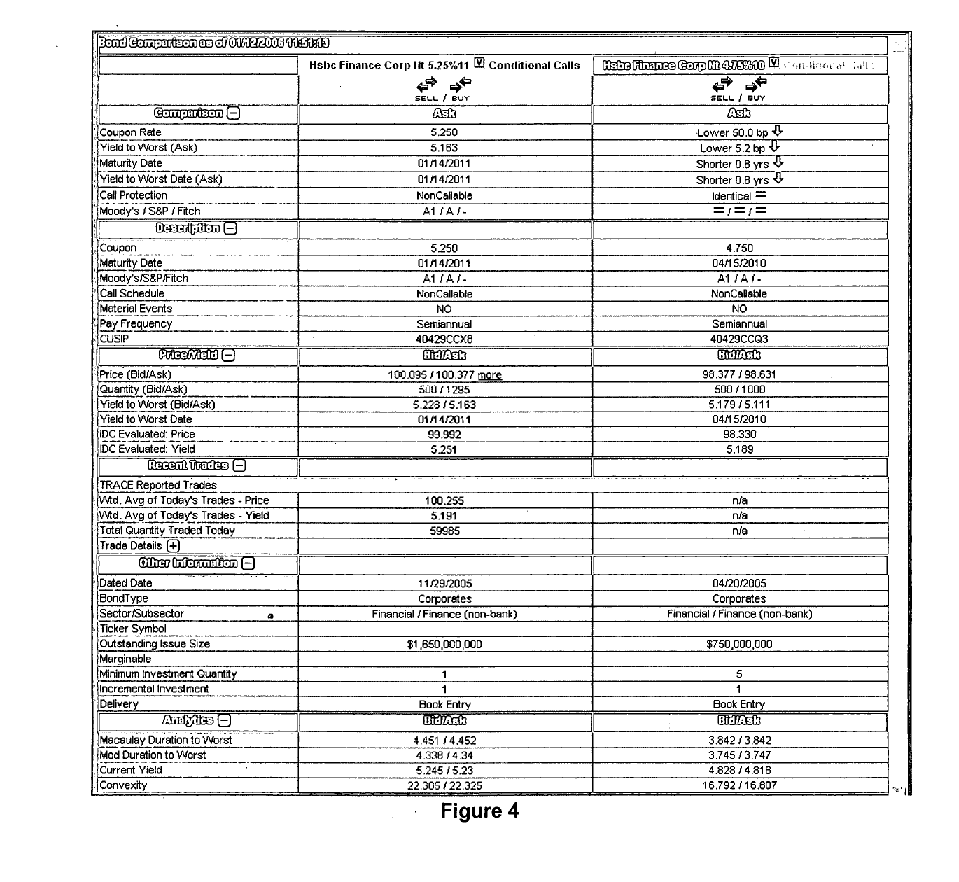

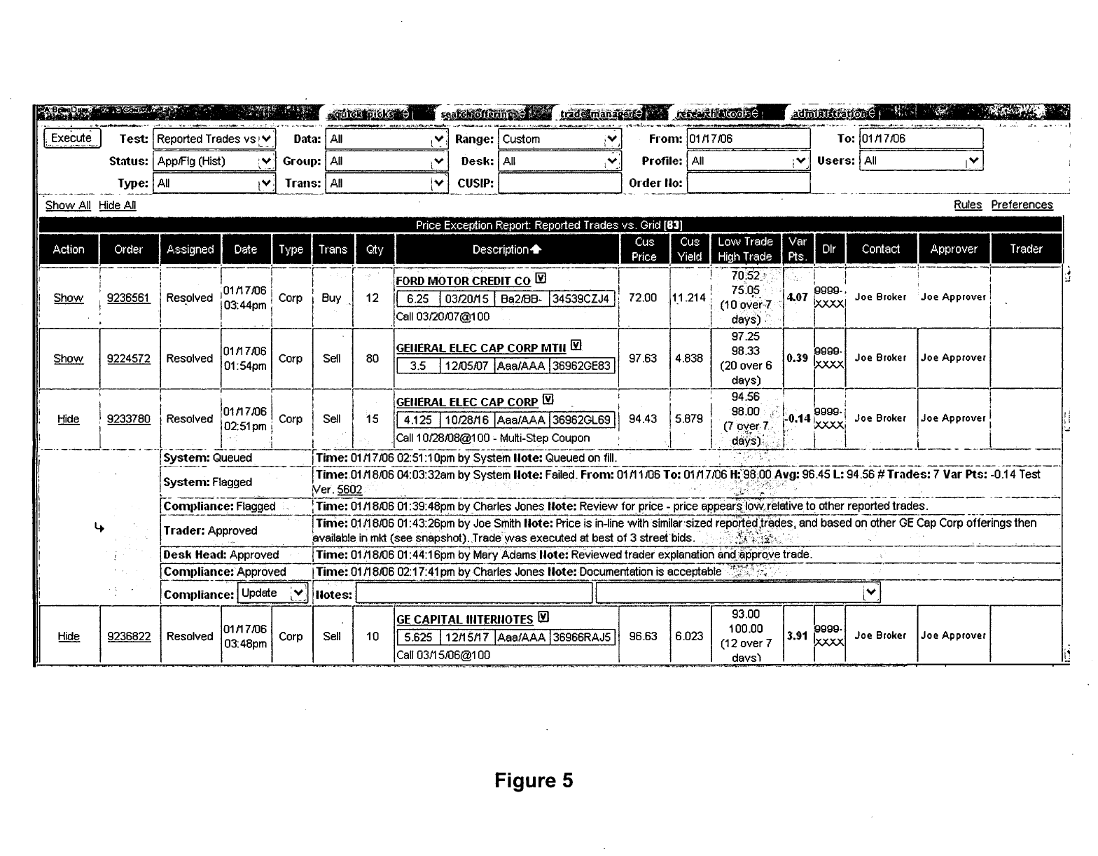

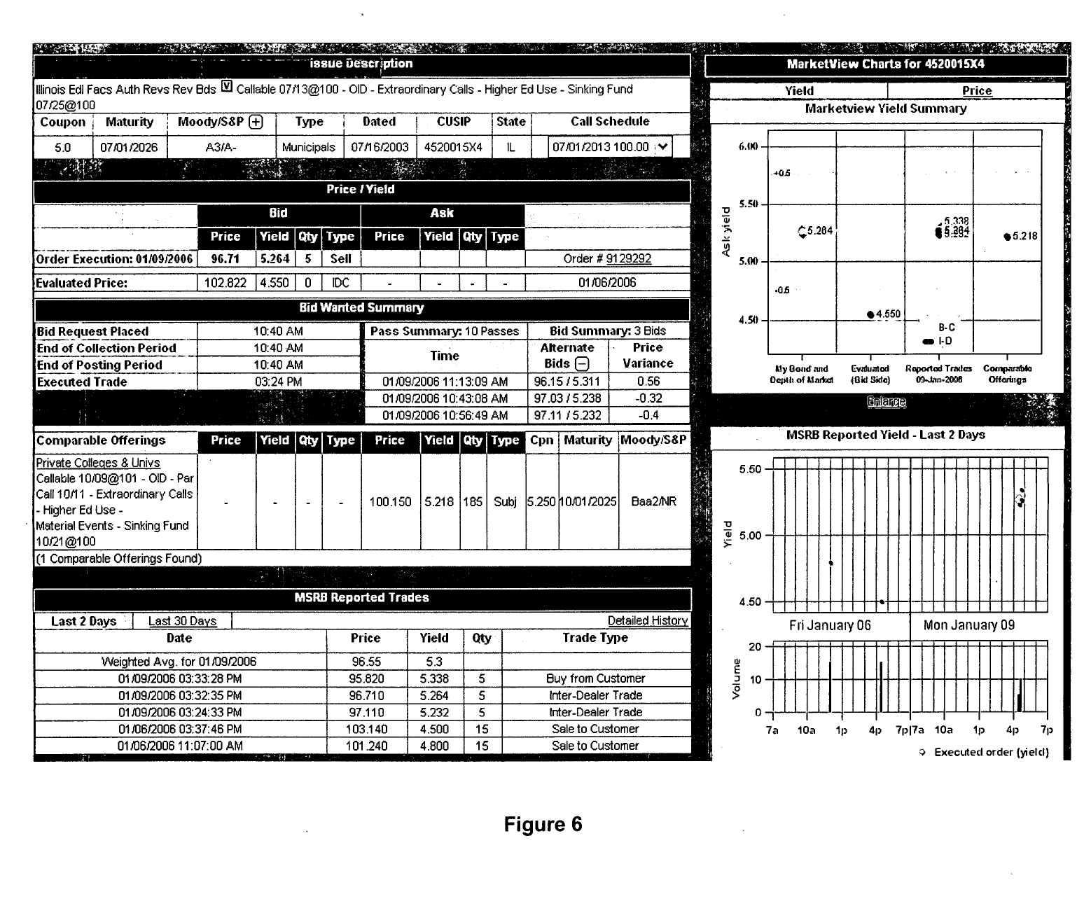

FIG. 1 is a block diagram illustrating a security price evaluation and exception reporting system 100. FIGS. 2-6 are diagrams illustrating examples of user screens on the computers 106. The user interface provides pull down menus for selecting different views or data.

The security price evaluation and exception reporting system 100 comprises a server 102, a communication network 104, such as the Internet, and a plurality of user computers 106. Two user computers 106 are shown for clarity, but other numbers of user computers 106 may be used. For simplicity and clarity, a user may be referred to as user 106. The server 102 executes a price evaluation system 108 and a trade monitoring system (TMS) 110. The server 102 includes a data storage system 112 for storing and/or collecting current and past trades and other market data in a data base, archive or other storage format. The security price evaluation and exception reporting system 100 may evaluate offerings, bids, potential trades, trades in real time, trades after they have occurred, or portfolio holdings. Although the security evaluation and exception reporting system 100 is described in terms of bond trading, the pricing evaluation may be applied to trades of other securities.

The price evaluation system 108 and the trade monitoring system 110 are software programs executed by the server 102. In another embodiment, the systems 108 and 110 may be executed fully or partially in the user computers 106.

The price evaluation system 108 and the trade monitoring system 110 may comply with regulatory rules or guidance or industry standard practices in fixed income markets and/or may help in creating pricing integrity in the fixed income marketplace. Although the security price evaluation and exception reporting system 100 is described for compliance with regulatory schemes, the security price evaluation and exception reporting system 100 may comply with other schemes for further price integrity. For example, the security price evaluation and exception reporting system 100 may have a differing definition of fair price based on the sophistication or risk characteristics of the firm or the purchasers, or based on specific regulations that may apply.

The security price evaluation and exception reporting system 100 promotes best execution by automatically alerting a firm if its customer's trades were not in-line with relevant market information, including TRACE and MSRB data, other sources of transaction data, benchmark scales, ratings changes, comparable bond trades, and current live pricing for comparable bond offerings on the price evaluation system 108. The security price evaluation and exception reporting system 100 also collects and archives all documentation and information from the time of trade, allowing for easy online retrieval. In addition the security price evaluation and exception reporting system 100 may alert potential buyers if the price they would need to pay to buy a particular security being offered for sale is not in-line with relevant market information and alert potential sellers if the price they are offering their security for sale for is not in-line with relevant market information.

The price evaluation system 108 allows fixed income securities buyers, sellers and professionals to evaluate bond prices as fair and reasonable within the context of prevailing market conditions. Prevailing market conditions are determined using a broad range of data including TRACE, MSRB, other sources of transaction data, benchmark scales, relevant market indices, past trades on similar bonds, and current live pricing for comparable bond offerings available from systems of software providers, such as BondDesk ATS, and/or other electronic trading platforms. The price evaluation system 108 is also referred to as the MarketView system herein. The price evaluation system 108 may use bond rating, block sizes, maturity, interest rate, and other metrics of currently or recently traded bonds to generate a numerical value or other indicia of the fairness of a pending or executed trade in view of the multiple data points of relevant information. For example, FIG. 2 shows a user screen with a summary chart of the current trade in view of reported trades and a detail chart of two days of reported trades with yield and price. The summary chart includes a band indicating a user-specified acceptable range for yields for the proposed trade based on recently traded bonds determined to be similar to the bond in the proposed trade. The MarketView system may be used in various processes including: (1) to evaluate the fairness of a bid or offer; (2) to evaluate the market before a trader prices an offering or bid; (3) to evaluate securities held in a portfolio, fund, or trading book; and (4) to evaluate whether a trade that occurred was fair, according to a firm's tolerance levels, or other rules or guidance which may be specified by a regulator or other outside body. The processes typically use user selectable criteria for the evaluations, tolerance levels, rules, market evaluation and fairness.

The security price evaluation and exception reporting system 100 determines which of the offerings are comparable to a specific bond being offered. The security price evaluation and exception reporting system 100 executes an algorithm with configurable criteria so that each firm can define and easily surface comparable offerings, for helping the users determine prevailing market conditions. The user 106 selects and configures user selectable criteria for the system 100 to select offerings that are comparable based on the criteria.

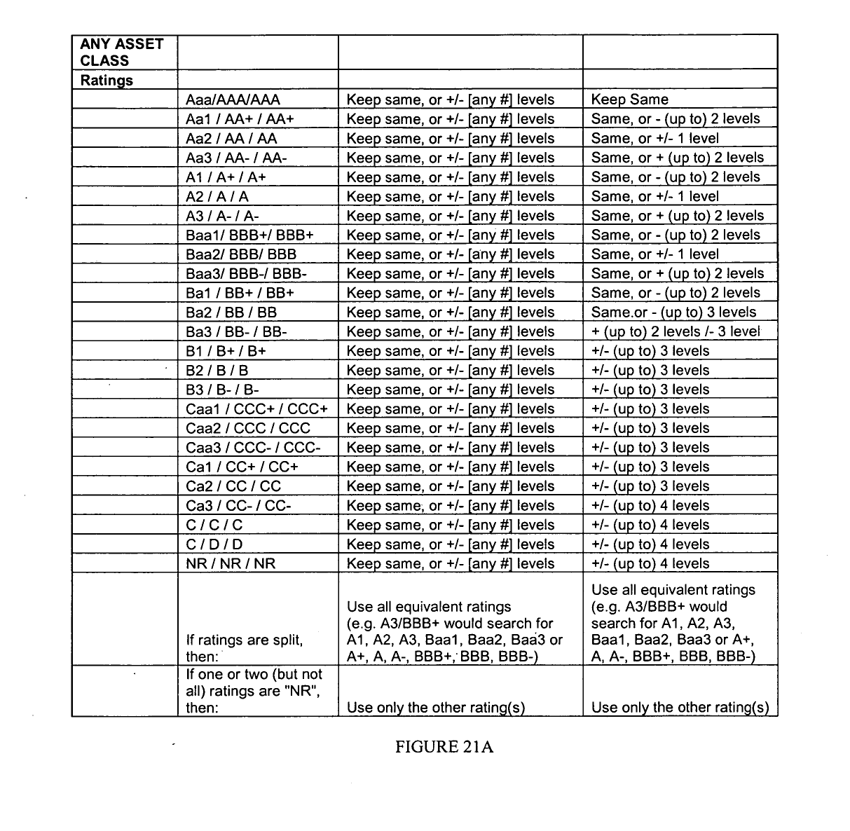

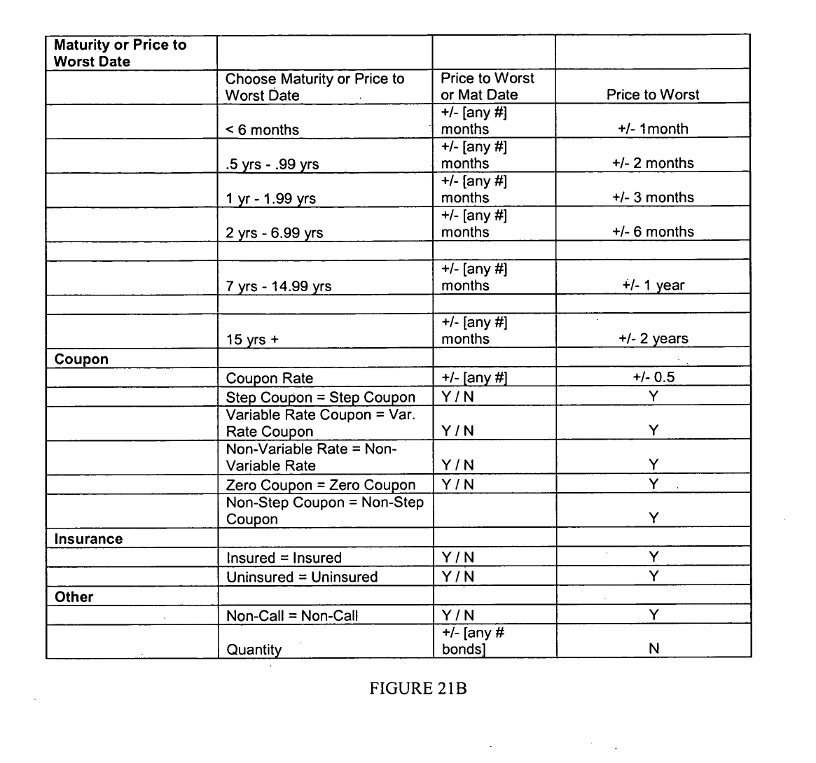

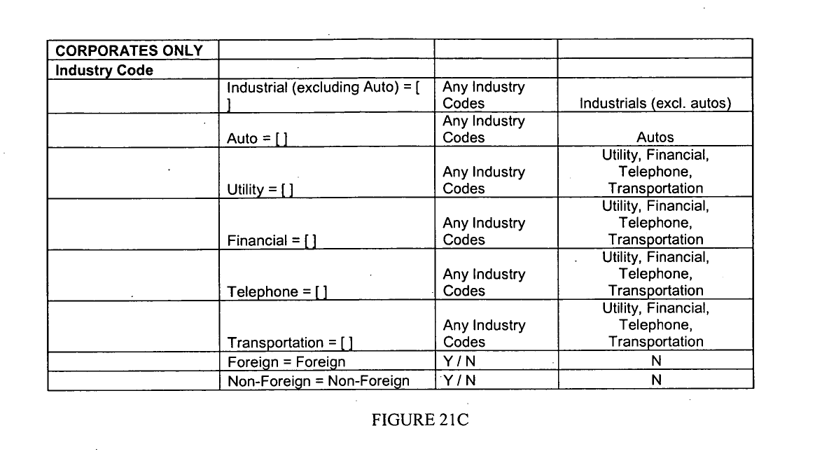

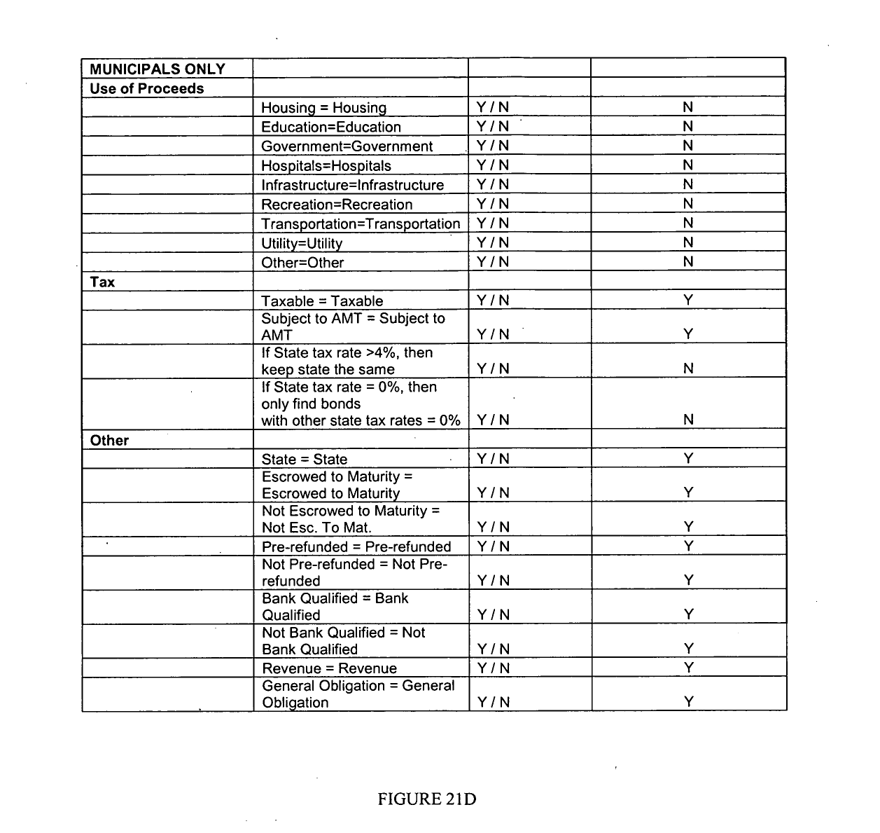

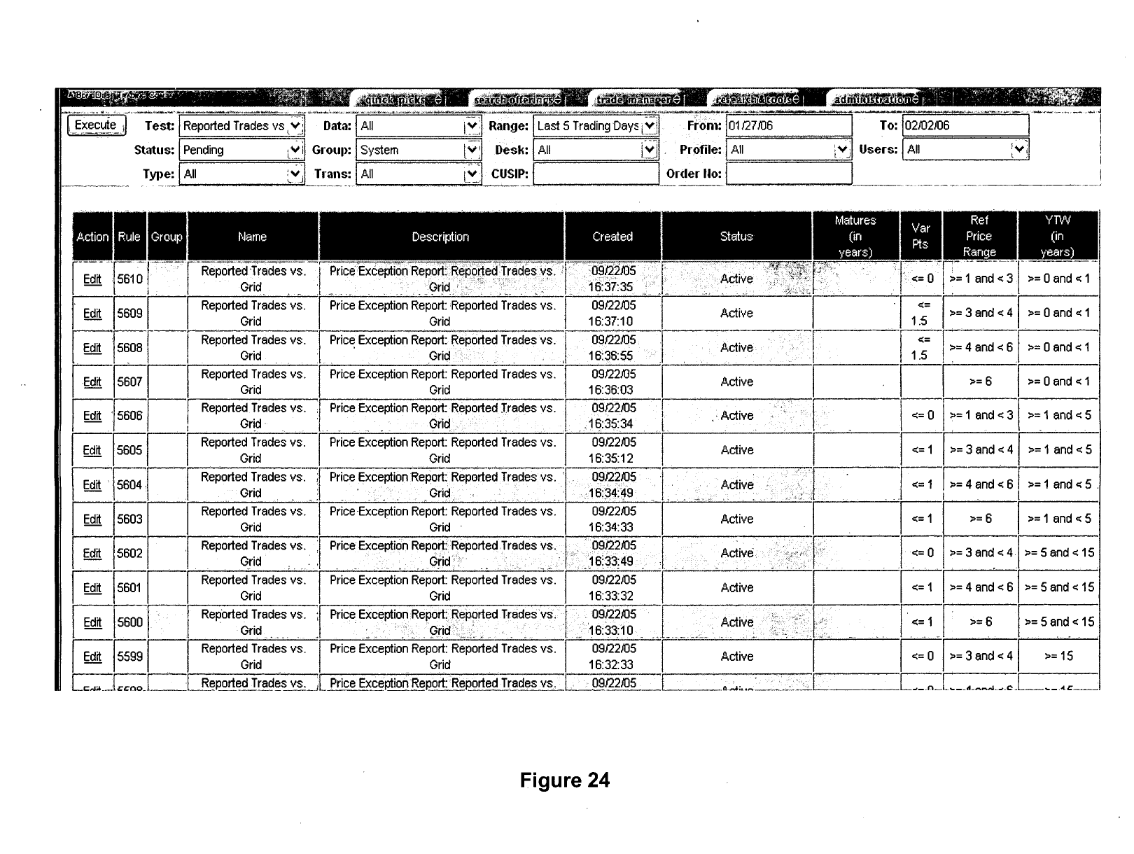

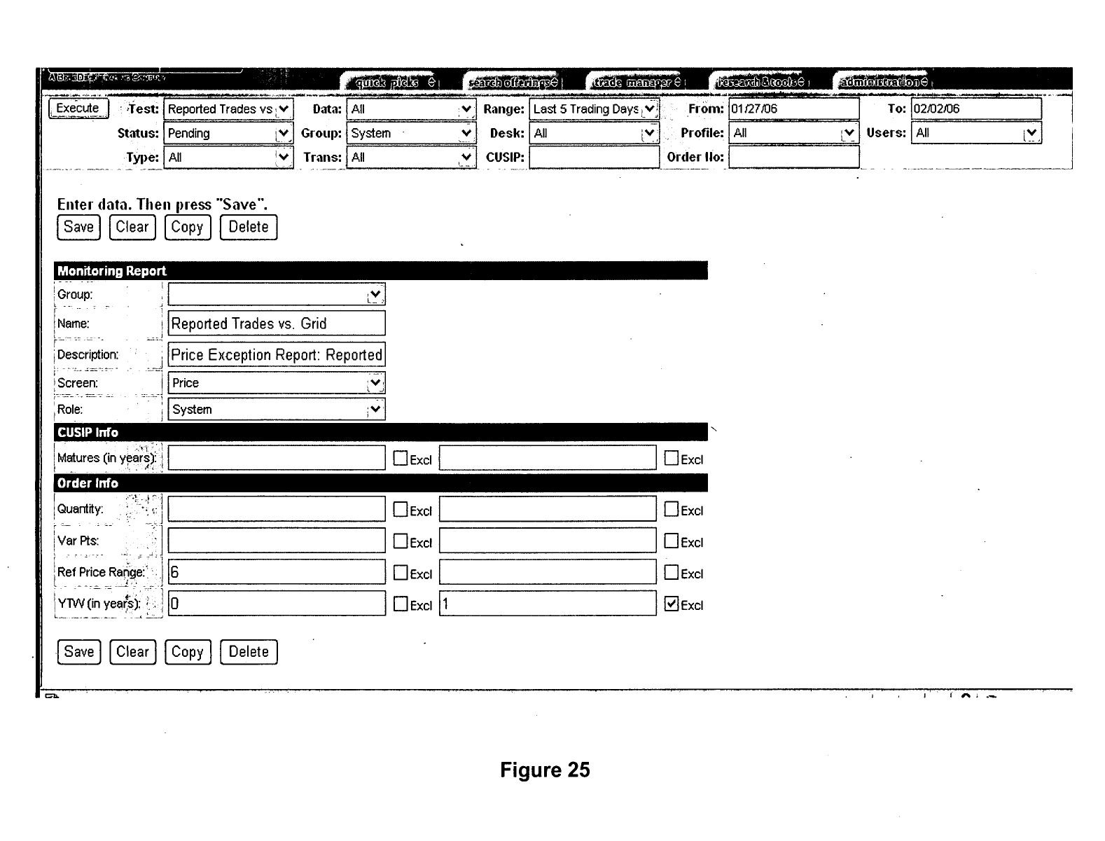

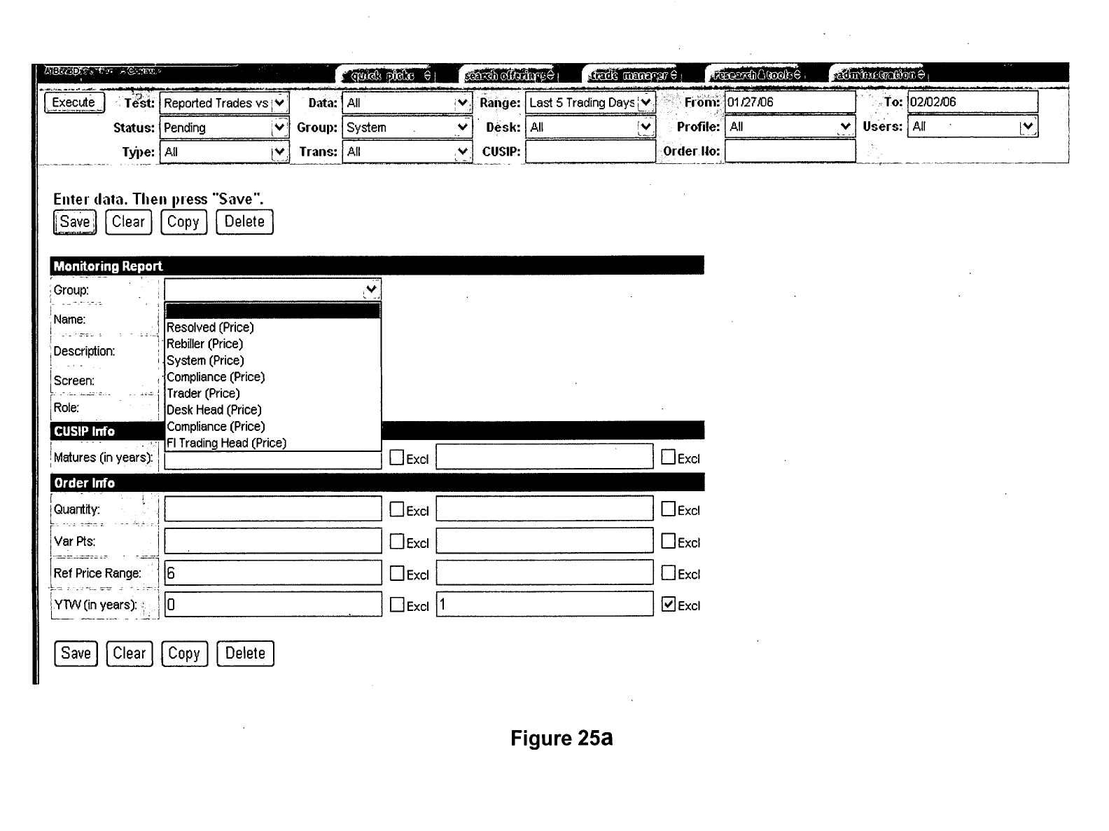

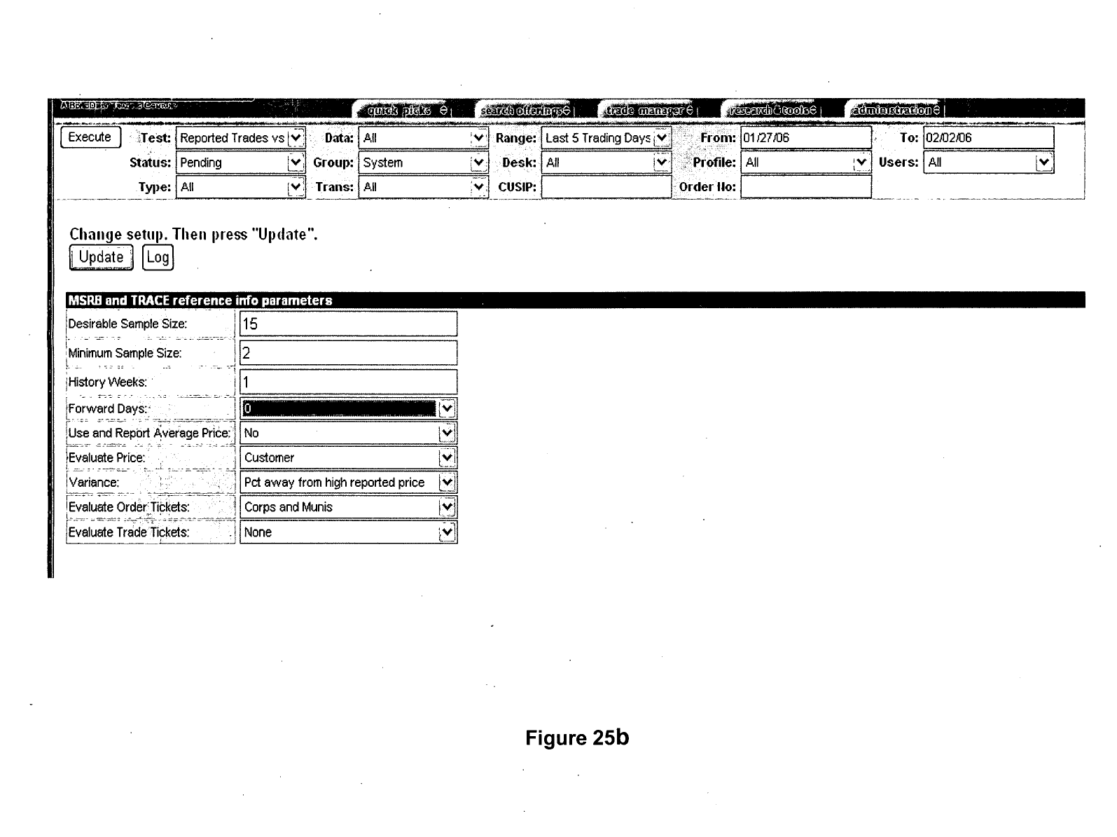

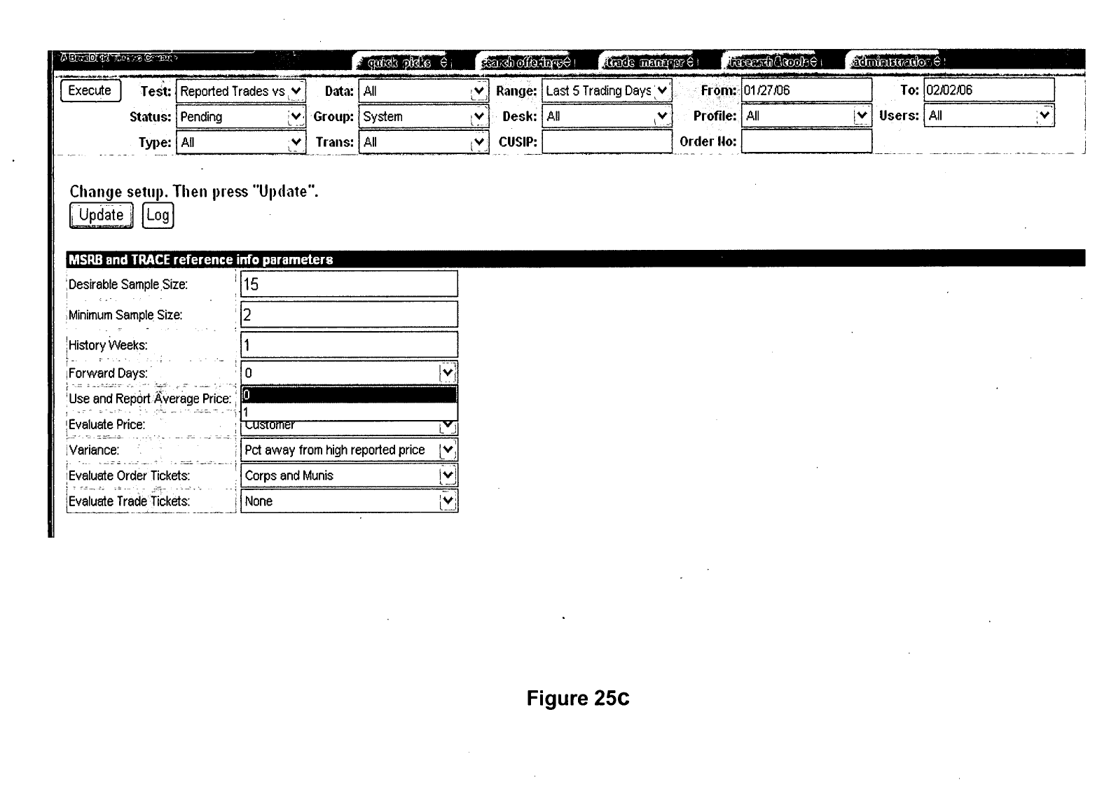

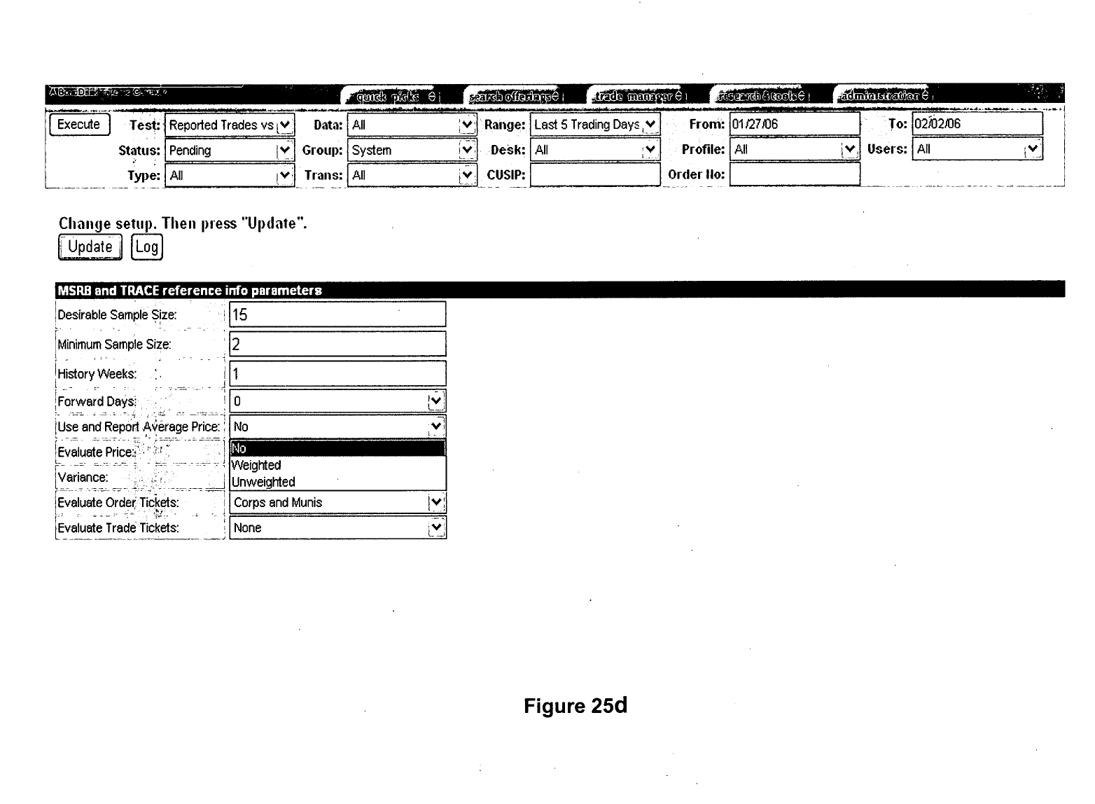

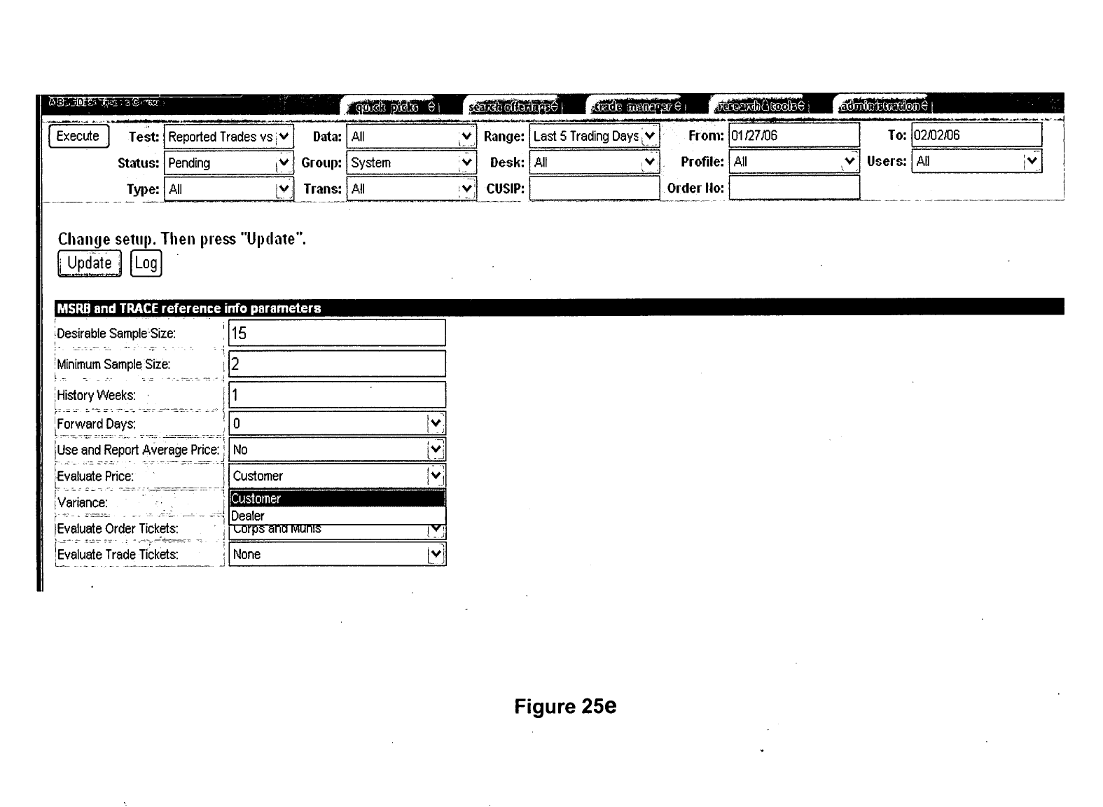

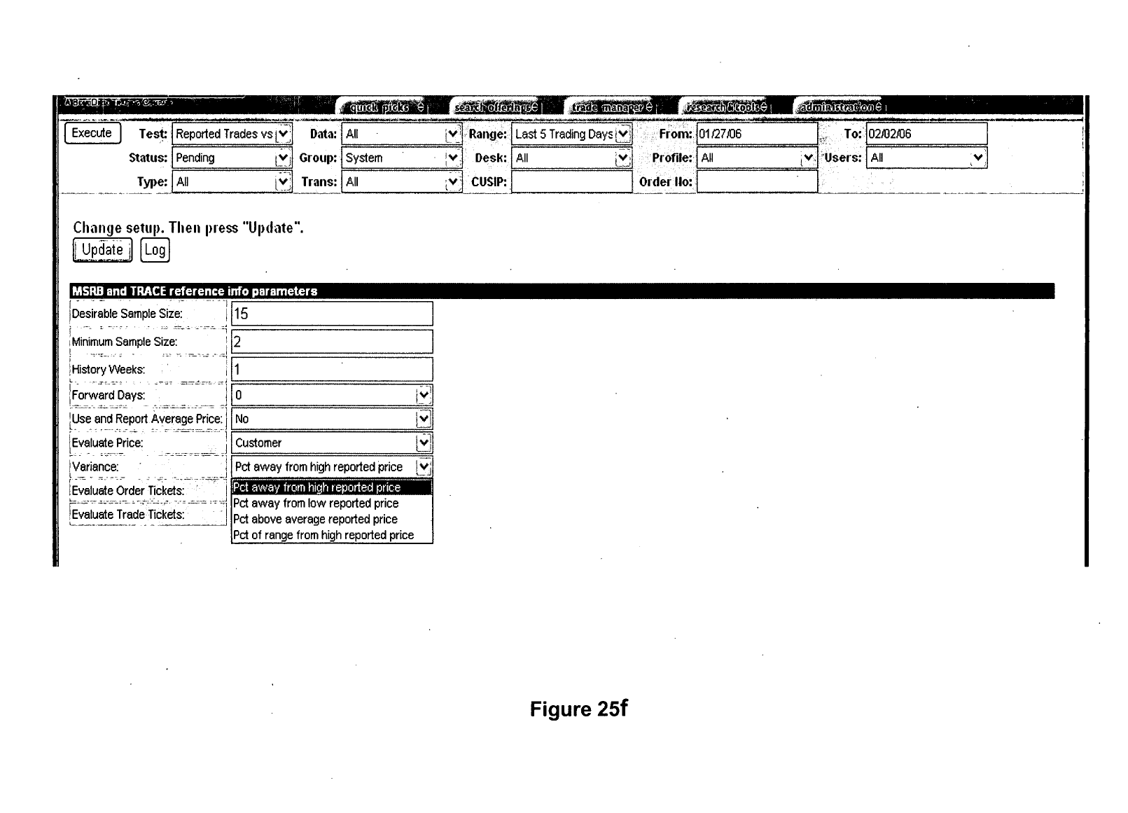

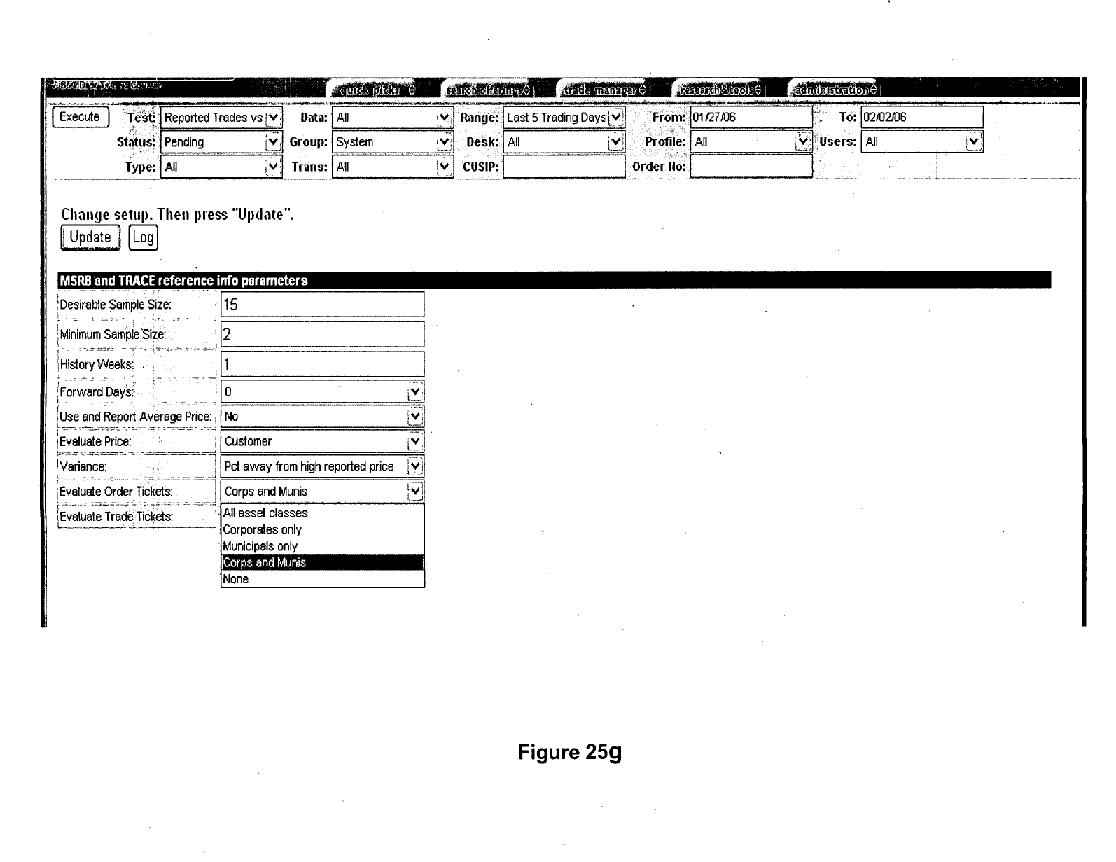

The trade monitoring system 110 is an exception reporting system that compares a firm's executions against relevant market information, such as reported trades of the day or earlier time period, surfacing any customer trades that fall out of line with the user or firm's tolerance levels, which may be preset or adjustable in real time. The trade monitoring system 110 also records a firm's trader documentation and supervisory notes on every trade, allowing the firm to easily monitor problem trades. The trade monitoring system 110 may generate exception reports in response to user defined criteria, such as described below in conjunction with FIGS. 24-30. For example, the user may set a number of trading days in the past, set a number of past trades as a subset, and a minimum number of trades to be used. The trade monitoring system 110 determines whether bond executions were fair and reasonable by comparing them against relevant market data, such as against parameters of TRACE or MSRB reported trades, such as a weighted average price, from the subsets calculated from the user defined criteria. Based on comparison to these trades, the trade monitoring system 110 employs user-defined tolerance levels to determine an index or indicia of whether the trade was fair. Examples of user selectable criteria are shown in FIGS. 25, 25a-h and 26. The system provider or regulators may also set the criteria. The price evaluation system 108 may also use configurable criteria shown in FIGS. 21a-d.

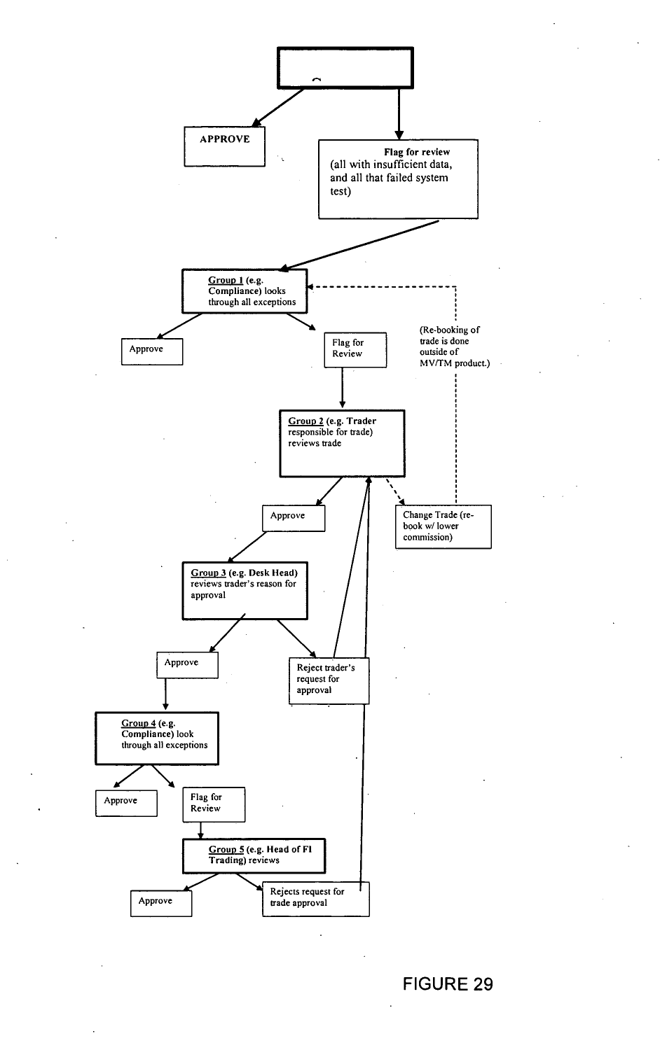

Once the system 100 flags a trade, user-defined logic specifies who will be alerted first, what actions he/she can take, and who the exception routes to next for further review. (e.g., see FIG. 29). Each person responsible for review may enter notes and documentation.

The system 100 may evaluate a given price for one unit of a first security, such as a denomination of a bond, or evaluate a traded price for the unit. The system 100 selects current offerings, past trades, dealer cost, or dealer marks on other units of the first security based on a set of first user selectable criteria. The system 100 also selects comparable securities, by selecting units of one or more second securities based on a set of second user selectable criteria and data related to offerings and transactions of said second securities. The second securities have similar characteristics to the unit of the first security by using characteristics that are a set of third user selectable criteria. For the given price, the system 100 generates indicia of price of the unit of the first security based on a set of fourth user selectable criteria. For agiven price or a traded price, the system 100 evaluates the price of the unit of the first security based on fourth user selectable criteria.

The fourth user selectable criteria are the rules or tolerance levels which will be used to compare the first security and second security to the first and third user selectable criteria, and will determine whether the first security will pass the user's test, indicating that it is fairly priced, or fail the user's test, indicating that it is off the market. The fourth user selectable criteria define either a specified value or a range (percentage or number of points, for example). If the first security exceeds the first user selectable criteria by the percentage or points defined in the fourth user selectable criteria, then it fails the user defined tolerance test. The percentage or number of points defined by the fourth user selectable criteria can be different for different types of securities. For example, the user may choose to vary the fourth user selectable criteria by the following characteristics of the first security: number of bonds; par value; ratings; volatility of the bond over a specified period of time; trading spread of the bond over a specified period of time; maturity; years until the price-to-worst date; option adjusted spread; industry sector; use of proceeds; obligor; and/or issuer.

In the event of an audit, the system 100 allows broker-dealers to easily retrieve important documentation that the auditors request. The system 100 comprises the data storage system 112 that includes an electronic archive, which records a snapshot of pertinent MarketView data from the time of execution, along with the firm's trader and supervisor notes. The broker-dealer can then easily retrieve that information online, by simply typing in the date in question, the specific order numbers, or other identifiers.

The data storage system 112 includes an electronic archive, as an online storage and retrieval tool, to record a snapshot of pertinent price evaluation data from the time of execution, along with the firm's trader and supervisor notes.

Although the price evaluation system 108 and the trade monitoring system 110 are described based on corporate and municipal bonds, the price evaluation system 108 and the trade monitoring system 110 also may be used for agency bonds, treasury bonds, certificate of deposits (CDs), pass throughs, asset backed securities, CMOs, MBS, Preferreds, and other fixed income securities.

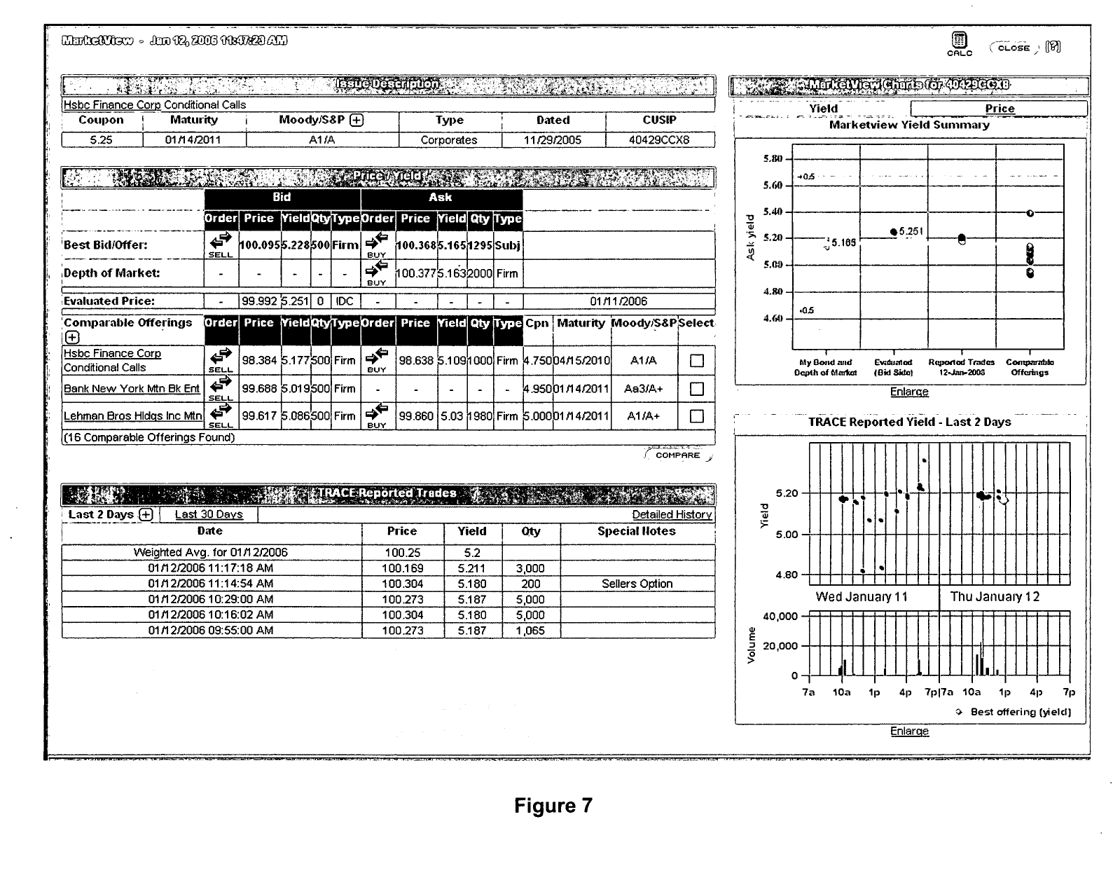

FIG. 7 is an exemplary screenshot illustrating data for a bond under evaluation. The screenshot includes an issue description for the bond under evaluation. For corporate bond and municipal bonds, the screenshot typically includes descriptive data for the issue description of call features, coupon, maturity, ratings, type, dated, CUSTP and call schedule.

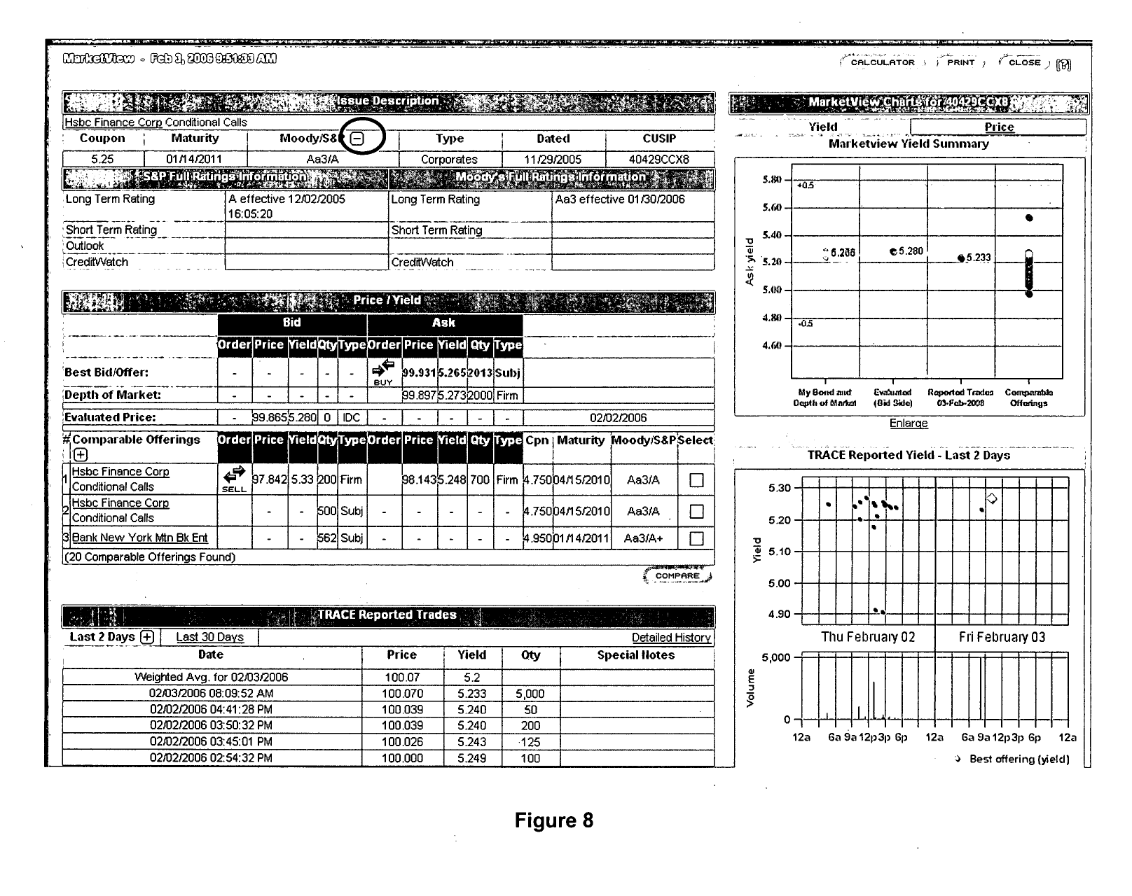

FIG. 8 is an exemplary screenshot illustrating data for a bond under evaluation. The screenshot is an expanded view of the screenshot of FIG. 7 including full rating information for the bond under evaluation when an expanded view button is pressed by a user. The screenshot includes best bid and ask prices, depth of market for bid and ask, third party price, comparable offerings, and reported trades. The depth of market bid/ask information indicates where multiple dealers would buy or sell that same security. The screenshot may include the depth of market with the best bid and best ask first in a collapsible table. The third party price indicates prices defined by external entities, such as IDC, Standard & Poor's, and Reuters.

The comparable offerings field includes a description to indicate whether the bond is callable or has material events. The comparable offerings field may include price-to-worst date if user selects this as search criteria. A ‘+’ icon next to ‘Comparable Offerings’ expands the list to show all comparable bonds with checkboxes; and a “−” icon collapses the list. The comparable offerings that each client sees may be different Each firm can set their own criteria and tolerance levels, which the system 100 uses for evaluating the offering or post trade price. See for example, FIGS. 21A, 21B, 21C, and 21D, which are tables illustrating user selectable criteria for determining which bonds or offerings are comparable to the security whose price is being evaluated. Other search criteria may include Option Adjusted Duration, and six digit SIC code for corporate bonds.

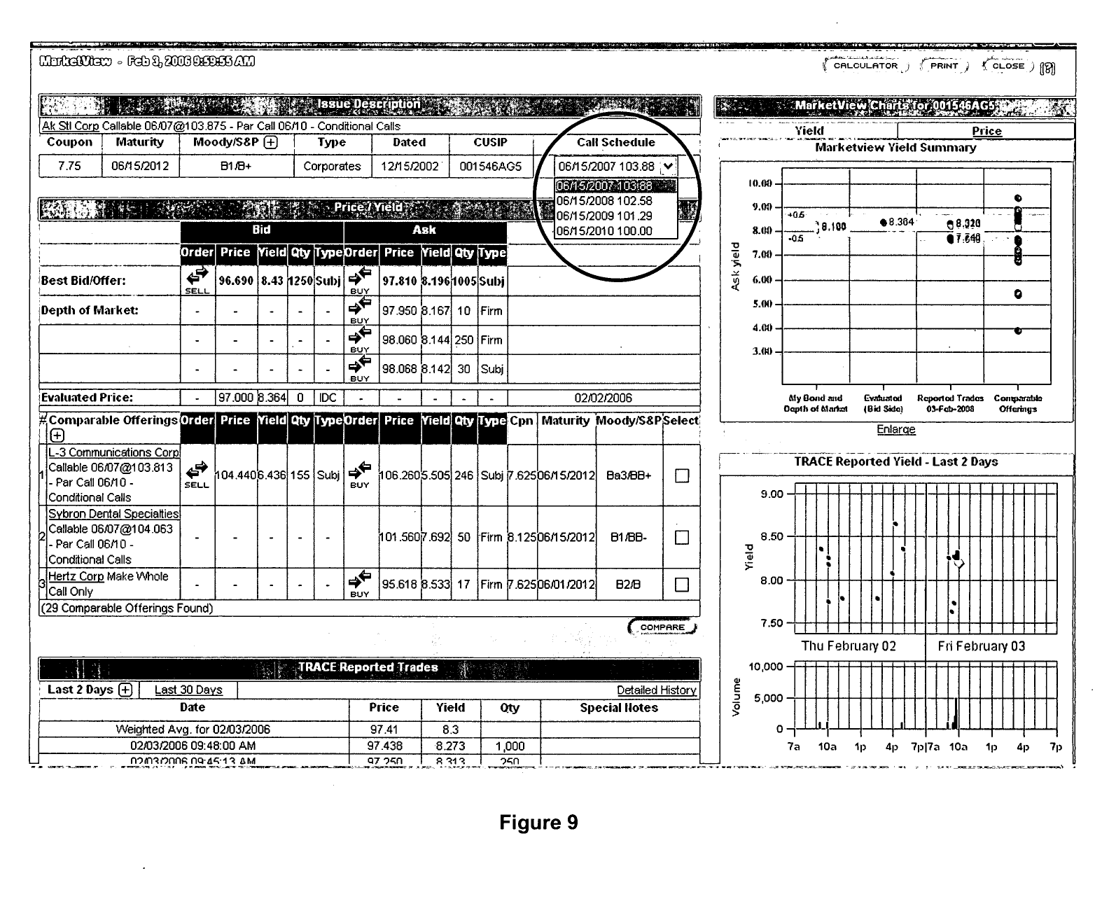

FIG. 9 is a screenshot illustrating data for a bond under evaluation with for a drop down for a call schedule for the bond under evaluation.

The price evaluation system 108 and trade monitoring system 110 allow a user to compare specified criteria between a specific security and selected securities.

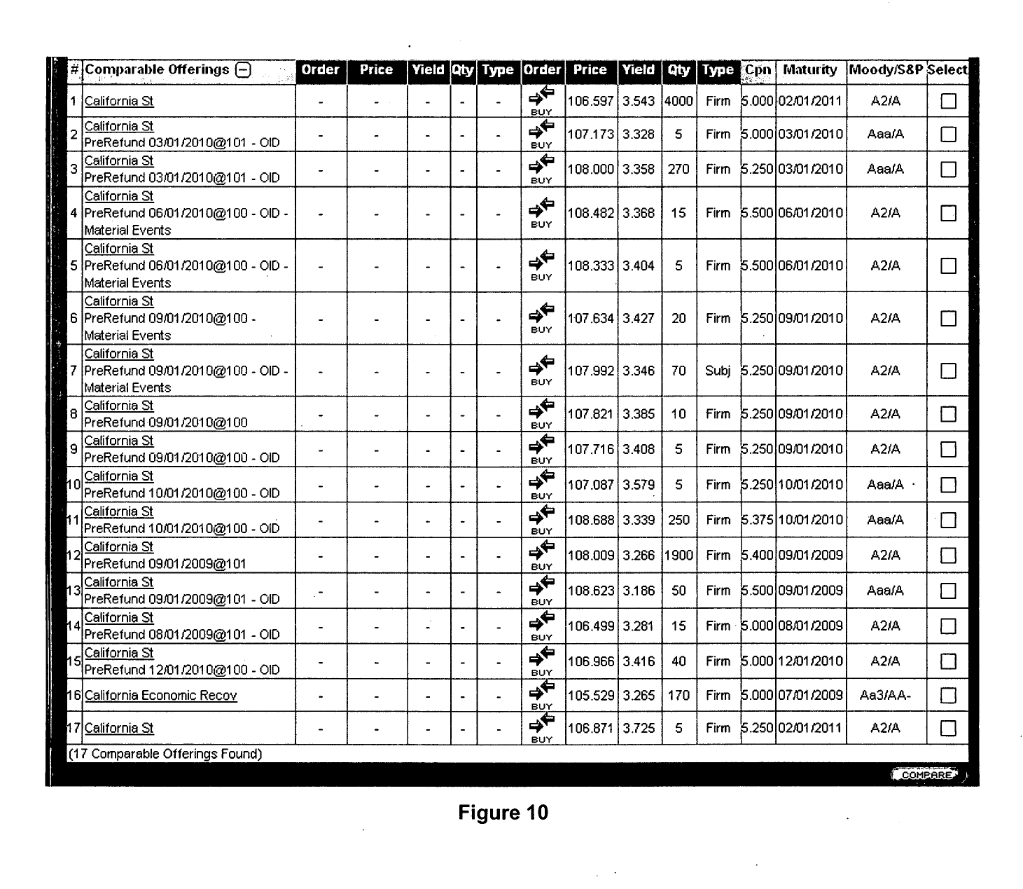

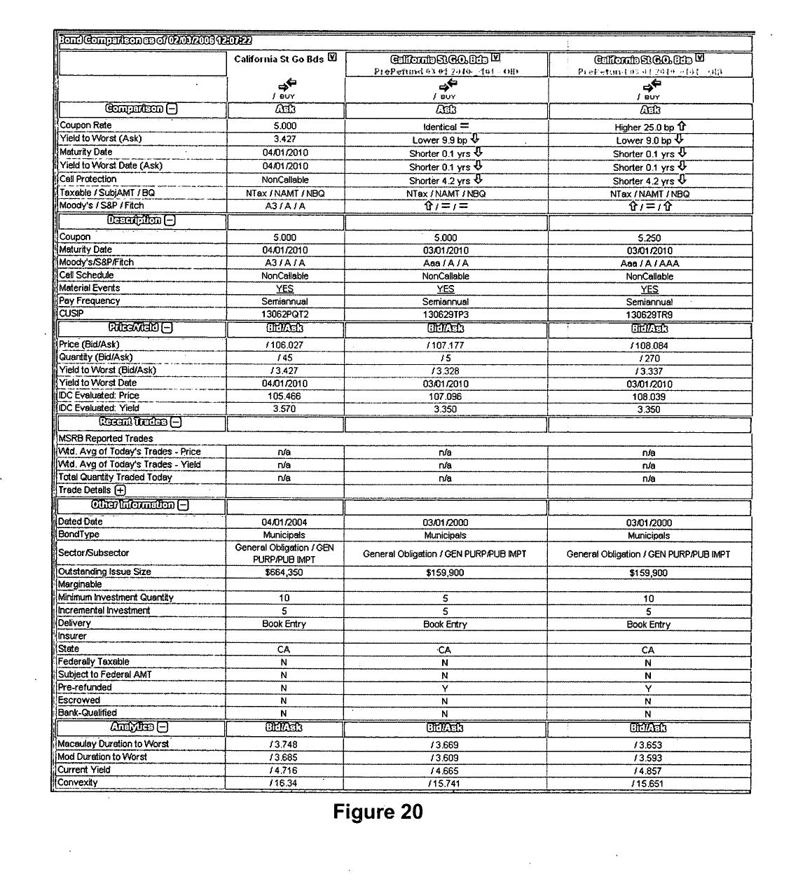

FIG. 10 is an exemplary screenshot illustrating comparable offerings in response to clicking the “+” icon to view all comparable offerings. The user selects the check boxes corresponding to the securities to be compared, and presses the “compare” button to view a side-by-side comparison, as shown in FIG. 20.

FIG. 20 is a screenshot illustrating a resultant comparison of selected securities. The comparison screenshot includes a quick compare function which calculates the difference between the selected bonds and comparable bonds for key attributes, including: coupon rate, yield to worst, maturity date, yield to worst date, call protection, tax status, and ratings. The comparison screenshot may also include issue detail information, additional analytics from an on-demand calculator, recent trades information, and rating alert details. For municipal bonds, the compare screen typically also includes: “Insurer”, “State”, “Federally Taxable”, “Subject to Federal AMT”, “Pre-refunded”, “Escrowed”, and “Bank Qualified”. For corporate securities, the compare screen typically also includes a ticker symbol. The “more” link typically is used if there is a depth of market, which may be shown in a roll-over or expanded view. The sector or subsector field may show an industry, such as “Industrials/Auto” for corporate securities, or use, such as “Revenue/Water&Sewer” for municipal bonds. Some Analytics may be displayed based on user and include: Option Adjusted Spread, Option Adjusted Yield, Option Adjusted Duration, and Option Adjusted Convexity.

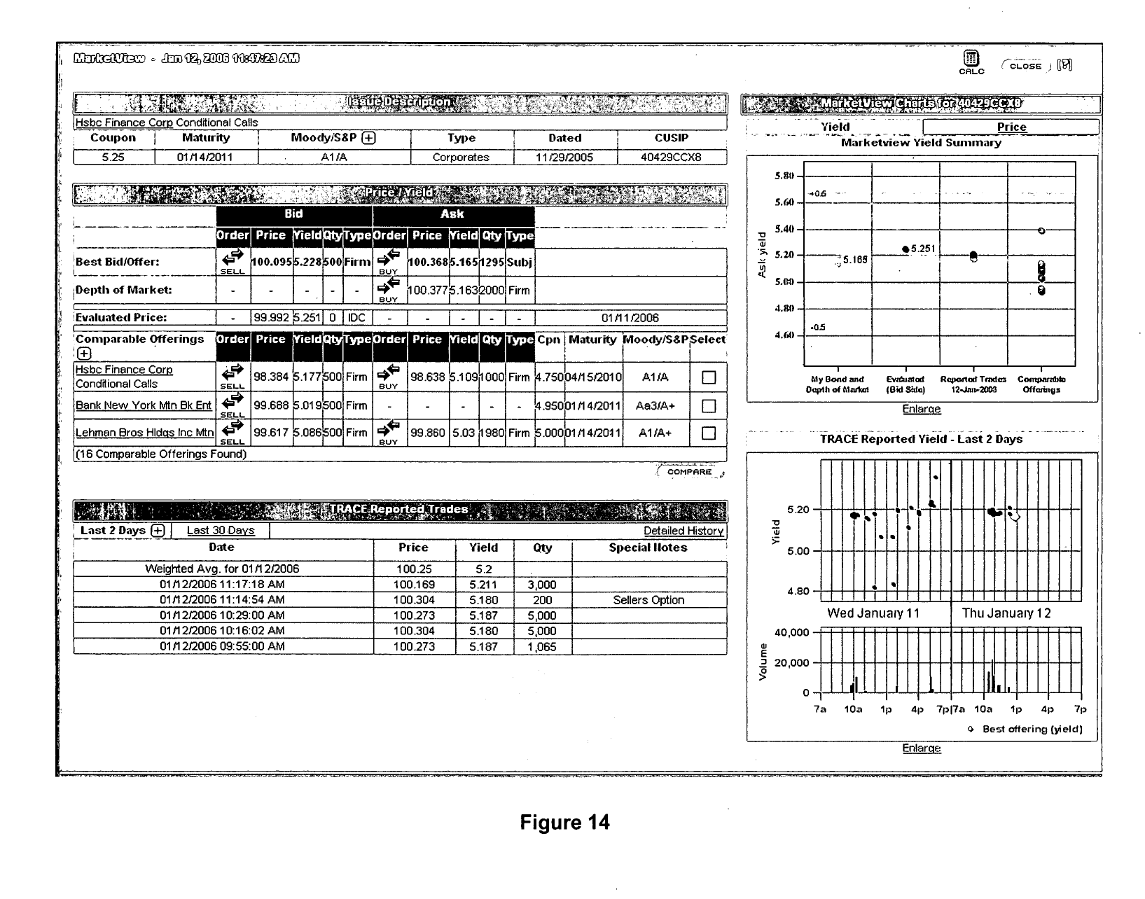

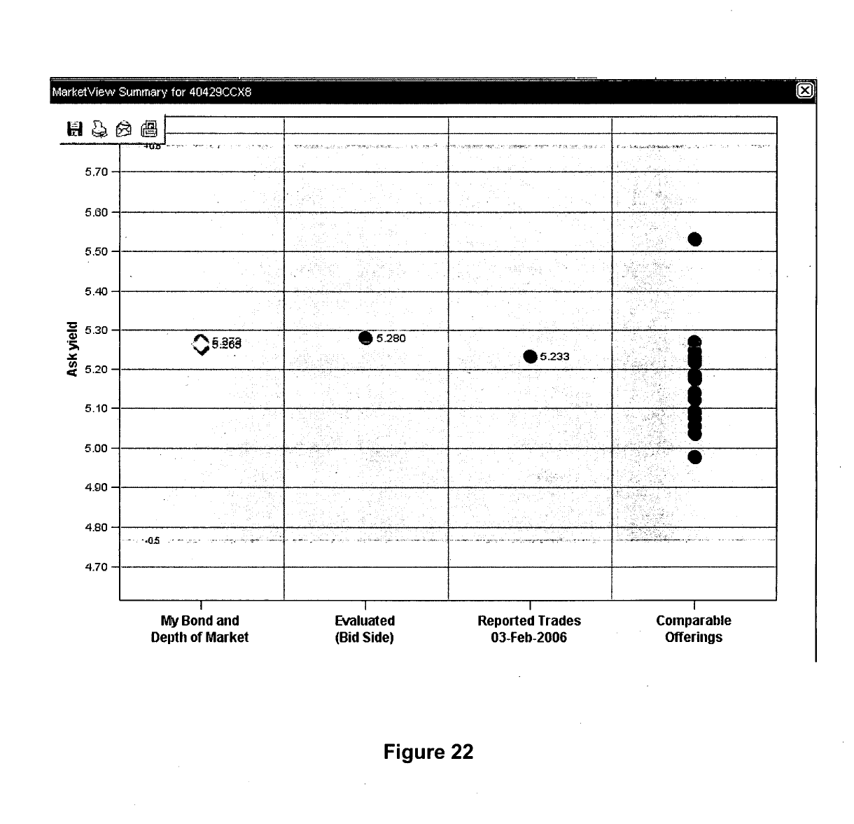

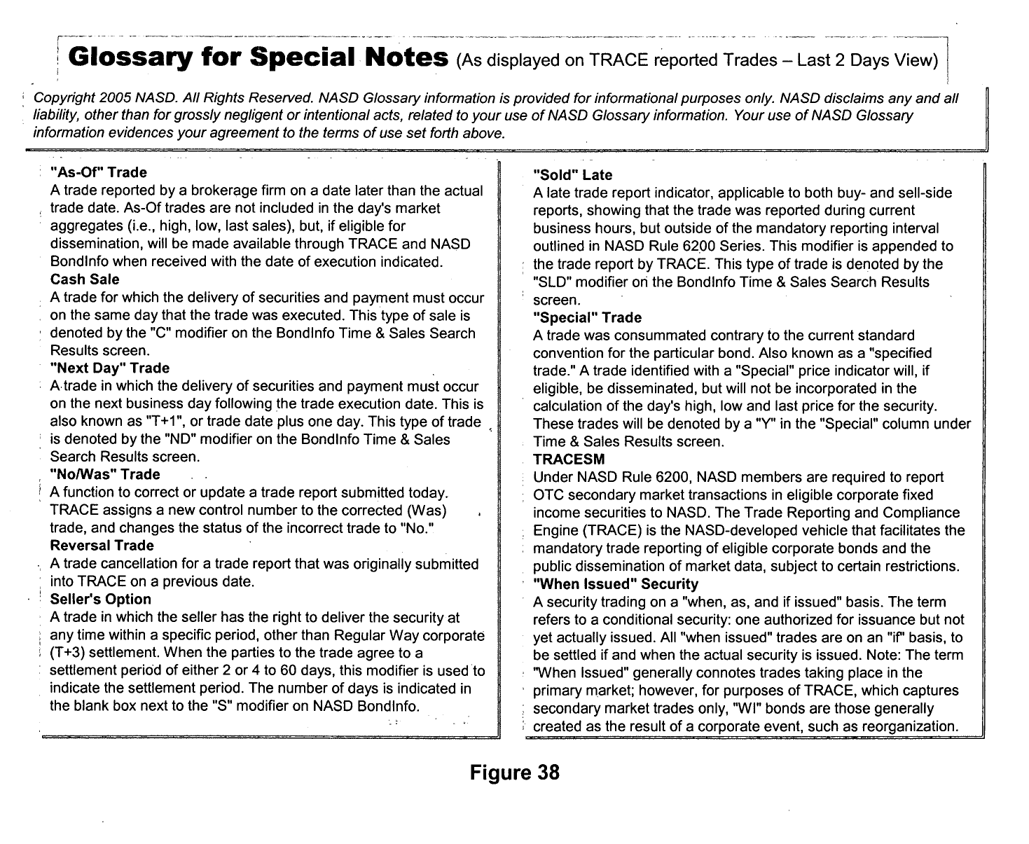

FIG. 14 is an exemplary screenshot illustrating trades of the security over the last two days. The screenshot comprises a reported trades region that includes a graph of yields and volume of the trades of the security over the last two days and a table listing trades and a weighted average of the current day trades. The list of trades may include a scroll window or a pop-up window. The screenshot includes a link for switching the reported trades region to a 30 days view. Although 2 and 30 days trades and views are described herein, the system may provide other numbers of days of reported trades and views. The trades may be displayed in real time or delayed, which may be in accordance with user entitlements. The regions of the screenshots may display an indicator if no trades are reported for the current day or during the reported trade period. The quantity traded typically is displayed at each time period of the trades, along with other relevant information, such as whether the trade was a buy from customer, sell to customer, or inter-dealer trade, and whether the trade had any special characteristics as listed in FIG. 38. In addition to reported trades, trades from other sources can be displayed in this area as well, such as trades executed on ATSs (Alternative Trading Systems) or other trading platforms, or trades executed on other exchanges. A firm's own trades can be highlighted in this section, and the information in this section can be augmented by the firm's proprietary trade information. The summary snapshot is shown in an expanded view in FIG. 22.

FIG. 22 is an exemplary screenshot illustrating an expanded view of the summary of trades for a two day period. A diamond at the most recent time noted on the chart is the user's bond, and is labeled “my bond”. A legend at the bottom of the chart indicates that the diamond is the best offering yield for the bond. The summary snapshot includes yield variance lines, such as +/−0.5% of the yield. These variance lines can be configured by the user. The summary includes the bond the user is evaluating, the depth of market, any evaluation pricing that the user is entitled to see, and trade data. The evaluated bond prices may include “Bid-side” and/or “ask-side” information. The summary may include other yields, such as 2 year, 5 year and 10 year treasury yields, other benchmark yields or indices, comparable offerings and reported trades. This chart can be displayed on a yield or price basis. Benchmark yields typically include US Treasury, MMA or MMD curves.

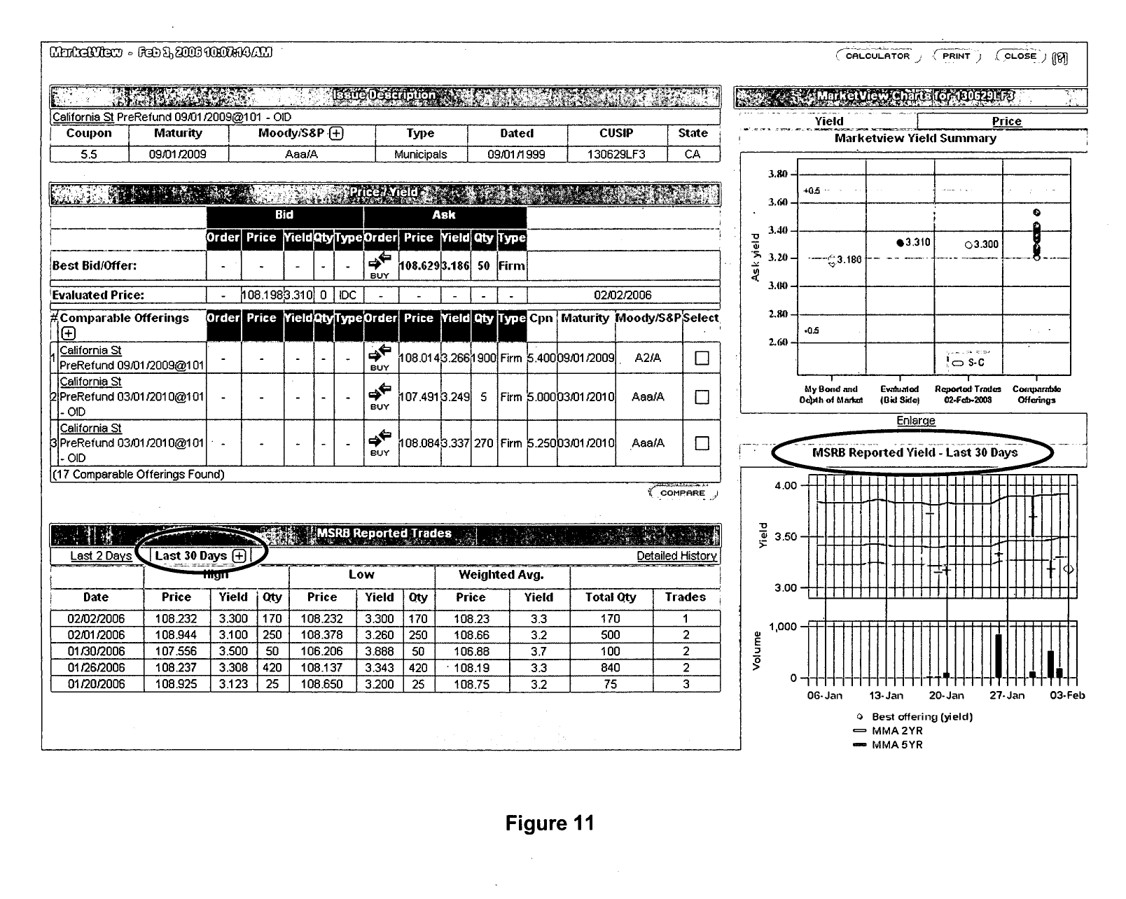

FIG. 11 is an exemplary screenshot illustrating trades of the security over the last thirty days. The screenshot comprises a trades region that includes a graph of yields or prices and volume of the trades of the security over the last thirty days and a table listing summary data of trades for each day. The list of trades may include a scroll window or a pop-up window. The summary data of trades for each day is displayed in columns. The high trade yield and the low trade yield correspond to the lowest price trade and the highest price trade, respectively. The quantity corresponds to the numbers of securities traded at the highest and lowest prices. An asterisk indicates that at least one trade at that price had a special note. The weighted average yield, price and quantity are calculated and displayed, and typically will exclude trade cancellations. The source of the trade information can be regulatory bodies, industry organization, ATS's, other trading platforms, dealers' proprietary trade information, exchanges, or other sources that provide trade information. The chart typically includes other yields, such as 2 year, 5 year and 10 year treasury yields, other benchmark yields or indices, comparable offerings and reported trades. This chart can be displayed on a yield or price basis.

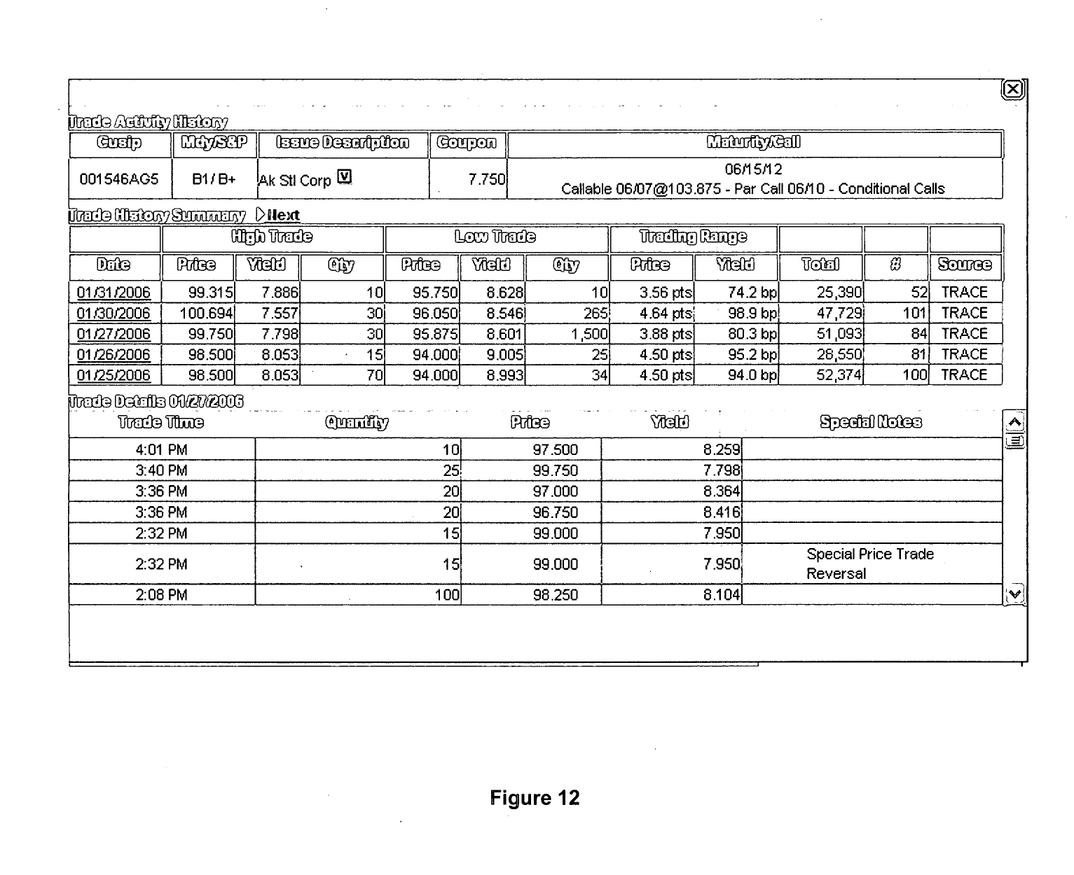

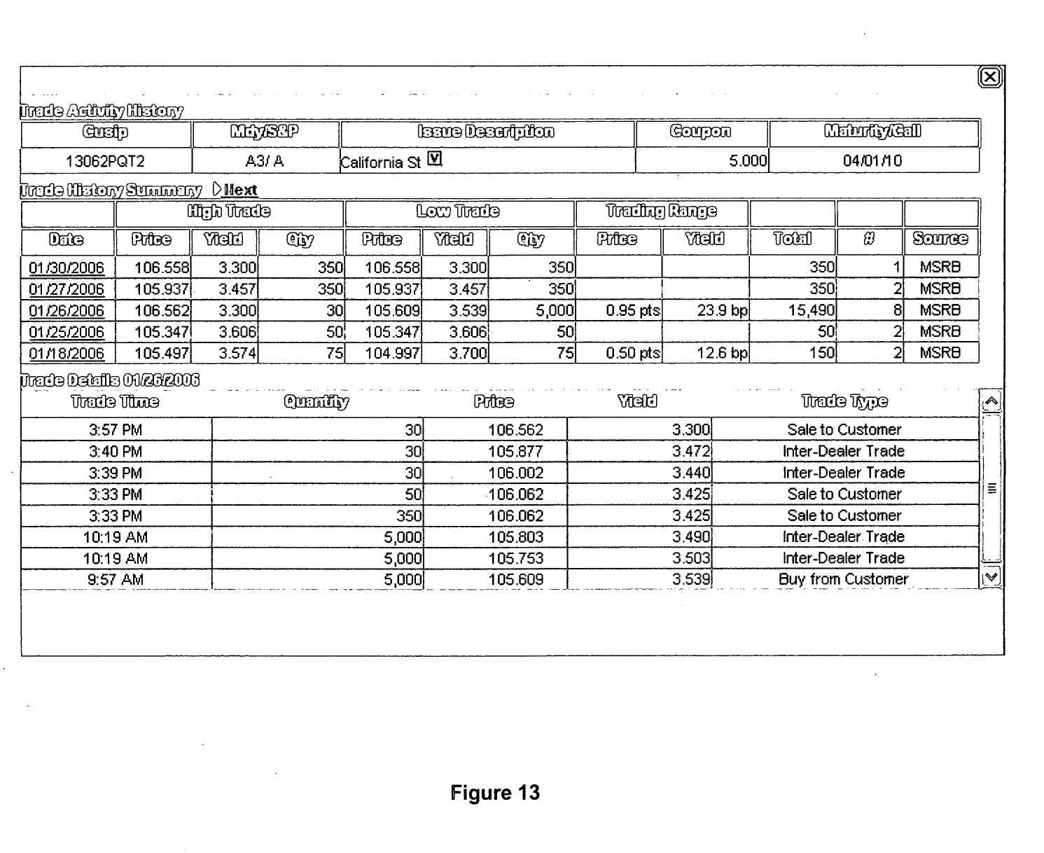

FIG. 12 is an exemplary screenshot illustrating a “show all history” selection from a screenshot for a corporate security. The screen shot includes a special note indicator to the right of the CUSIP, if applicable. If applicable, a ‘Halt’ indicator may be added to the bond's red warning text to appear on the main page for the system 108. FIG. 13 is a screenshot illustrating a “show all history” selection for municipal bonds.

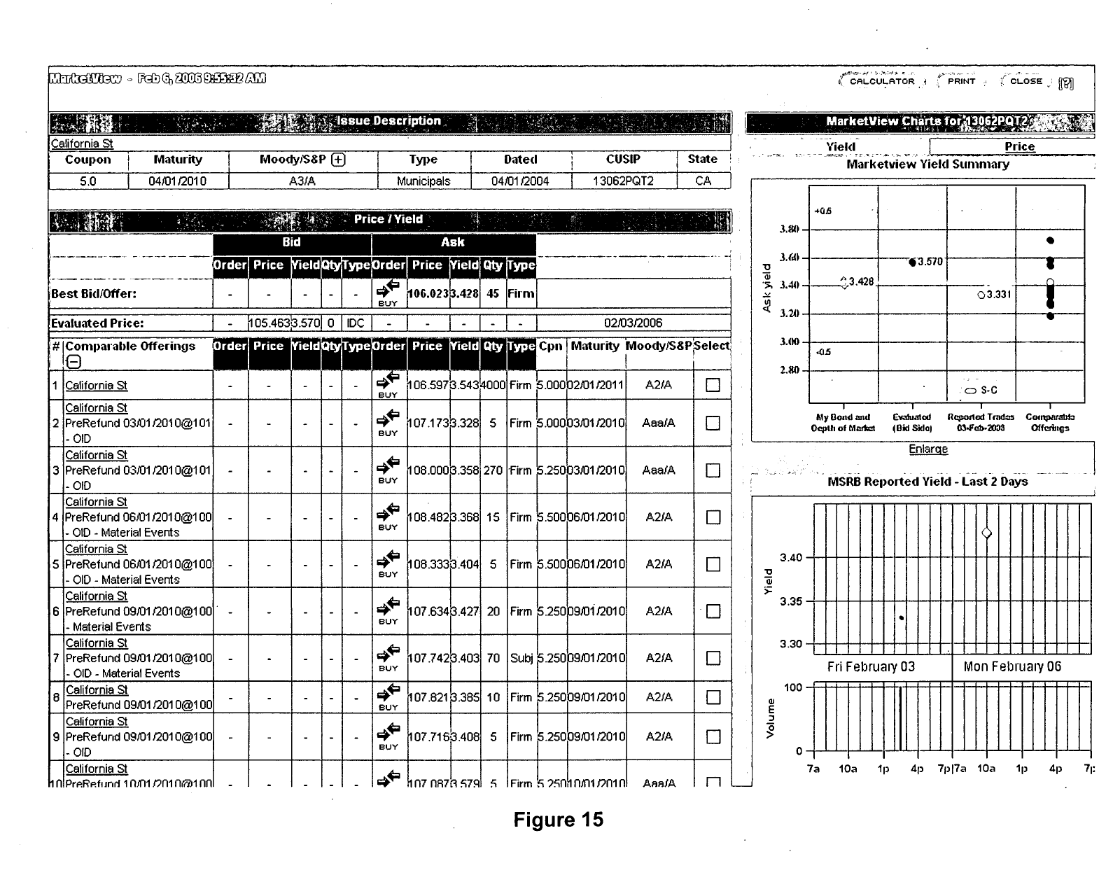

FIG. 15 is a screenshot illustrating a list of comparable offerings, a summary of the yields of the comparable offerings, a list of past trades during a time period (here the last two days), and graphs of the yields and volume of the past trades over a two day period.

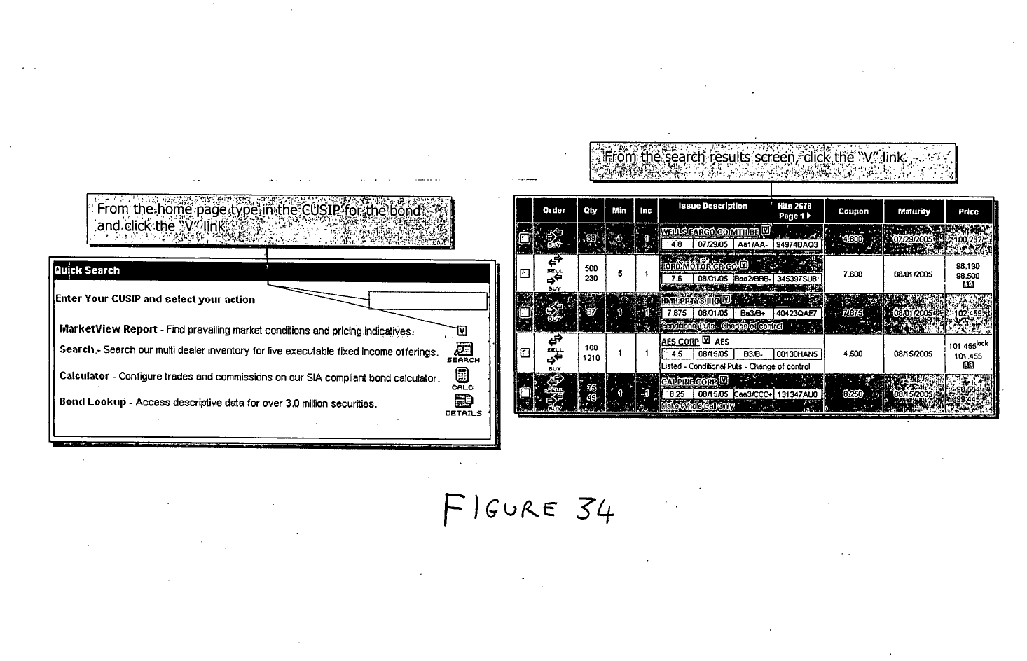

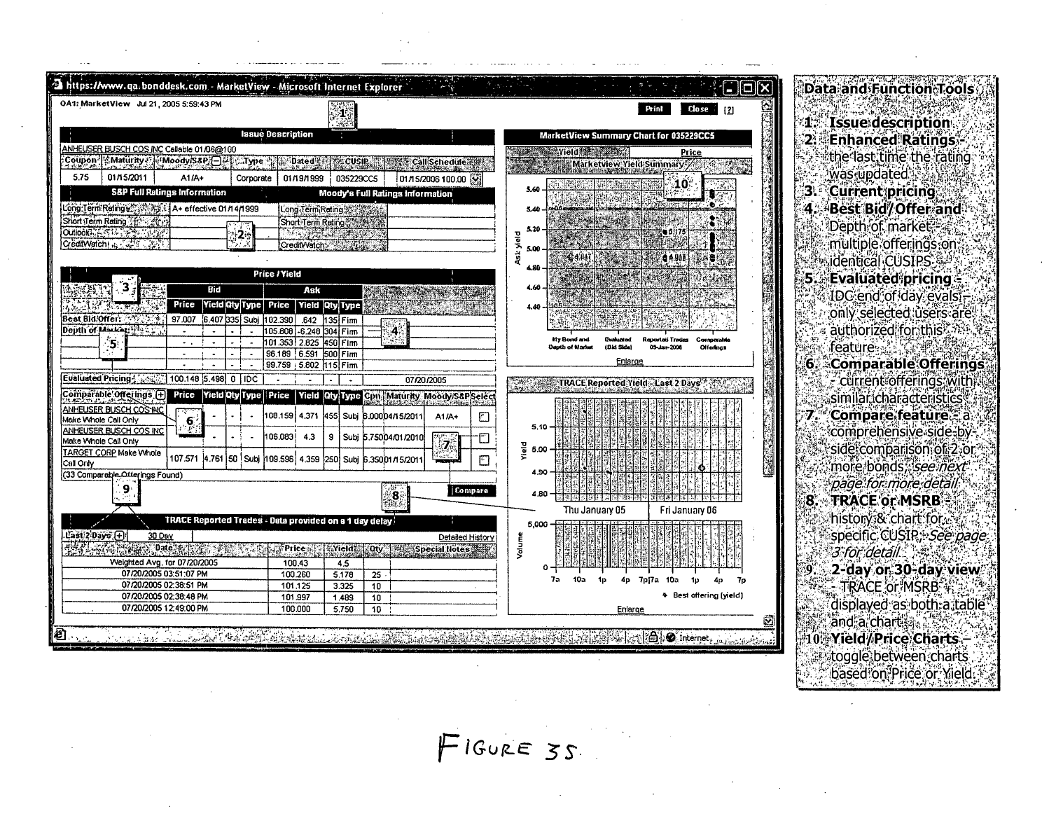

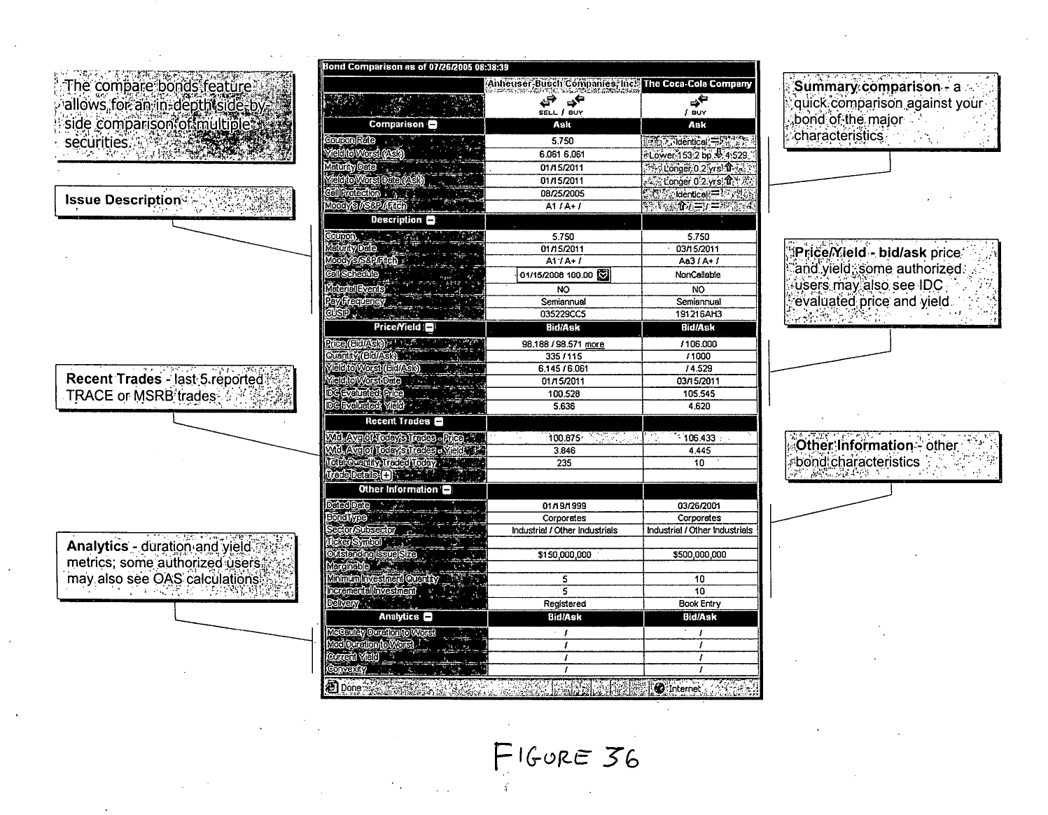

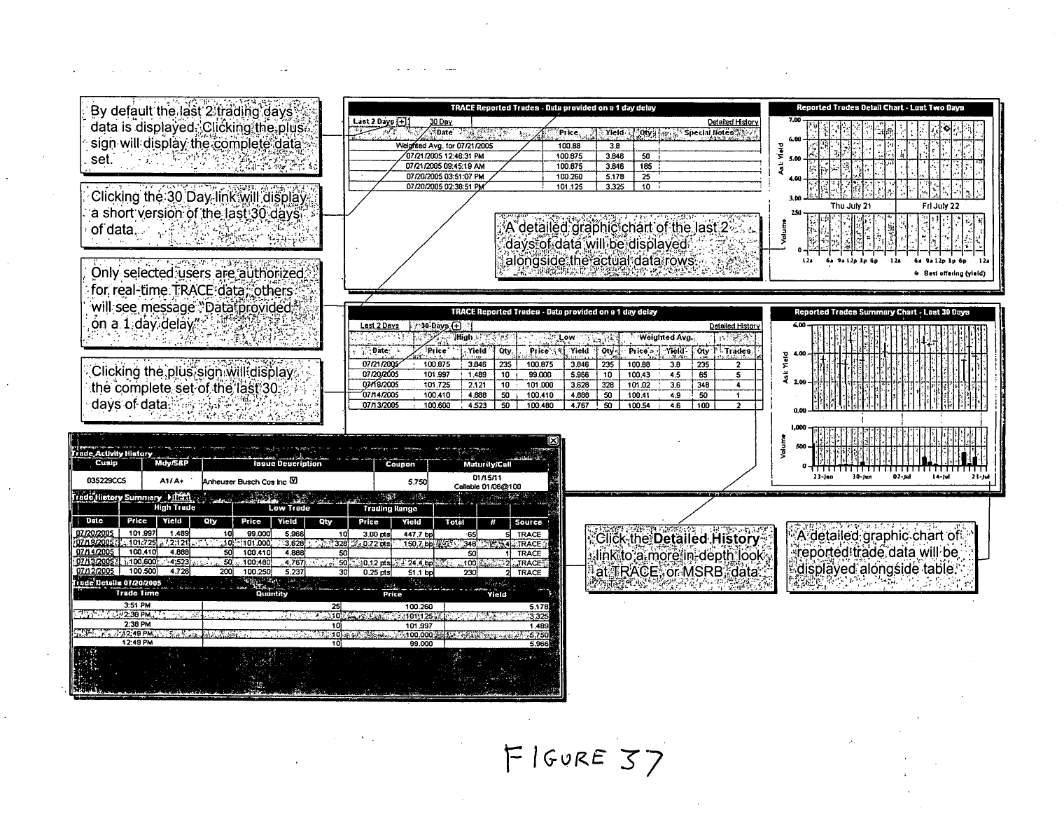

FIGS. 34-37 are exemplary screenshots illustrating a summary of the user operation of the price evaluation system of the system of FIG. 1.

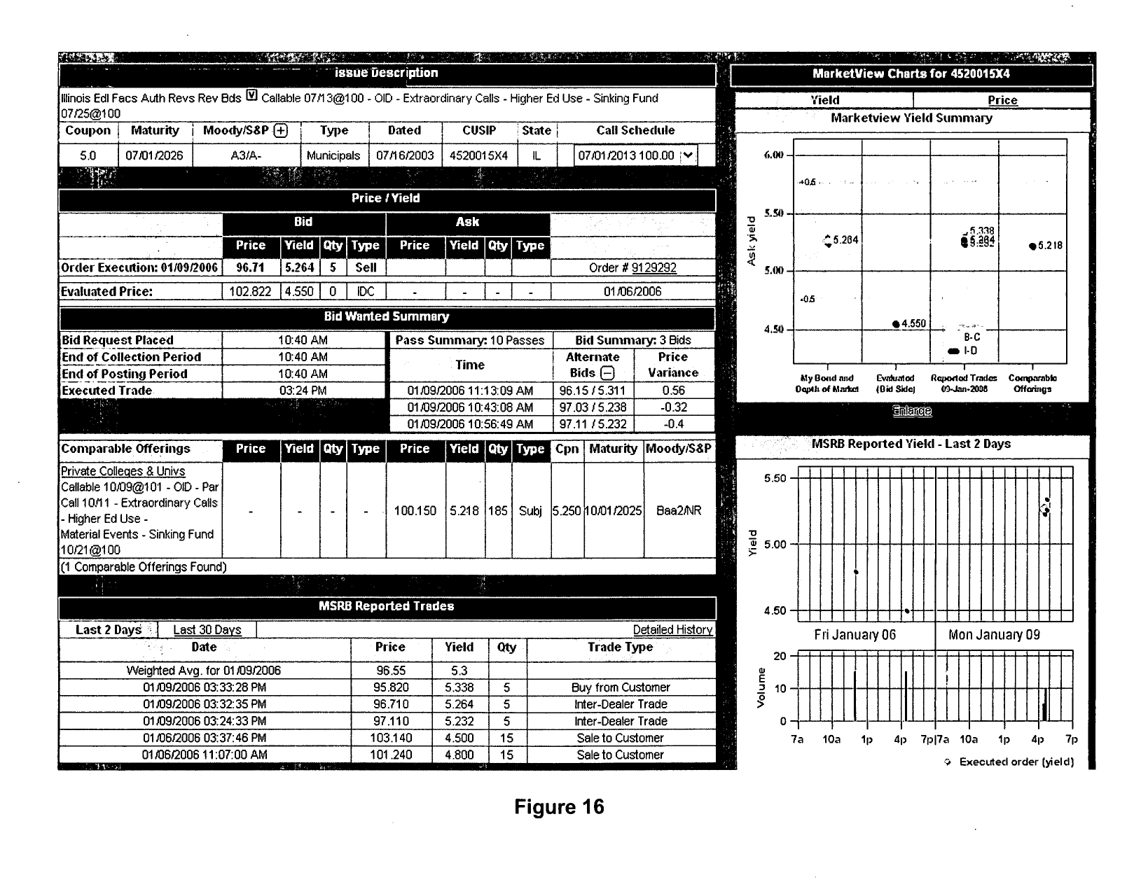

FIG. 16 is a screenshot illustrating data for evaluating a bond after the trade has occurred. The screenshot is similar to the screenshot of FIG. 7, and further includes information for the executed order shown as order execution in FIG. 16. The executed order typically will be added to the data storage system 112 for use in evaluating future trades. The screenshot of FIG. 16 typically also differs from the screenshot of FIG. 7 in the following ways: (1) the order execution line being displayed in bold instead of the best bid/offer line; (2) a bid wanted summary with all relevant bid information is included under a price/yield table if the order was placed through a bid-wanted process; (3) and a comparable bonds table may be separate from the price/yield table; and (4) the reported trades over a time period includes all trades executed on the day of the trade including those executed after the trade. For example, if this execution was done at 10:30am on Jun. 2, 2005, then the post-trade “last 2 days view” shows all trades done in that security through the end of day Jun. 2, 2005.

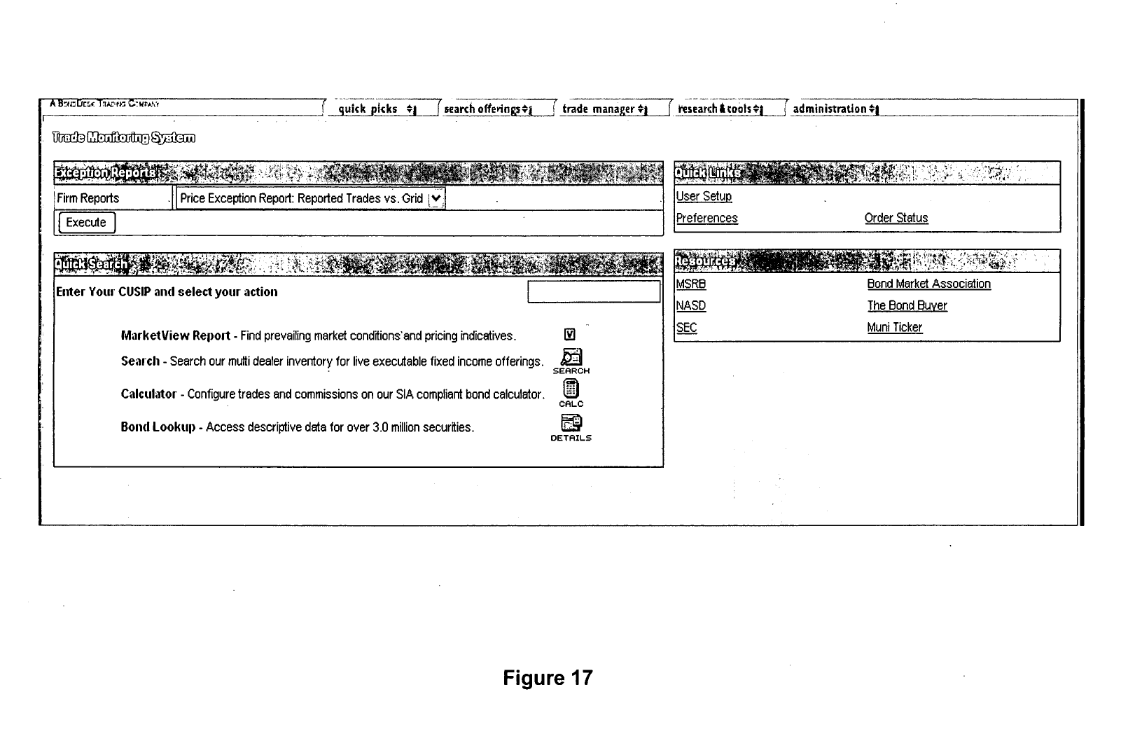

FIG. 17 is a screenshot illustrating a home page for the trade monitoring system 110. The homepage provides a portal into the trade monitoring system 110 including a MarketView display link, trade monitoring system access, trade monitoring system administration including brand reports and correspondent reports, and administrative ability to edit tests, re-test certain trades, or change display options, daily email queries, system group visibility, and resolved status visibility. The home page may be a bridge destination from an external bridged system, in the event that the user 106 wants to connect this product with a different software or trading system

An exception reports section of the screenshot includes a drop down menu of configured tests that may be executed. A “today's summary” section may be included, as shown in the screenshot to indicate tests performed that day, the number of tests that are pending user review, the number of tests that were failed by the TMS system, and the number of tests passed by the TMS system.

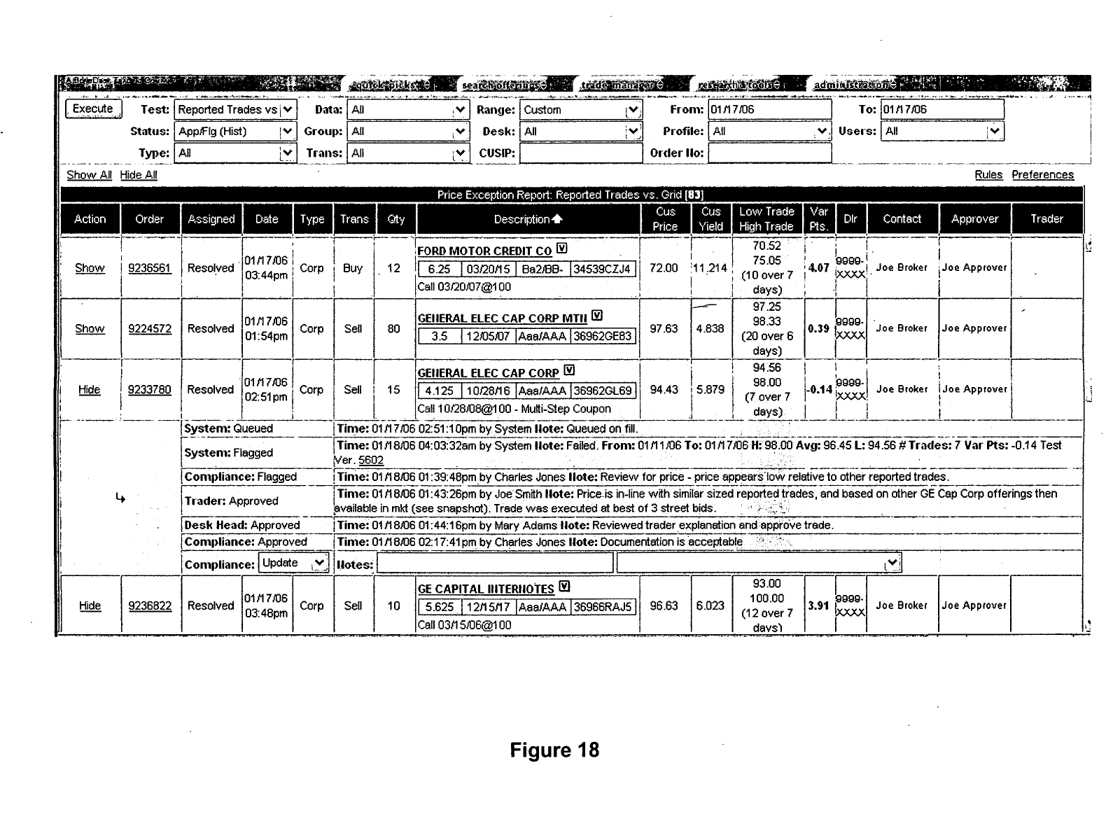

FIG. 18 is an exemplary screenshot illustrating results of a single price exception test. Exception tests for several trades are shown for pending review. A test version number hyperlink provides a link to a Test Summary screen, e.g. version 15265 as shown in FIG. 18. The Test data points used to evaluate the test are displayed on the order level row and again in the test detail rows. The ‘Reported Trades vs. Matrix’ test in this example includes reference price, ‘Low Trade and High Trade,’ and ‘Variance Points.’

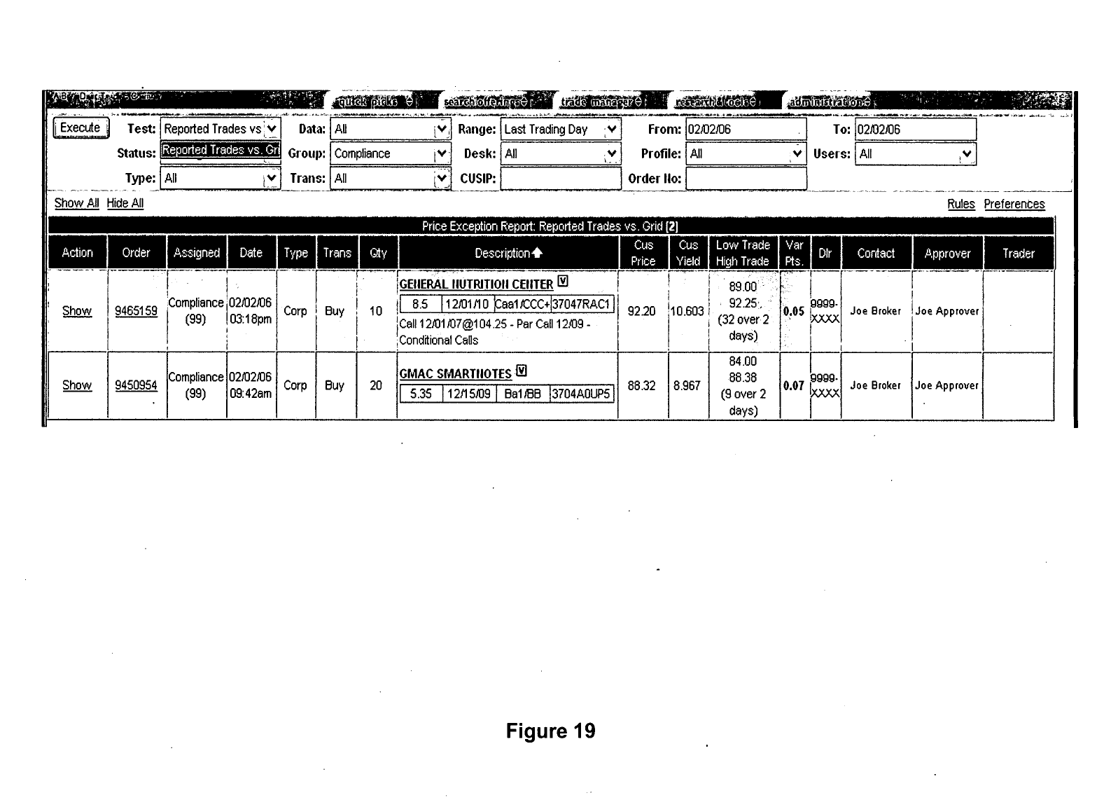

FIG. 19 is a partial screenshot illustrating a drop down menu for user selection. The user selection may be for all groups of users, subgroups of users, or individual users. A status drop down screen may include the status of all tests, tests pending review, tests approved by certain users, or flagged by certain users.

Table I illustrates filter options typically available to different TMS users. Table II is an example of how a user can define order routing for review of exceptions. FIGS. 21A-D are an example of how the user can define the configurable algorithm for comparable offerings. The second to the right and the right hand columns of the FIGS. 21A-D are an example of user choices and an exemplary setting by a user, respectively.

TABLE I

| | Filter options | | | | | | |
|---|---|---|---|---|---|---|---|
| TMS Group | Test | Date | Type | Trans | Cusip | Order | Group |
| Trader | — | Range | All | All | | | All |
| | | To | Muni | Buy | | | Trader |
| | | From | Corp | Sell | | | System (if entitled) |
| Desk Head | — | Range | All | All | | | All |
| | | To | Muni | Buy | | | Trader |
| | | From | Corp | Sell | | | Desk Head |
| | | | | | | | System (if entitled) |
| Compliance | — | Range | All | All | | | All |
| | | To | Muni | Buy | | | Trader |
| | | From | Corp | Sell | | | Desk Head |
| | | | | | | | Compliance |
| | | | | | | | System (if entitled) |
| FI Trading | — | Range | All | All | | | All |
| Head | | To | Muni | Buy | | | Trader |
| | | From | Corp | Sell | | | Desk Head |
| | | | | | | | Compliance |
| | | | | | | | FI Trading Head |
| | | | | | | | System (if entitled) |

| | Filter options | | | |
|---|---|---|---|---|
| TMS Group | Status | Desk | Profile | User |
| Trader | Pending | — | All | — |
| | Approved | | Profiles | |
| | Flagged | | Associated | |
| | Approved/Flagged | | | |
| | Resolved (if entitled) | | | |
| Desk Head | Pending | — | All | All |
| | Approved | | Desk Profiles | All Users |
| | Flagged | | | |
| | Approved/Flagged | | | |
| | Resolved (if entitled) | | | |
| Compliance | Pending | All | All | All |
| | Approved | WS-TAX | All Profiles | All Users |
| | Flagged | WS-MUNI | | |
| | Approved/Flagged | | | |
| | Resolved (if entitled) | | | |
| FI Trading | Pending | All | All | All |
| Head | Approved | WS-TAX | All Profiles | All Users |
| | Flagged | WS-MUNI | | |
| | Approved/Flagged | | | |
| | Resolved (if entitled) | | | |

TABLE II

| # | Expected Views Required | Test | Date | Type | Trans | Status | Group | Desk | Profile | User | Alternate View |
|---|---|---|---|---|---|---|---|---|---|---|---|
| 1 | Approved by System | | | | | Approved | System | | | | Resolved System |
| 2 | Flagged by System | | | | | Pending | System | | | | Pending Compliance |
| 3 | Pending Compliance | | | | | Pending | Compliance | | | | Flagged System |
| 4 | Approved by Compliance | | | | | Approved | Compliance | | | | Resolved Compliance |
| 5 | Flagged by Compliance | | | | | Flagged | Compliance | | | | Pending Trader |
| 6 | Pending Any Trader | | | | | Pending | Trader | | | | Flagged Compliance |
| 7 | Pending Any Trader in | | | | | Pending | Trader | Desk | | | Flagged Compliance |
| | Specific Desk | | | | | | | | | | |
| 8 | Pending Any Trader in a | | | | | Pending | | | Profile | | Flagged Compliance |
| | Specific Profile | | | | | | | | | | |
| 9 | Pending Specific Trader | | | | | Pending | | | | User | Flagged Compliance |
| 10 | Approved by Any Trader | | | | | Approved | Trader | | | | Pending Desk Head |
| 11 | Approved by Any Trader | | | | | Approved | Trader | Desk | | | Pending Desk Head |
| | in Specific Desk | | | | | | | | | | |
| 12 | Approved by Any Trader | | | | | Approved | | | Profile | | Pending Desk Head |
| | in Specific Profile | | | | | | | | | | |
| 13 | Approved by Specific | | | | | Approved | | | | User | Pending Desk Head |
| | Trader | | | | | | | | | | |
| 14 | Re-Booked by Any Trader | | | | | Flagged | Trader | | | | Pending System |
| 15 | Re-booked by Any | | | | | Flagged | Trader | | | | Pending System |
| | Trader in Specific Desk | | | | | | | | | | |
| 16 | Re-booked by Any Trader | | | | | Flagged | | | Profile | | Pending System |
| | in Specific Profile | | | | | | | | | | |
| 17 | Re-Booked by Specific | | | | | Flagged | | | | User | Pending System |
| | Trader | | | | | | | | | | |
| 18 | Pending Any Desk Heads | | | | | Pending | Desk Head | All | | | Approved Trade/Flagged |
| | | | | | | | | | | | Compliance |
| 19 | Pending Any Desk Heads | | | | | Pending | Desk Head | Desk | | | Approved Trade/Flagged |
| | in Specific Desk | | | | | | | | | | Compliance |
| 20 | Pending Specific Desk | | | | | Pending | | | | User | Approved Trade/Flagged |
| | Head (e.g. Jim Stebner) | | | | | | | | | | Compliance |
| 21 | Approved by Any Desk | | | | | Approved | Desk Head | | | | Pending Compliance |
| | Heads | | | | | | | | | | |
| 22 | Approved by Any Desk | | | | | Approved | Desk Head | Desk | | | Pending Compliance |
| | Heads in Specific Desk | | | | | | | | | | |
| 23 | Approved by Specific | | | | | Approved | | | | User | Pending Compliance |
| | Desk Head | | | | | | | | | | |
| 24 | Flagged by Any Desk | | | | | Flagged | Desk Head | All | | | Pending Trader |
| | Heads | | | | | | | | | | |
| 25 | Flagged by Any Desk | | | | | Flagged | Desk Head | Desk | | | Pending Trader |
| | Heads in Specific Desk | | | | | | | | | | |
| 26 | Flagged by Specific | | | | | Flagged | | | | User | Pending Trader |
| | Desk Head | | | | | | | | | | |
| 27 | Pending Any FI Trading | | | | | Pending | FI Trading Head | | | | Flagged Compliance2 |
| | Head | | | | | | | | | | |
| 28 | Pending Specific FI | | | | | Pending | | | | User | Flagged Compliance2 |
| | Trading Head | | | | | | | | | | |
| 29 | Approved by Any FI | | | | | Approved | FI Trading Head | | | | Resolved FI Trading Head |
| | Trading Head | | | | | | | | | | |
| 30 | Approved by Specific FI | | | | | Approved | | | | User | Resolved FI Trading Head |
| | Trading Head | | | | | | | | | | |
| 31 | Flagged by FI Trading | | | | | Flagged | FI Trading Head | | | | Pending Trader |
| | Head | | | | | | | | | | |
| 32 | Flagged by Specific FI | | | | | Flagged | | | | User | Pending Trader |
| | Trading Head | | | | | | | | | | |

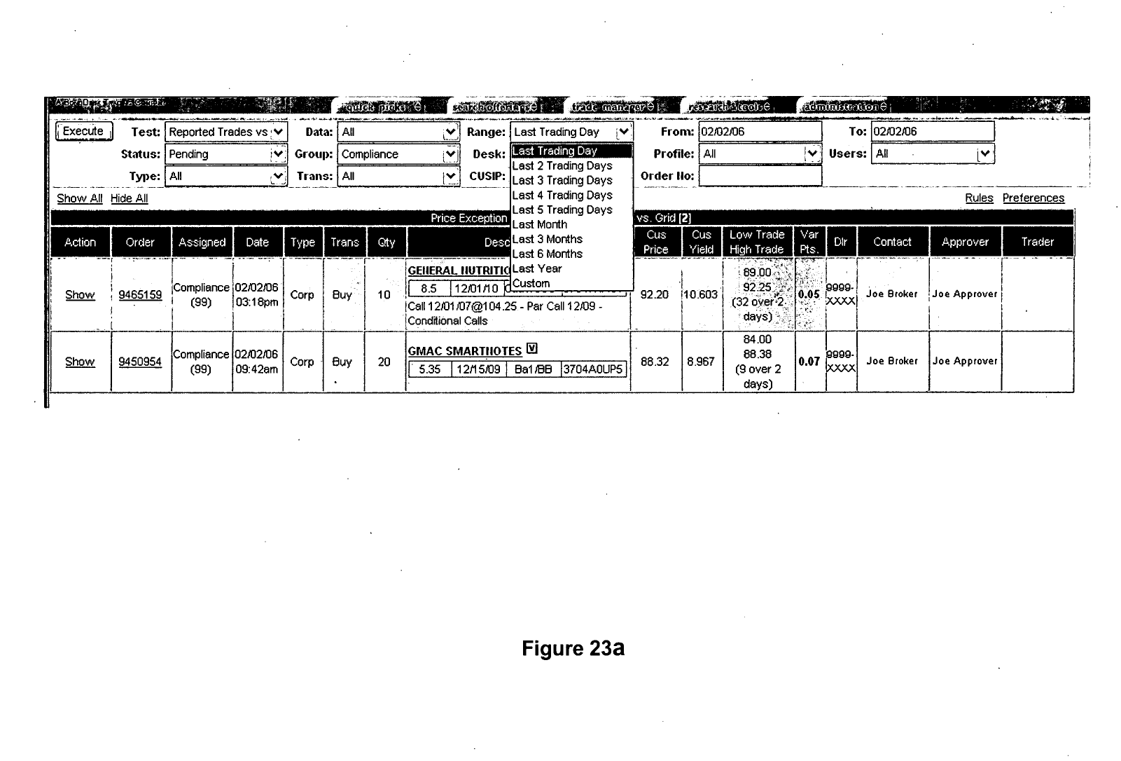

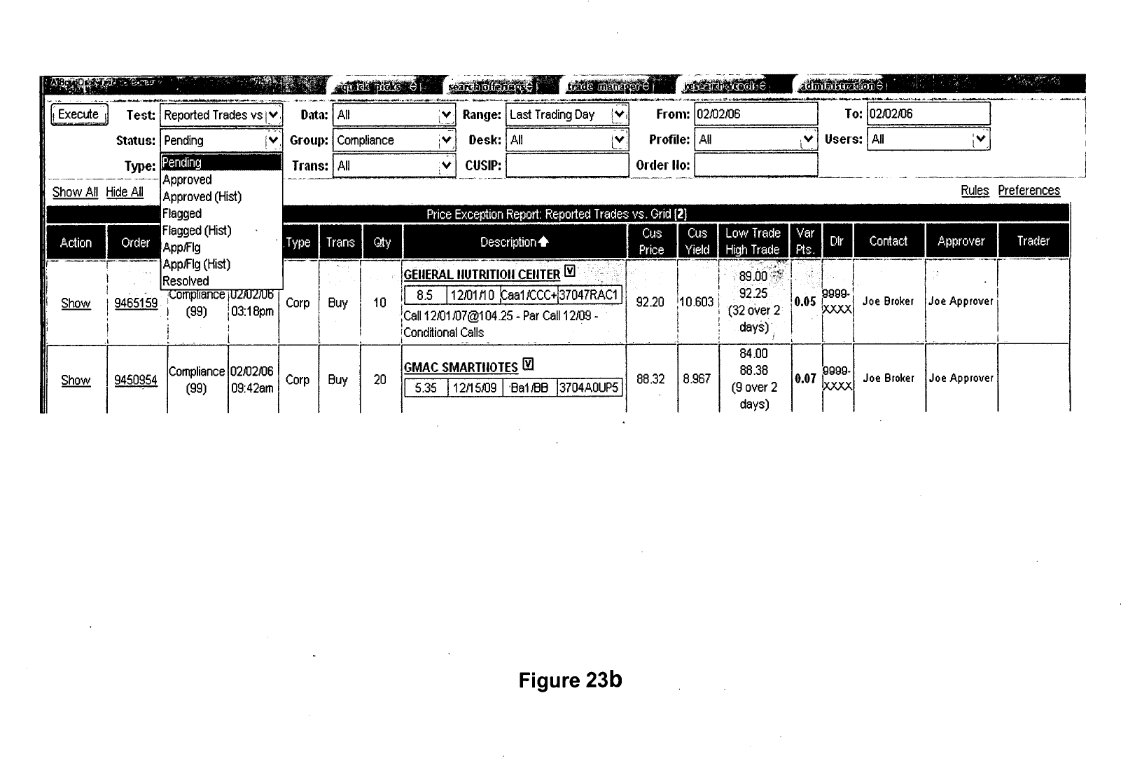

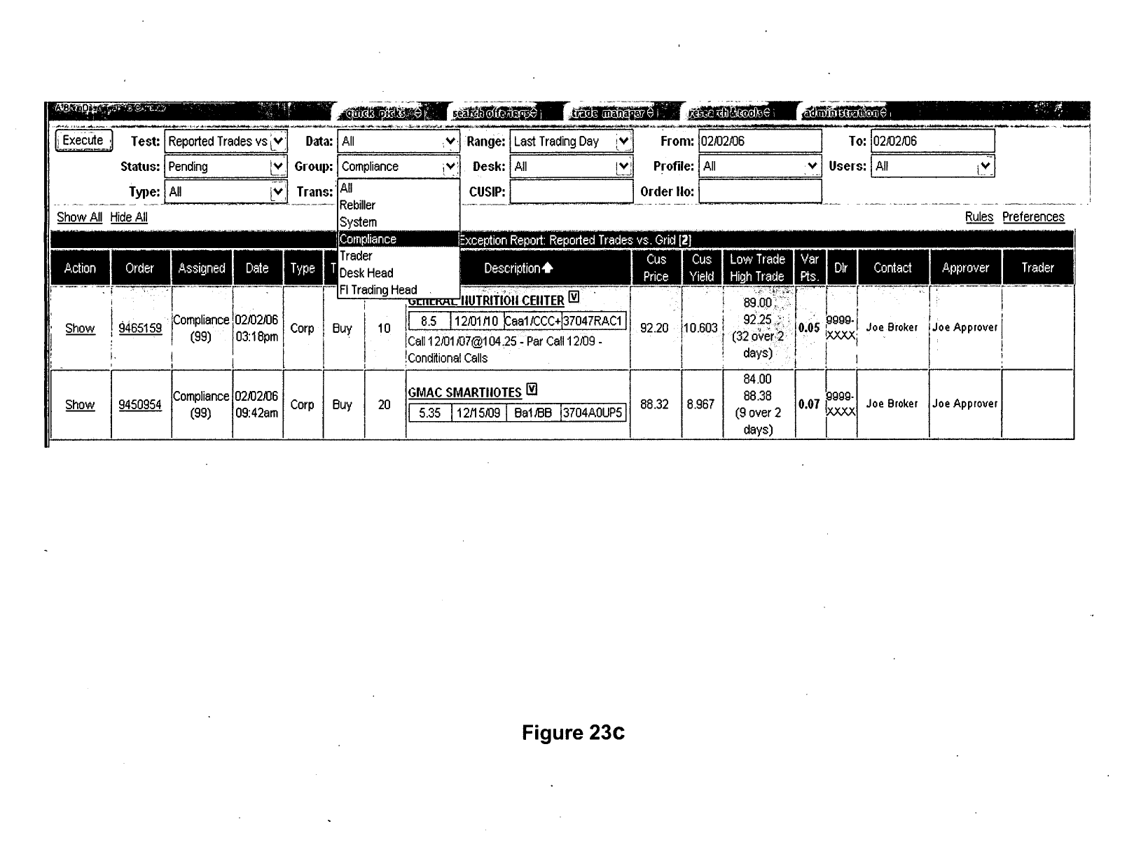

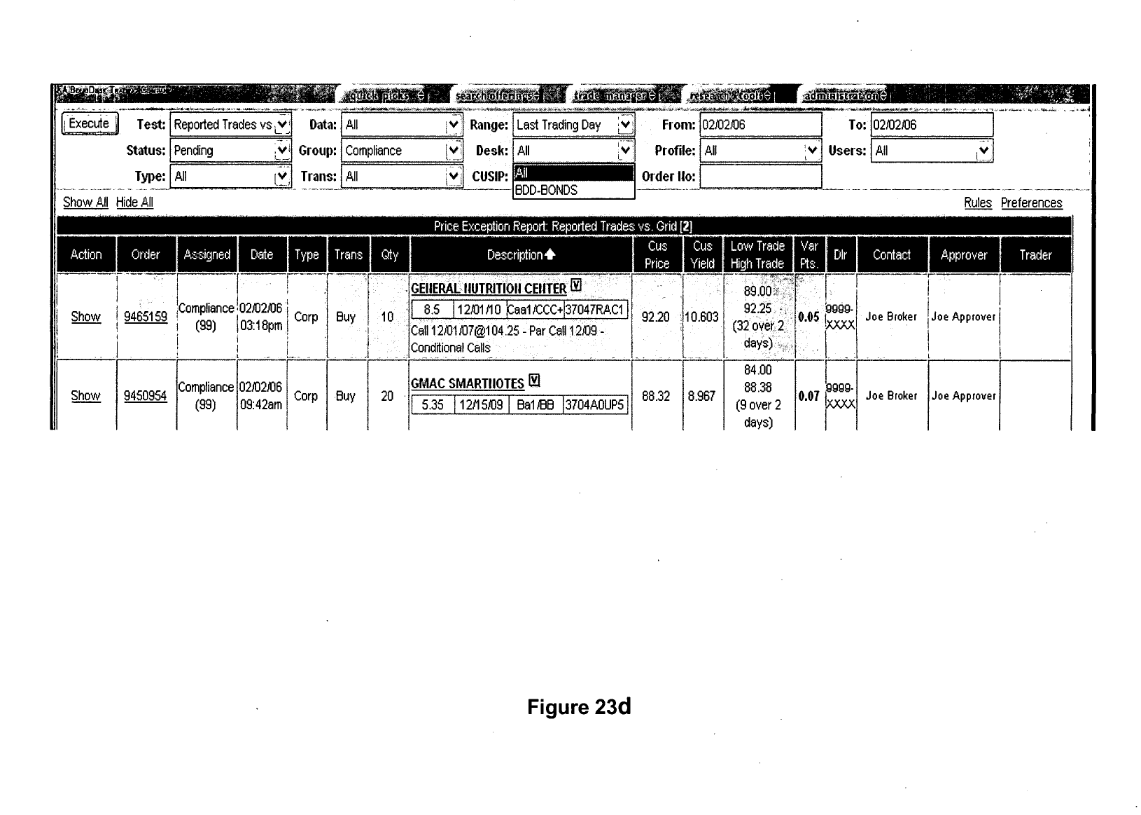

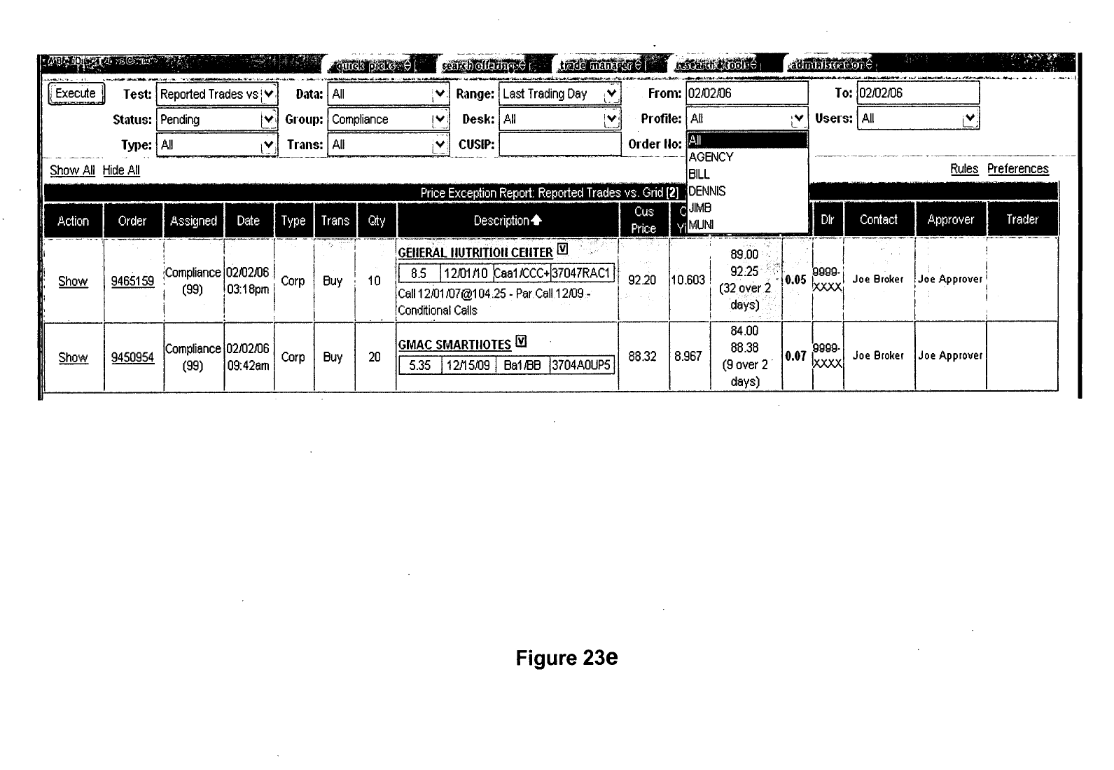

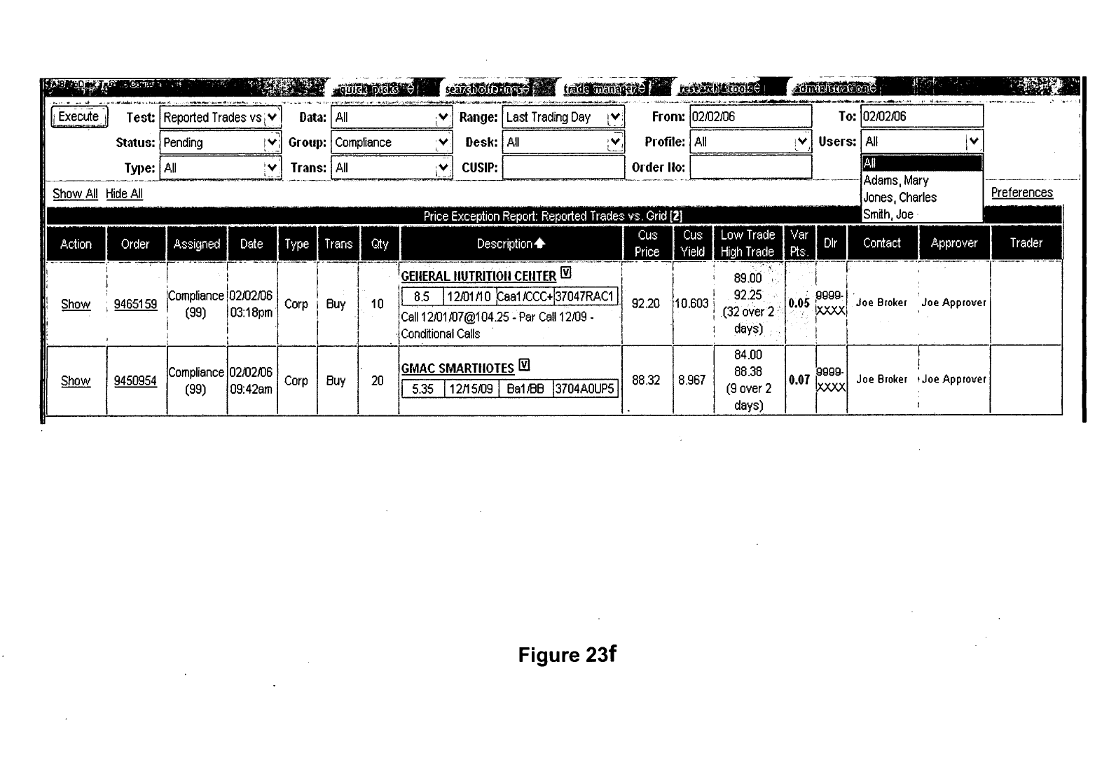

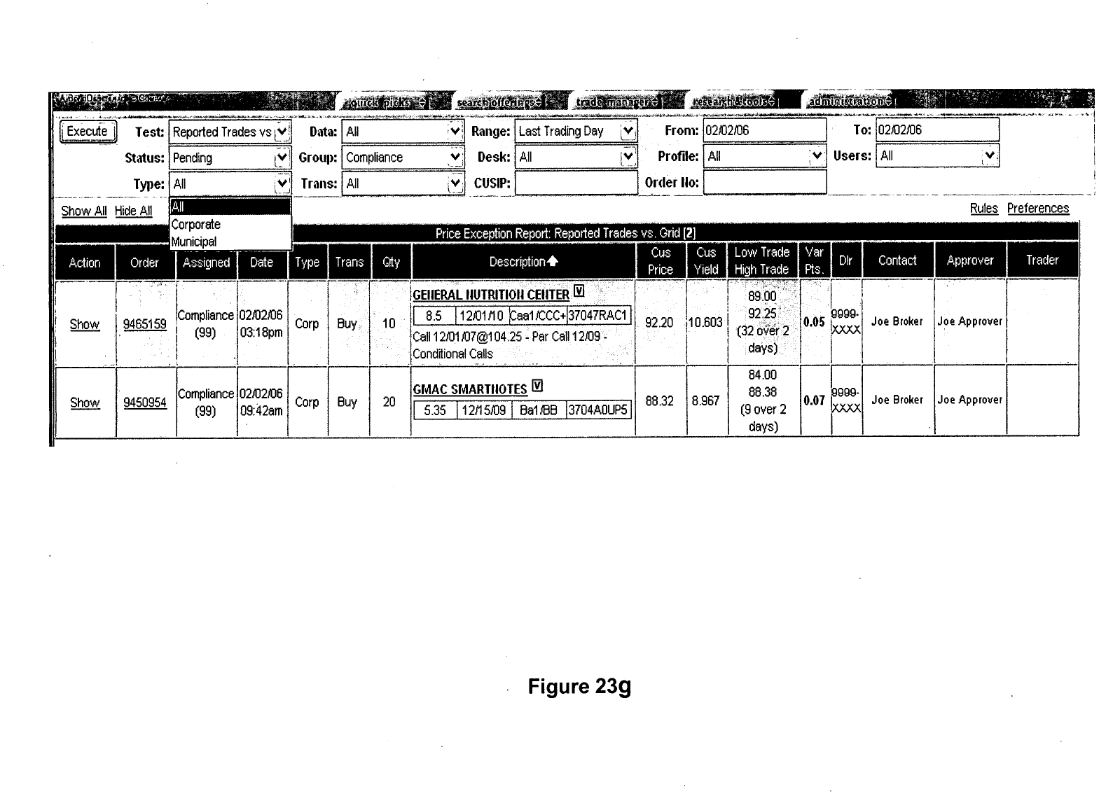

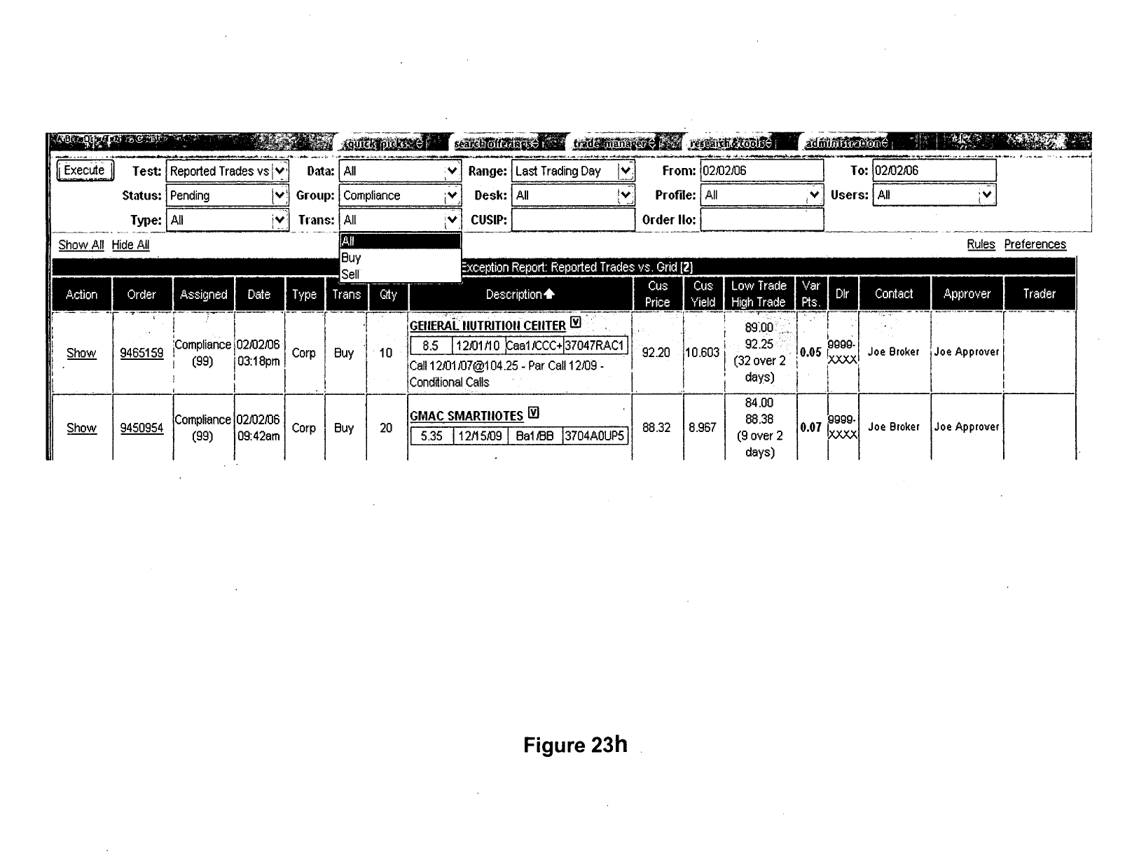

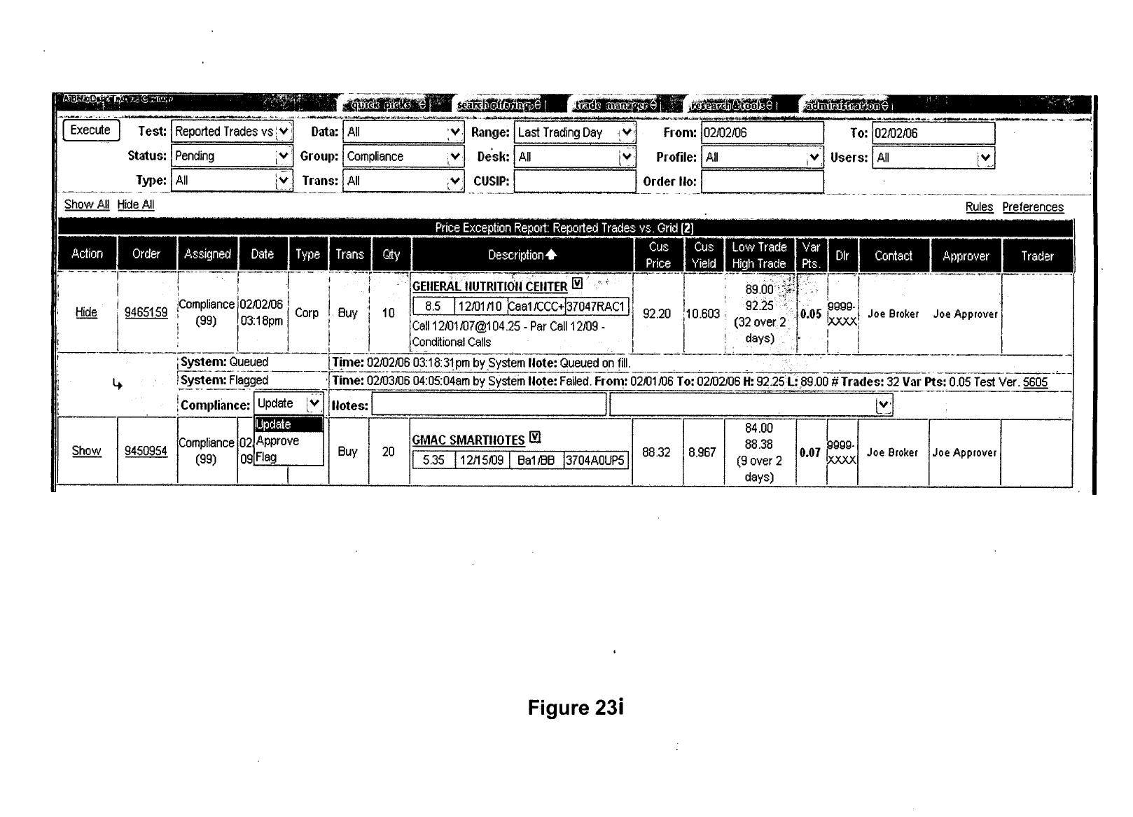

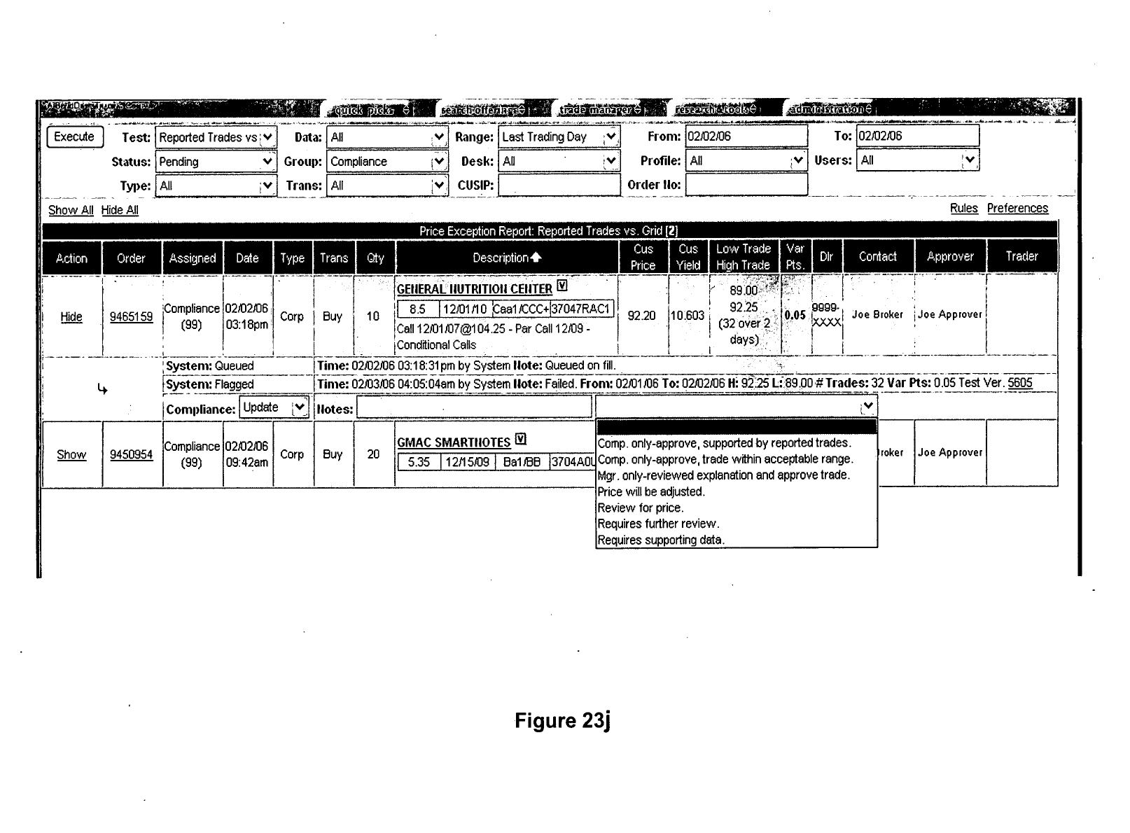

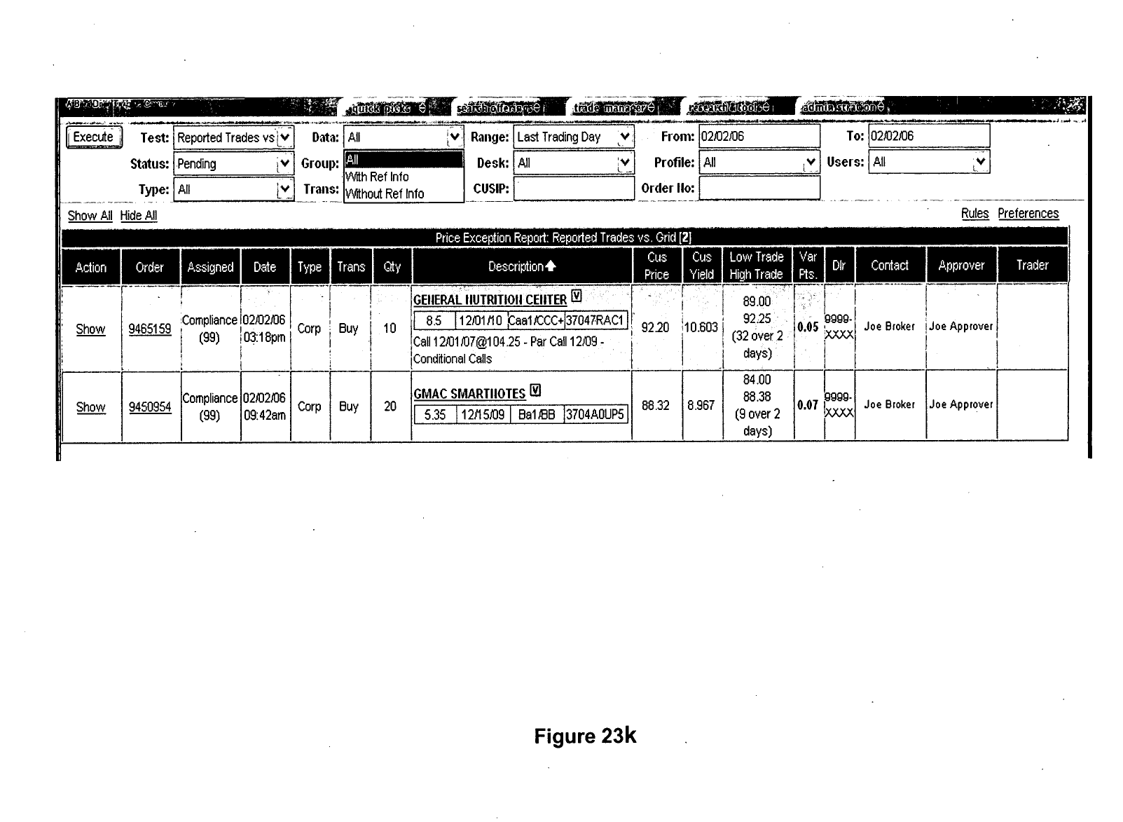

FIG. 23 is a screenshot illustrating a test approval screen. A user clicks an “execute” ton to apply approval status and notes updates. The trade monitoring system 110 may generate an alert message during the test approval if the user fails to enter the required notes on each approval status update, fails to click the ‘execute’ button to apply the approval status or the note changes, or when updating a test with approval status and notes and the test has already been updated by another user while displayed on this user's screen. Approvals notes may be selected from a drop-down menu or written in free form. The drop down menu may include:
Price will be adjusted
Review for price
Requires further review

FIG. 24 is a screenshot illustrating a test summary. Different users may have different entitlement options for the “action” view and editing for each test. Administrators typically will edit test details to be applied to the next batch run. Ad-hoc query capabilities allow the user to experiment with new query conditions to view results.

FIG. 25 is a screenshot illustrating a data input screen for test administration.

FIG. 26 is a screenshot illustrating an ad hoc test query. The user 106 may run an ad-hoc query to test various criteria against the customer price.

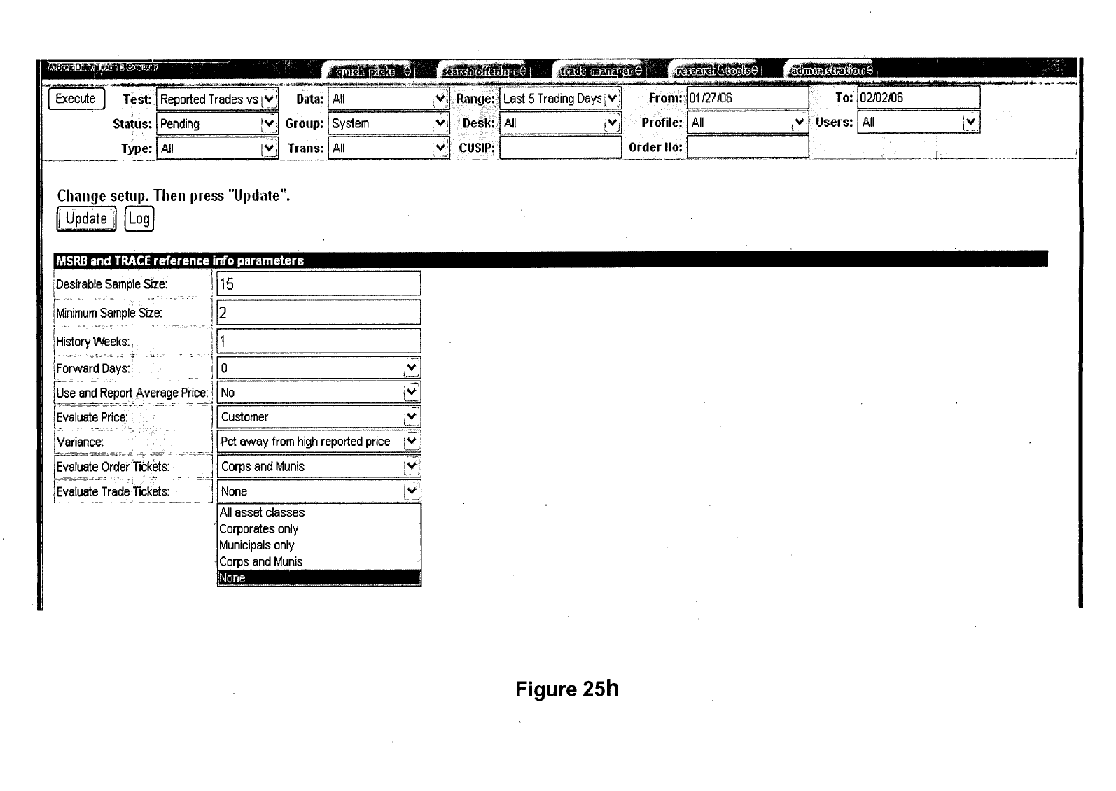

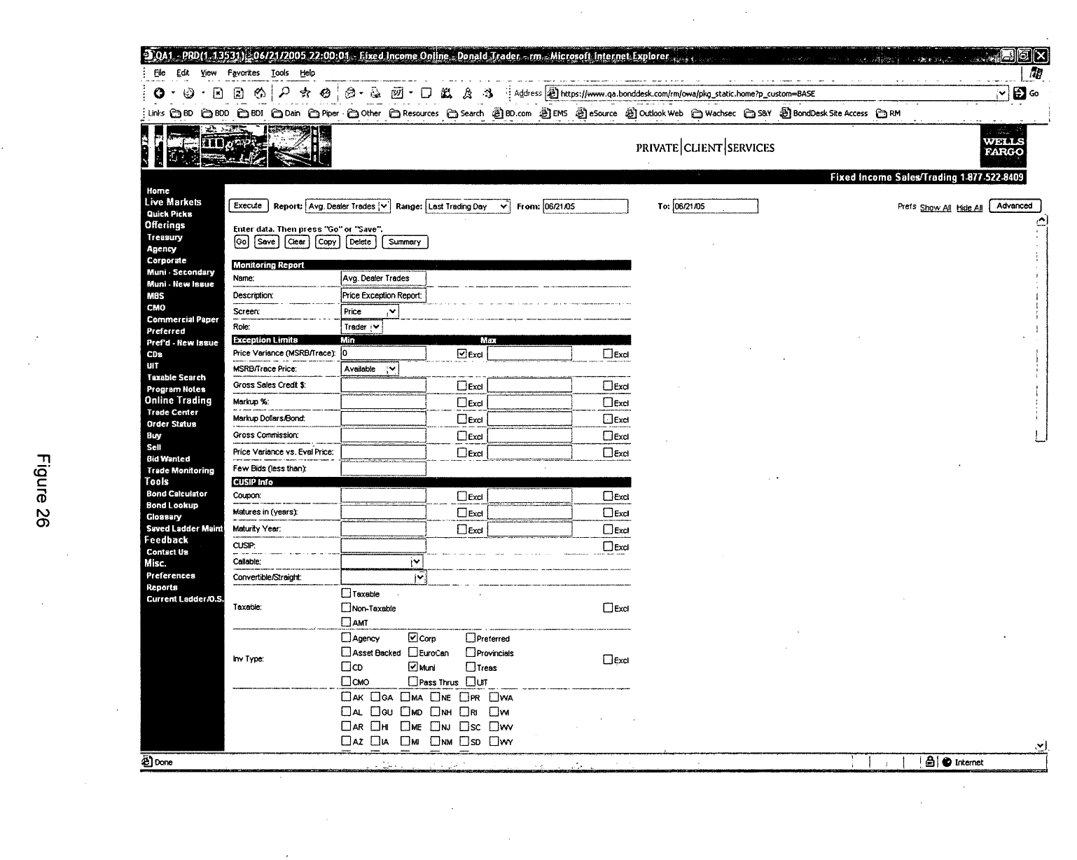

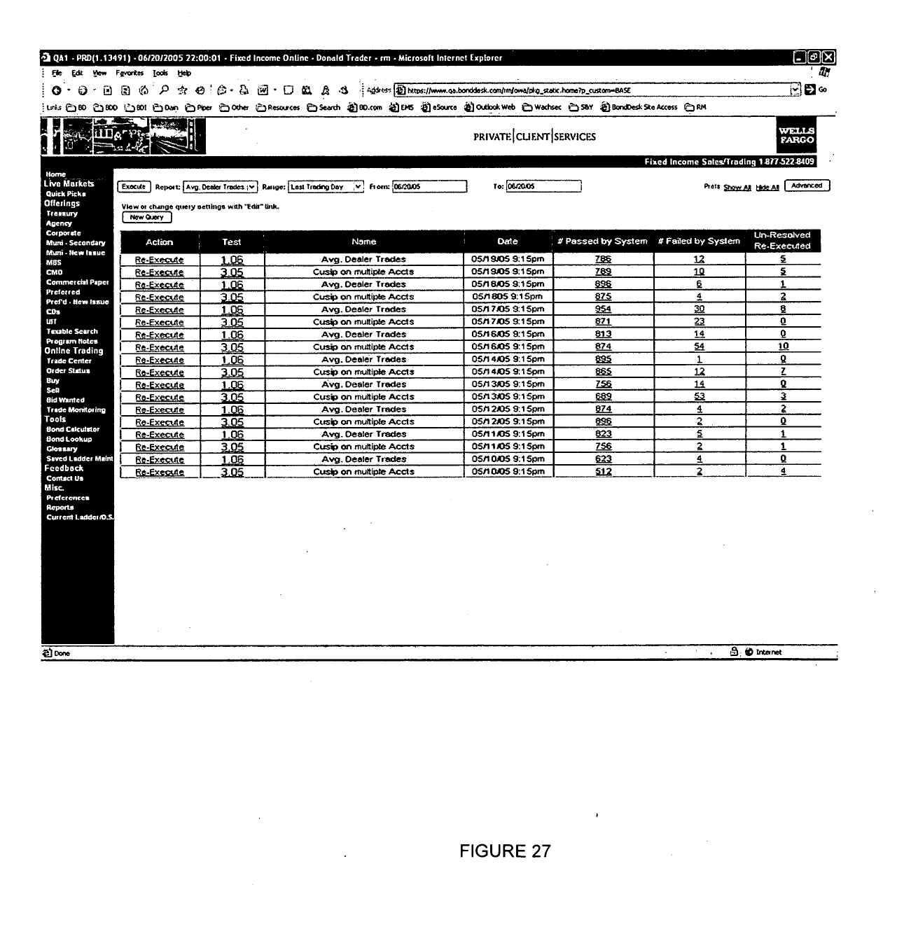

FIG. 27 is a screenshot illustrating a test execution summary. A ‘Re-Execute’ hyperlink on the ‘Edit Test’ screen allows the user to specify any additional criteria to be re-tested with a ‘Re-Execute’ button. The test execution summary includes hyperlinks to the TMS tests to display the results available in the execution summary columns, and include the number passed by the system, the number failed by the system, and the un-resolved and re-executed tests.

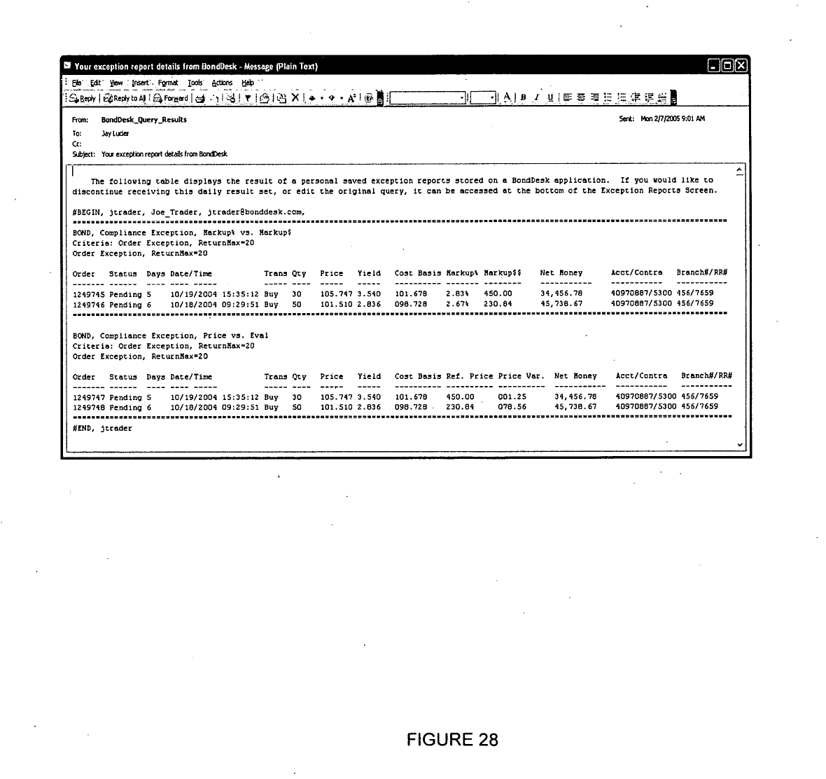

FIG. 28 is a screenshot illustrating an exemplary email of exception tests. Emails may be sent to alert specific users or groups of users that they have trade exceptions that are pending their review.

FIG. 29 is a flow diagram for approval of exception reports. Group 1, such as compliance group, reviews all exceptions, list users, and flags for review. Group 2, such as traders responsible for the trade, reviews the trade. The routing logic of the trade monitoring system 110 is used to assign the trade. Group 3, such as desk head, reviews the trader's reason for approvals. Group 4, such as compliance, reviews approvals and flags for review. Group 5, such as head of FI trading, reviews the flagged approvals. The system monitors and flags orders that have not passed the configured exception tests. Typically the system is only executed on a scheduled routine time every day to flag the exceptions. Administrative personnel will be equipped with an interface to re-execute a schedule test to re-generate the exceptions for the day, order #, CUSIP, etc. A rebiller refers to the client user group that is response for canceling and rebilling the orders on the system. Once a trade is rebilled, the system 100 automatically re-tests the trade. All notes and tests passed or failed will be saved and archived in the data storage system 112, along with the re-test results and any additional notes. This information is archived for a period of time, typically seven years.

### Exception Test Example

The user 106 defines an exception test, which explains what will be compared, and what test will be performed to surface a given trade as an exception.

As an example, the user 106 can define a test to compare past trades against the user's customer trades. The user 106 may compare its customers' municipal trades against MSRB reported trades, corporate trades against TRACE trades, and trades in other asset classes (CDs, Treasuries, Agencies, Mortgages, and similar classes.) against the universe of trades executed a trading system, such as BondDesk ATS.

The user may use a matrix (e.g., matrix I) to determine when each customer trade would be marked as an exception.

WHEN TO MARK MY CUSTOMER TRADES AS AN EXCEPTION (MATRIX I)

| If Spread btwn past | | | | |
|---|---|---|---|---|
| trades | Years to Price-to-Worst-Date | | | |
| High and Low is: | 0-.99 yrs | 1-4.99 yrs | 5-14.99 yrs | 15+ yrs |
| <1.5 point | cust buy at high; | Never | Never | Never |
| | cust sell at low | | | |
| 1.5-2.99 points | cust buy at high; | cust buy at high; | cust buy at high; | Never |
| | cust sell at low | cust sell at low | cust sell at low | |
| 3-3.99 points | cust buy w/in 1.5% of high; | cust buy w/in 1% of high; | cust buy w/in 0.5% of high; | cust buy w/in 0.5% of high; |
| | cust sell w/in 1.5% of low | cust sell w/in 1% of low | cust sell w/in 0.5% of low | cust sell w/in 0.5% of low |
| 4-5.99 points | cust buy w/in 1.5% of high; | cust buy w/in 1% of high; | cust buy w/in 0.5% of high; | cust buy w/in 0.5% of high; |
| | cust sell w/in 1.5% of low | cust sell w/in 1% of low | cust sell w/in 0.5% of low | cust sell w/in 0.5% of low |
| 6+ points | Always | cust buy w/in 1.5% of high; | cust buy w/in 1% of high; | cust buy w/in 0.5% of high; |
| | | cust sell w/in 1.5% of low | cust sell w/in 1% of low | cust sell w/in 0.5% of low |

A user 106 may vary the Matrix I based on the Bond's maturity, Years until the price-to-worst date, Bond Ratings (e.g., Moody's/S&P/Fitch), Size of Trade, Type of Bond, and Asset Class.

The user 106 may choose to compare his client's executions only against past trades which were the same side of the market.

A version number is assigned to each rule in the above matrix, and this version number is saved with every exception. As new test rules are added, new version numbers are created.

The exception test above relies on a subset of past trades to be compared against the user's customer trades. A user 106 may then define logic to specify exactly which past trades should be compared against his customers' trades. Below is an example of such logic:
Look at all trades which occurred on the same day the user's customer traded the bond; find highest-price trade (“high trade”) and lowest price trade (“low trade”)
A. If there were 15 or more trades in the same security on the same day that my trade was executed, then use all of that day's trades as the subset for reported trades.
B. If not, look back up to 5 trading days at most, but stop at the most recent day for which the cumulative number of trades equals 15 or greater, for the days between T and T−[X] (for which [X] is <or =5).
C. If there are at least 3 but less than 15 trades in the last five trading days, then use all of the trades from the last 5 trading days as the subset of reported trades.
D. If there is only 1 reported trade in the last 5 trading days, then re-queue for testing on T+1, and include T+1 trades in the subset
E. If there is only 1 trade in that security from T−5 through T+1, then report “insufficient data available”, and execute a second exception test, comparing my customer's execution against a comparable offering; surface as exception if customer price is more than 3% different from other selected comparable offerings.

A user 106 may define entitlements for individuals using the user's access to the system 100. The entitlements may include the group that the individual belongs, the display format for data, and data access.

The trade monitoring system 110 generates an exception report by comparing all bond executions (customer prices) against the TRACE, MSRB, or BondDesk ATS prices from the subset of reported trades found in the band analysis above. The trade monitoring system 110 surfaces problem trades as exceptions if the execution fails one of the boxes in the Matrix I above.

In an Insufficient Data Condition, the system reviews the trades which do not have sufficient data with which to run the above exception report. The user 106 may define a second exception test against another data set, such as third party price or comparable offerings, in the event that their first exception test results in insufficient data.

The trade monitoring system 110 may provide the users 106 with alerts in response to pending compliance exceptions. The trade monitoring system 110 may provide a report when multiple users 106 bought or sold the same security at different prices.

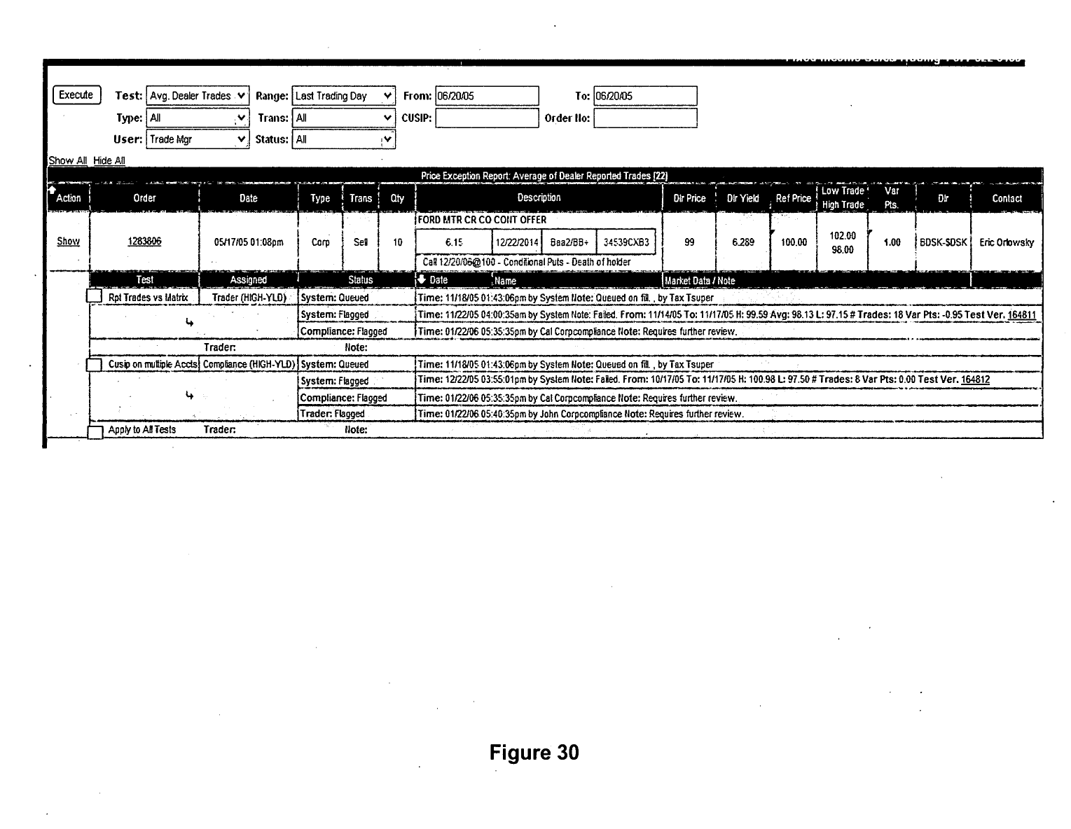

FIG. 30 is a screenshot illustrating a multiple test screen view. Test checkboxes to identify which subset of the tests are to have the approval status and notes applied to them. Initially all the test checkboxes will be checked to have the approval status and notes applied to all tests on the order. The user is required to un-check those tests that the approval status and notes do not apply to.

The trade monitoring system 110 typically generates alerts to a user when updating a test with approval status and notes and the test has already been updated by another user while displayed on this user's screen. The trade monitoring system 110 may also provide alerts, notifications or emails for a number of past days since last traded (either reported or like security), a status change made that is a level above a specified “requires review” level, a level of activity or event that set an alerts, show spread to treasury for Corporate like bonds and reported trades, called bonds, printed or downloaded reports, or expanded starting page or dashboard.

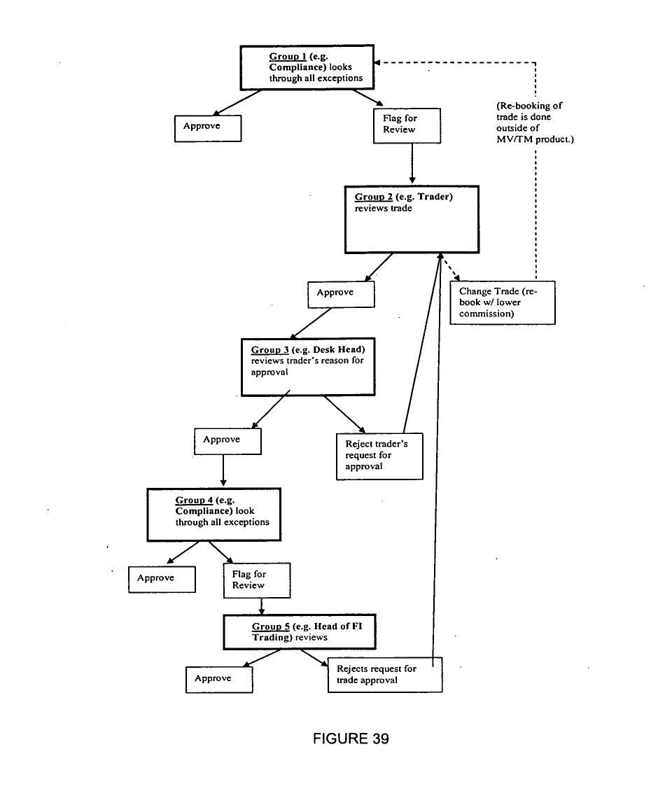

FIG. 39 is a flow diagram illustrating the methodology for approval of exception reports. The user 106 defines an approval flow chart for trades that get flagged as exceptions. The flow chart of FIG. 39 defines who looks at the exception first, what actions he can take, and who that exception flows to next. When a trade exception has been assigned to a particular user per the flow chart, it then shows up in that person's “pending” to-do list on his TMS screen. That person would then either approve or flag the trade, and enter notes. All notes and approval data are visible to all users, and cannot be altered by any subsequent users.

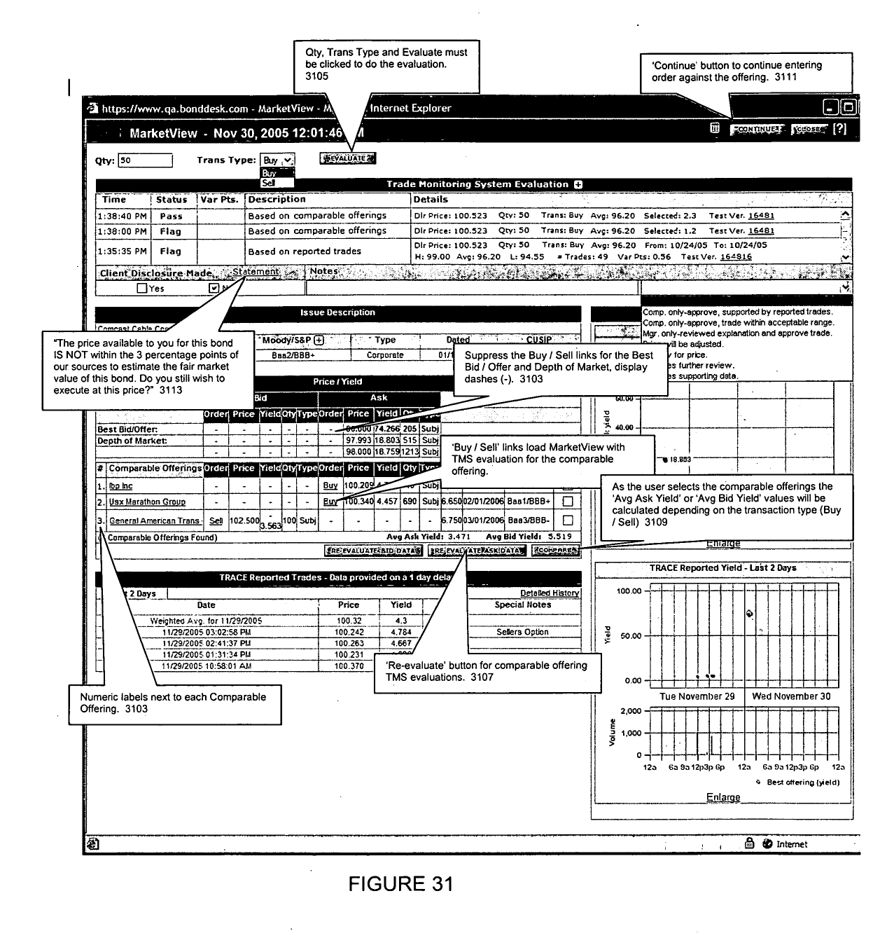

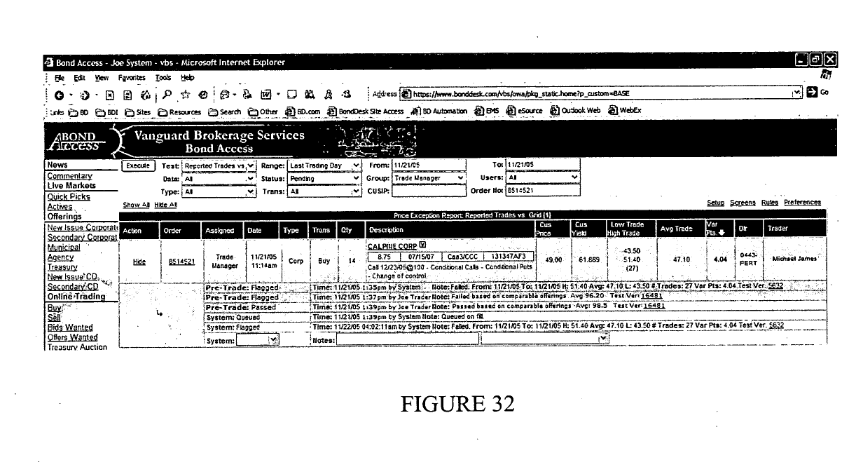

Along with a post-trade test, the user 106 may also elect to have a pre-trade alert. FIG. 31 is an exemplary screenshot illustrating a pre-trade test with trade monitoring system evaluation. FIG. 32 is an exemplary screenshot illustrating the screenshot of FIG. 31 and a pop-up window for past trades. The security price evaluation and exception reporting system 100 provides a pre-trade, on-demand test which compares any municipal or corporate offering to past trades and comparable offerings. The test informs the trader whether an offering falls outside of client tolerance levels, and if it does, prompts the trader to make the disclosure to the client. The results of this test, the fact that the disclosure was made, and any free-form trader notes may be saved with the executed trade for archiving in the data storage system 112.

The trade monitoring system 110 executes a revised order workflow for corporate and municipal bonds. Selection of a buy or sell order or a client link causes the system 110 to start a TMS evaluation. An order entry is made, previewed and then placed. An order number is used when the buy or sell order or client link is selected for those users entitled with the pre-trade order process. Order numbers are used by the comparable bonds and the storage archives of the data storage system 112. An order entry process uses the order number quantity and action as will be described below.

If the user is entitled, the buy or sell order links for the client link calls the pre-test process, including those on the following screens: search results; ladder/offer sheets; pre-trade market view; market bond compare (except the market view desk bid/offer in depth of market buy/sell links); offer/issue description; and other. Selecting a pre-trade client link (v-link) causes a pre-trade system evaluation to continue with the order process, such as the buy or sell links.

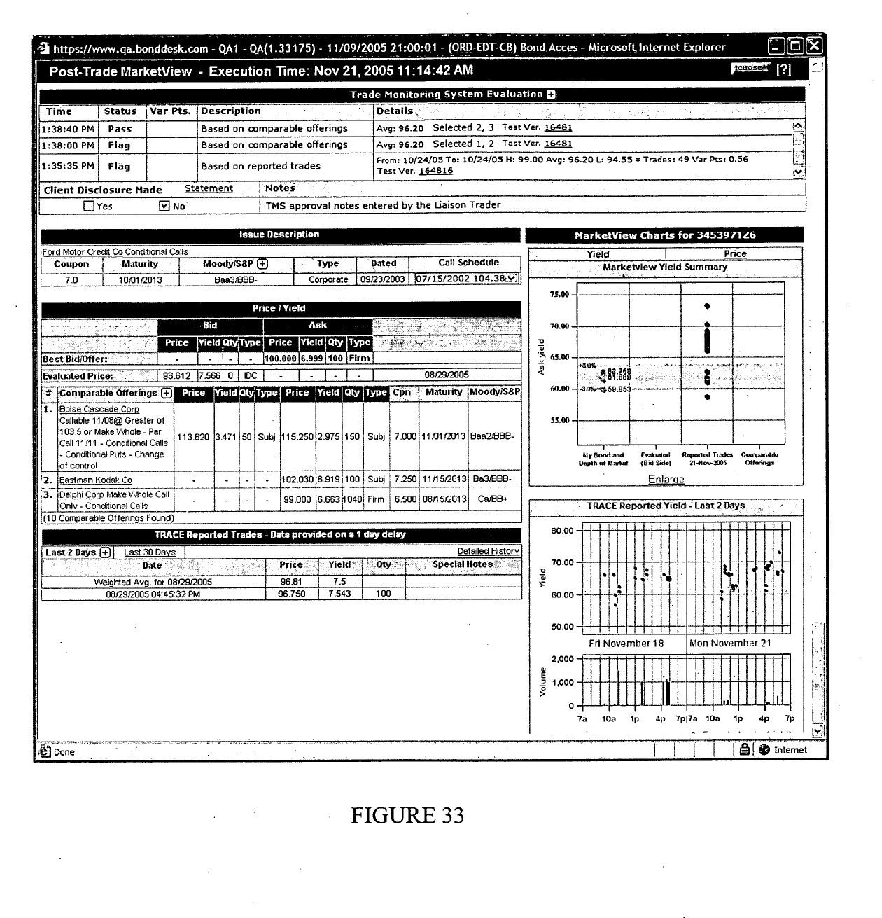

The trade monitoring system 110 suppresses the buy/sell links for the best bid/offer and depth of market and displays a dash in each ‘order’ cell. The trade monitoring system 110 has numeric labels for each comparable offering (block 3103). The user enters the quantity, transaction type and selects the ‘evaluate’ button (block 3105). The trade monitoring system 110 uses the quantity to determine which offering has the best price when evaluate is selected. The system 100 executes the trade monitoring system reported trade test and indicates a pass/flag status and related details, including the dealer price, quantity entered and transaction selected for each evaluation. The user may select comparable offerings and then press the ‘reevaluate’ button (Block 3107). The trade monitoring system 110 continues to add the trade monitoring system evaluation results to the TMS evaluations display on the top of the screen. In response to the user selecting the comparable offering, the trade monitoring system 110 calculates the average ask yield (‘AVG ASK yield’) and the average bid yield (‘ABG bid yield’) values depending on the transaction type selected in block 3105 (block 3109). The trade monitoring system 110 stores comparable offerings when the pre-trade market view screen is initially loaded and will display these offerings in a post-trade market view as described below in conjunction with FIG. 33. The trade monitoring system 110 saves the comparable offerings selected for each pre-trade TMS evaluation request by saving the row numbers. The trade monitoring system 110 stores the pre-trade TMS approval notes in the archives of the data storage system 112 and displays the notes in the post-trade TMS. The user may select the continue button to validate the order (block 3111) to indicate that at least one test has been performed and passed. In one embodiment an indication that a client disclosure has been made constitutes a passed TMS test. The TMS notes may be used if no tests have passed and the user has not marked the “client disclosure made” flag. The trade monitoring system 110 may display a pop-up to request the user to undertake certain actions, such as select comparable bonds which passed the pre-trade test, make client disclosure and select yes, or enter notes, before allowing the trade to proceed in the event that certain criteria are not met. The comparable offering buy/sell links allow the user to load a price evaluation with trade monitoring evaluation for the chosen comparable offerings. Hover over bubble provides a disclosure statement to remind users what the client disclosure statement is.

In a pre-trade test configuration, the trade monitoring system 110 evaluates an offering using the same test as the user specified in Matrix I above. If there is insufficient data for a pre-trade TMS evaluation based on reported trades or if the offering is “flagged” based on reported trades, then the trade monitoring system 110 performs a test based on an average of selected Comparable Offerings. The trade monitoring system 110 displays check boxes for user selection of comparable bonds they want to use in comparison. In response to user selection of the comparable bonds using the check boxes, and selection of either a “Re-evaluate Ask-side Data” button or a “Re-evaluate Bid-side Data” button, the trade monitoring system 110 averages the yields of the selected bonds. If best bid/offer yield is within a selected range (e.g., 3%) of the average yield of the reported trades of the day, then the system 108 notes a “Pass, based on Comparable Offerings” (As one illustrative embodiment, use best bid-side yield if user chose “Re-evaluate bid data”; use best ask-side yield if user chose “Re-evaluate ask data”). If the best bid/offer yield is not within the selected range (e.g., 3%) of the average yield of the reported trades of the day, the system 110 notes a “Flag, based on Comparable Offerings” and may display a pop up window (block 3113) indicating the trade does not comply and requesting confirmation that a trade is to be executed.

FIG. 33 is an exemplary screenshot illustrating a post-trade trade monitoring system display with pre-trade evaluation data. The trade monitoring system 110 displays the evaluations that were made on the pre-trade screen of FIG. 31 as approval updates for the order. The pre-trade approval updates are pre-fixed with ‘Pre-Trade’ with the appropriate pre-trade test results. If a client disclosure statement was made, the trade monitoring system 110 displays an indicative pre-trade note, such as “Client Disclosure Made.” Any TMS notes that were entered by the users will also be displayed as approval status updates on the order. In one embodiment, the pre-trade comparable bonds tests that did not result in an order being placed are cleared from the data storage system 112.

The post-trade screenshot of FIG. 33 is similar to the pre-trade screenshot of FIG. 31 and displays the pre-trade evaluations and associated data including the comparable offerings at the time when the pre-trade screenshot of FIG. 31 was initially loaded. The post-trade screenshot typically will not include the following features that are available on pre-trade screenshot: a “Compare” button, a “Re-evaluate Ask Data” button, a “Re-evaluate Bid Data” button, an average ask yield, an average bid yield.“Yes/No” Checkboxes under “Client Disclosure Made” is not edit-able on a post-trade basis. The “Notes” field is not edit-able on a post-trade basis.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention. While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

What is claimed is:

1. A method for evaluating a given price for a unit of a first security, the method comprising:
selecting current offerings, past trades, dealer cost, or dealer marks on other units of the first security based on a set of first user selectable criteria;
selecting units of one or more second securities based on a set of second user selectable criteria and data related to offerings and transactions of said second securities, the second security having similar characteristics to said unit of the first security, the characteristics being a set of third user selectable criteria; and
generating an indicia of price of the unit of the first security based on a set of fourth user selectable criteria.

2. The method of claim 1 wherein the generating the indicia further includes generating the indicia based on the sets of first and third user selectable criteria.

3. The method of claim 1 wherein the generating the indicia further includes generating the indicia based on the sets of first, second, and third user selectable criteria.

4. The method of claim 1 further comprising generating an automatic alert to the user if the price for said unit of the first security is off the market based on results of a user-selected tolerance test.

5. The method of claim 1 wherein the sets of the first, second, third, and/or fourth user selectable criteria are set by, regulatory standards or other industry standard practices.

6. The method of claim 1 wherein the indicia of the price is determined in real time with a trade of the first security.

7. The method of claim 1 wherein the indicia of the price is determined before the offerings on a plurality of first securities are shown to the user, the method further comprising flagging ones of the offerings as acceptable, out-of-line, or requiring further review based on the indicia of the price.

8. The method of claim 1 wherein the indicia of the price is determined after a trade of the one of the first security.

9. The method of claim 8 further comprising generating an exception notice in the event that the trade of the unit of the first security does not conform to the indicia of the price of the first security.

10. The method of claim 1 further comprising alerting a seller of the unit of the first security in the event that an offering price of the first security does not match the user-selected past trades, dealer marks, dealer cost, or current offerings of the first security, and/or the indicia of the selected second securities.

11. The method of claim 1 further comprising alerting a potential buyer of the unit of the first security in the event that an offering price of the first security does not match the user-selected past trades, current offerings, and/or dealer marks of the first security, and/or the indicia of the selected second security.

12. The method of claim 1 further comprising receiving data related to past trades of the first and second securities from a third party.

13. The method of claim 1 wherein the third party is TRACE, MSRB, or another regulatory or industry body; past trades from an exchange, Alternative Trading System (ATS), or Electronic Communications Network (ECN).

14. The method of claim 1 further comprising receiving the characteristics of the plurality of second securities from traders of the second securities.

15. The method of claim 1 wherein the first user selectable criteria includes a range or value for one or more of side of market (buy or sell); size of trade; recency of trades, type of customer.

16. The method of claim 1 wherein the second securities include live offerings of comparable bonds available for purchase or sale on any Alternative Trading System (ATS), Electronic Communications Network (ECN), exchange, or through a dealer offer sheet, or inter-dealer system; and/or past trades of comparable bonds disseminated by TRACE, MSRB, another regulatory or industry body, or available from another ATS, ECN, exchange, or dealer's or broker's system.

17. The method of claim 1 wherein the second user selectable criteria defines either a specified value, or specified acceptable range between the first security and one or more characteristics of the second security, the specified value or specified acceptable range being different for each of the characteristics.

18. The method of claim 1 wherein the set of third user selectable criteria includes one or more of characteristics of the second security selected from a group of yield, maturity date, block size, type of trade, asset class, effective maturity date, years until price-to-worst date, price volatility of past trades, price or yield of past trades, ratings, callability, issuer yield curves, coupon, insurance, industry code, spread to benchmarks, option adjusted spread, option adjusted duration, use of proceeds, tax status, state of issue, obligor, type of collateral or guarantee, investor qualifications, and refunding status.

19. The method of claim 1 wherein the benchmarks include US Treasury, MMA or MMD curve.

20. The method of claim 1 further comprising:
providing an indication in the event that the indicia indicates the given price is outside a tolerance level;
generating said indicia in the response to a user command and user selection of ones of said first securities.

21. The method of claim 1 further comprising:
providing an indication in the event that insufficient ones of said first security are available for selection;
generating said indicia in the response to a user command and user selection of ones of said second securities.

22. The method of claim 1 further comprising:
providing an indication in the event the indicia indicates the given price is outside a tolerance level; and
prohibiting purchase of said unit of the first security if the indicia indicates the given price is outside a tolerance level unless a user override and user notes are received.

23. The method of claim 22 wherein said prohibiting further includes prohibiting unless a client disclosure indication is received.

24. A system for evaluating a given price for a unit of a first security, comprising:
a processor for executing programs; and
a price evaluation module executable by the processor, the module including:
instructions for selecting current offerings, past trades, dealer cost, or dealer marks on other units of the first security based on a set of first user selectable criteria;
instructions for selecting units of one or more second securities based on a set of second user selectable criteria and data related to offerings and transactions of said second securities, the second security having similar characteristics to said unit of the first security, the characteristics being a set of third user selectable criteria;
instructions for generating an indicia of price of the unit of the first security based on a set of fourth user selectable criteria.

25. The system of claim 24 wherein the instructions for generating the indicia further includes instructions for generating the indicia based on the sets of first and third user selectable criteria.

26. The system of claim 24 wherein the instructions for generating the indicia further includes instructions for generating the indicia based on the sets of first, second, and third user selectable criteria.

27. The system of claim 24 further comprising instructions for generating an automatic alert to the user if the price for said unit of the first security is off the market based on results of a user-selected tolerance test.

28. The system of claim 24 wherein the indicia of the price is determined before the offerings on a plurality of first securities are shown to the user, the system further comprising instructions for flagging ones of the offerings as acceptable, out-of-line, or requiring further review based on the indicia of the price.

29. The system of claim 24, wherein the indicia of the price is determined after a trade of the one of the first security, the system further comprising instructions for generating an exception notice in the event that the trade of the unit of the first security does not conform to the indicia of the price of the first security.

30. The system of claim 24 further comprising instructions for alerting a seller of the unit of the first security in the event that an offering price of the first security does not match the user-selected past trades, dealer marks, dealer cost, or current offerings of the first security, and/or the indicia of the selected second securities.

31. The system of claim 24 further comprising instructions for alerting a potential buyer of the unit of the first security in the event that an offering price of the first security does not match the user-selected past trades, current offerings, and/or dealer marks of the first security, and/or the indicia of the selected second security.

32. The system of claim 24 wherein the first user selectable criteria includes a range or value for one or more of side of market (buy or sell); size of trade; recency of trades, type of customer.

33. The system of claim 24 wherein the second user selectable criteria defines either a specified value, or specified acceptable range between the first security and one or more characteristics of the second security, the specified value or specified acceptable range being different for each of the characteristics.

34. The system of claim 24 wherein the set of third user selectable criteria includes one or more of characteristics of the second security selected from a group of yield, maturity date, block size, type of trade, asset class, effective maturity date, years until price-to-worst date, price volatility of past trades, price or yield of past trades, ratings, callability, issuer yield curves, coupon, insurance, industry code, spread to benchmarks, option adjusted spread, option adjusted duration, use of proceeds, tax status, state of issue, obligor, type of collateral or guarantee, investor qualifications, and refunding status.

35. The system of claim 24 further comprising:
instructions for providing an indication in the event that the indicia indicates the given price is outside a tolerance level;
instructions for generating said indicia in the response to a user command and user selection of ones of said first securities

36. The system of claim 24 further comprising:
instructions for providing an indication in the event that insufficient ones of said first security are available for selection; and
instructions for generating said indicia in the response to a user command and user selection of ones of said second securities.

37. The system of claim 24 further comprising:
instructions for providing an indication in the event the indicia indicates the given price is outside a tolerance level;
instructions for prohibiting purchase of said unit of the first security if the indicia indicates the given price is outside a tolerance level unless a user override and user notes are received.

38. The system of claim 37 wherein said instructions for prohibiting further includes prohibiting unless a client disclosure indication is received.

39. A computer program product for use in conjunction with a computer system, the computer program product comprising a computer readable storage medium and a computer program mechanism embedded therein, the computer program mechanism including:
instructions for selecting current offerings, past trades, dealer cost, or dealer marks on other units of the first security based on a set of first user selectable criteria;
instructions for selecting units of one or more second securities based on a set of second user selectable criteria and data related to offerings and transactions of said second securities, the second security having similar characteristics to said unit of the first security, the characteristics being a set of third user selectable criteria; and
instructions for generating an indicia of price of the unit of the first security based on a set of fourth user selectable criteria.

40. A graphical user interface comprising:
a first display element showing selected past trades of a plurality of second securities based on the second security having similar characteristics to a first security;
a second display element showing the characteristics, the characteristics being user selectable;
a third display element showing an indicia of a price of the first security based on the selected past trades and user selected criteria; and
a fourth display element showing the user selected criteria.

41. The graphical user interface of claim 40 further comprising a fifth display element illustrating a list of the prices of the selected second securities.

42. A method for evaluating a traded price for a unit of a first security, the method comprising:
selecting current offerings, past trades, dealer cost, or dealer marks on other units of the first security based on a set of first user selectable criteria;
selecting units of one or more second securities based on a set of second user selectable criteria and data related to offerings and transactions of said second securities, the second security having similar characteristics to said unit of the first security, the characteristics being a set of third user selectable criteria; and
evaluating the traded price of said unit of the first security based on a set of fourth user selectable criteria.

43. The method of claim 42 wherein the evaluating the trade further includes evaluating the trade based on the first and third user selectable criteria.

44. The method of claim 42 wherein the evaluating the trade further includes evaluating the trade based on the first, second, and third user selectable criteria.

45. A system for evaluating a given price for a unit of a first security, comprising:
a processor for executing programs; and
a price evaluation module executable by the processor, the module including:
instructions for selecting current offerings, past trades, dealer cost, or dealer marks on other units of the first security based on a set of first user selectable criteria;
instructions for selecting units of one or more second securities based on a set of second user selectable criteria and data related to offerings and transactions of said second securities, the second security having similar characteristics to said unit of the first security, the characteristics being a set of third user selectable criteria;
instructions for evaluating the traded price of said unit of the first security based on a set of fourth user selectable criteria.

46. The system of claim 45 wherein the instructions for evaluating the trade further includes instructions for evaluating the trade based on the first and third user selectable criteria.

47. The system of claim 45 wherein the instructions for evaluating the trade further includes instructions for evaluating the trade based on the first, second, and third user selectable criteria.

48. A computer program product for use in conjunction with a computer system, the computer program product comprising a computer readable storage medium and a computer program mechanism embedded therein, the computer program mechanism including:
instructions for selecting current offerings, past trades, dealer cost, or dealer marks on other units of the first security based on a set of first user selectable criteria;
instructions for selecting units of one or more second securities based on a set of second user selectable criteria and data related to offerings and transactions of said second securities, the second security having similar characteristics to said unit of the first security, the characteristics being a set of third user selectable criteria;
instructions for evaluating the traded price of said unit of the first security based on a set of fourth user selectable criteria.
